(19) United States
(12) Patent Application Publication
(10) Pub. No.: US 2007/0077520 A1
(43) Pub. Date: Apr. 5, 2007

(54) Recording medium, planographic printing plate using the same and production method thereof

(75) Inventor: Kazuo Maemoto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,721

(22) Filed: Oct. 2, 2006

(30) Foreign Application Priority Data
Sep. 30, 2005 (JP) 2005-288752
Mar. 3, 2006 (JP) 2006-058671
Mar. 15, 2006 (JP) 2006-071463

(51) Int. Cl. G03C 1/00

(52) U.S. Cl. 430/270.1

(57) ABSTRACT

The invention provides a recording medium for producing a direct-writing planographic printing plate comprising: a support; a hydrophilic layer; and an ink receiving layer laminated in this order, wherein the ink receiving layer contains one or more compounds selected from the group consisting of organic fluorine compounds having a fluoroalkyl group and compounds having a dimethyl siloxane skeleton, and receives ink deposited by an ink jet recording system.

### CROSS-REFERENCES TO RELATED APPLICATIONS

This invention claims priority under 35 USC 119 from Japanese Patent Application Nos. 2006-288752, 2006-071463 and 2006-058671, the disclosures of which are incorporated by reference herein.

### BACKGROUND OF THE INVENTION

1. Field of the Invention

The invention relates to a recording medium for use in image formation utilizing an ink jet recording system, a planographic printing plate obtained by the combination of the recording medium and an ink, and a method for producing a planographic printing plate utilizing an ink jet recording system.

2. Description of the Related Art

As recording methods for forming an image on a recording medium on the basis of image data signals, electrophotographic methods, heat transfer methods, and ink jet methods are known. The electrophotographic methods require a process of forming an electrostatic latent image by electrostatic charging and photo-exposure on a photosensitive drum, thus the systems are complicated and an expensive apparatus is necessary. The heat transfer method, although the apparatus is inexpensive, uses an ink ribbon hence running cost becomes expensive, and waste material is lost behind. On the other hand, in the ink jet methods, as printing is performed directly on a printing medium by ejecting ink only on a necessary image area with an inexpensive apparatus, no waste materials left and the running cost is inexpensive, which makes the methods advantageous as a recording method.

A variety of recording media such as paper, plastic and metal are used in ink jet recording methods, and they are selected in accordance with the intended use. For example, by using ordinary paper for recording such as wood-free paper and recycled paper, directly printed products can be obtained. However, the recording rate of ink jet recording methods is so low that much time is necessary to produce many sheets of printed products. Therefore, producing many sheets of printed products from a printing plate produced by the ink jet recording method has been attempted. As a method for producing direct-writing planographic printing plates for drawing an image by the ink jet method, for example, a technique for applying ink to an aluminum support whose surface has been previously hydrophilized with a hydrophilic organic polymer compound is suggested (see Japanese Patent Application Laid-Open (JP-A) No. 2000-108537). However, ink deposited by ink jet can bleed on the substrate. Moreover, a method for producing a planographic printing plate by applying a specific ink to a support whose surface has been treated with a terminal alkyl, silicon-based or fluorine-based surfactant is disclosed (e.g., U.S. Pat. No. 6,472,045, 6,455,132, 6,451,413, 6,555,205, 6,471,359, and 6,742,886). These methods can prevent the deposited ink from bleeding, but tend to generate staining easily during printing and achieve poor printing durability.

### SUMMARY OF THE INVENTION

The present invention has been made in view of the above circumstances and provides a recording medium, a planographic printing plate using the same and a producing method therof.

A first aspect of the present invention provides a recording medium for producing a direct-writing planographic printing plate comprising: a support; a hydrophilic layer; and an ink receiving layer laminated in this order, wherein the ink receiving layer contains one or more compounds selected from the group consisting of organic fluorine compounds having a fluoroalkyl group and compounds having a dimethyl siloxane skeleton, and receives ink deposited by an ink jet recording system.

### BRIEF DESCRIPTION OF THE DRAWINGS

FIG. 1 is a side elevational view showing the concept of the brush graining process for use in mechanical surface-roughening treatment in the production of the recording medium for producing a direct-writing planographic printing plate of the present invention.

FIG. 2 is a graph showing an example of an alternating current waveform for use in the electrochemical surface-roughening treatment in the production of the recording medium for producing a direct-writing planographic printing plate of the invention.

FIG. 3 is a side elevational view showing an example of an radial type cell in the electrochemical surface-roughening treatment using an alternating current in the production of the recording medium for producing a direct-writing planographic printing plate of the invention.

FIG. 4 is a schematic view of anodic oxidation treatment equipment for use in anodic oxidation treatment in the production of the recording medium for producing a direct-writing planographic printing plate of the invention.

### DETAILED DESCRIPTION OF THE INVENTION

An object of the invention is to provide a recording medium for planographic printing plate which prevents bleeding of deposited ink, leaves no significant stains during printing, and provides good printing durability.

Another object of the invention is to provide a planographic printing plate which uses the recording medium of the invention, forms image areas with excellent resolution and printing durability, and produces printed matters with reduced stains in non-image area, and to provide a simple method for producing the planographic printing plate.

As a result of the eager investigation, the inventors of the present invention have found that both of ink bleeding and staining in non-image area are prevented by increasing the contact angle with deposited ink and decreasing the contact angle with water, and also found that the above-described problem is solved by using a recording medium comprising an ink receiving layer and a hydrophilic layer which meets the above-described requirement. Thus, the invention has been accomplished.

In the first place, the recording medium of the invention is described. The recording medium of the invention comprises a support, a hydrophilic layer, and an ink receiving layer laminated in this order, wherein the ink receiving layer contains one or more compounds selected from the group consisting of compounds having a fluoroalkyl group and compounds having a dimethyl siloxane skeleton, and receives a radiation-curable ink deposited by an ink jet recording system.

The recording medium of the invention comprises a hydrophilic layer, and an ink receiving layer which contains one or more compounds selected from the group consisting of compounds having a fluoroalkyl group and compounds having a dimethyl siloxane skeleton.

By introducing a compound having a fluoroalkyl group or a polydimethylsilyloxy group which decreases the surface energy of ink into the ink receiving layer, the contact angle between ink and the ink receiving layer surface is increased to larger than 30°, ink bleeding is prevented, and thereby an image area of high resolution having excellent adhesiveness with the ink receiving layer is formed.

On the other hand, in order to prevent the non-image area from being stained during printing, the ink receiving layer must be removed to expose the hydrophilic layer. Therefore, the ink receiving layer must be designed in such a manner the layer in the non-image area where no ink present is readily removed after disposition and curing of ink using dampening water or gum to expose the adjacent hydrophilic layer. For readily removing the ink receiving layer, the contact angle between water and the ink receiving layer should be smaller than 10°. More specifically, it is preferable to introduce a hydrophilic resin or an water-solubilized compound having a fluoroalkyl group or a polydimethylsilyloxy group into the ink receiving layer. It is more preferable to water-solubilize a compound having a fluoroalkyl group or a polydimethylsilyloxy group, and blend it with a hydrophilic resin. The hydrophilic layer surface thus exposed by removing the ink receiving layer has high wettability with dampening water used during printing, which effectively prevents the formation of stains in the non-image area.

Under normal conditions, printing durability is deteriorated when the ink receiving layer is highly wettable with water and soluble in water. However, in a preferable embodiment of the invention, a radiation-curable ink is used for enhancing the film quality in the image area, therefore an water resistant resin film is formed in the ink-attached area after radiation curing, which achieves high printing durability. Moreover, in a preferable embodiment of the invention, the surface form of the support is controlled to increase the adhesiveness between ink and the support. Accordingly, a recording medium suitable to direct-writing planographic printing plate which prevents ink bleeding, causes no stain during printing, and exhibits high printing durability can be obtained.

In the invention, the contact angle refers to the contact angle of flying droplets measured 10 seconds after dropping of 0.8 μL.

In a preferable embodiment of in the invention, when an ink receiving layer of a fluorine compound having five or more fluorine atoms per molecule is provided on a support comprising a substrate of aluminum or the like having provided thereon an anodic oxidation film and a silicate layer of 2.0 to 25 mg/m², more preferably 5.0 to 20 mg/m² provided on the anodic oxidation film, or on a support having provided thereon a sol-gel hydrophilic layer, ink bleeding is reduced by the water and oil repellency of fluorine. The reason is that the fluorine-based compound is oriented on the surface which has been hydrophilized by silicate. The non-image area where no ink has been deposited during printing can be readily stained if any organic fluorine compounds remain on it. However, on a substrate having a silicate layer in the range of 2.0 to 25 mg/m² or a substrate having a sol-gel hydrophilic layer according to the invention can reduce the adsorption of fluorine-based compounds to the substrate, accordingly any remained fluorine compounds are readily removed by a dampening water or ink during printing. Thus the hydrophilicity and the stain resistance of the substrate are improved. On the image area where ink has been deposited, fluorine-based compounds are dissolved by the ink component, which ensures the adhesiveness between ink and the support. The printing durability is further improved by using radiation-curable UV ink or ink containing thermally fused polymer particles, and introducing a fixing process by light or heat.

[Support]

The support (substrate) for use in the recording medium of the invention is not particularly limited as long as it is a dimensionally stable plate-shaped material having necessary strength and durability. Example thereof include papers, papers laminated with plastic (e.g., polyethylene, polypropylene and polystyrene), metal plates (e.g., aluminum, zinc and copper), plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate and polyvinyl acetal), papers or plastic films laminated or deposited with metal.

Of these examples, in the invention, polyester films or aluminum plates are preferable, and aluminum plates are particularly preferable because they have good dimensional stability and are relatively low cost. Preferable aluminum plates are pure aluminum plates and alloy plates that are mainly composed of aluminum and contain a trace amount of different elements, and may be plastic films deposited or laminated with aluminum. Examples of the different elements contained in the aluminum alloy include silicon, iron, manganese, copper, magnesium, chromium, zinc, bismuth, nickel and titanium. The content of the different elements in the alloy is about 10% by mass or less. In the invention, preferable supports are surface treated aluminum plates and polyester films having provided thereon a sol-gel hydrophilic layer. These supports are described below.

[Aluminum Support]

In the invention, pure aluminum is particularly preferable. However, completely pure aluminum is not easily produced from the viewpoint of metallurgy technology. Thus, aluminum containing a trance amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.15 to 0.3 mm. The aluminum plate may be subjected, depending on necessity, to a surface treatment, such as a surface roughening treatment and an anodic oxidation treatment. The surface treatment will be described below.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

<Description of the Surface Treatment for Preparing Aluminum Grain Shape>

The recording medium for producing the direct-writing planographic printing plate (support for planographic printing plate) of the invention is obtained by subjecting an after-mentioned aluminum plate, to the surface treatment to form the surface grain on the surface of the aluminum plate, and forming thereon an after-mentioned specific layer. A support that serves as a substrate of the recording medium for producing the direct-writing planographic printing plate of the invention is obtained by subjecting an aluminum plate to the surface-roughening treatment and the anodic oxidation treatment, but the production process of the support is not particularly limited, and may include various processes other than the surface-roughening treatment and the anodic oxidation treatment. Examples of the typical methods for forming the surface grain include: a method to subject an aluminum plate sequentially to mechanical surface-roughening treatment, alkali etching treatment, desmutting treatment with an acid and electrochemical surface-roughening treatment with an electrolyte; a method to subject an aluminum plate sequentially to mechanical surface-roughening treatment, alkali etching treatment, desmutting treatment with an acid and plural times of electrochemical surface-roughening treatment with different electrolytes; a method to subject an aluminum plate sequentially to alkali etching treatment, desmutting treatment with acid and electrochemical surface-roughening treatment with an electrolyte; and a method to subject an aluminum plate sequentially to alkali etching treatment, desmutting treatment with acid and plural times of electrochemical surface-roughening treatment with different electrolytes. However, the invention is not limited to these examples. In these methods, the electrochemical surface-roughening treatment may be followed by the alkali etching treatment and the desmutting treatment with an acid. The recording medium for producing the direct-writing planographic printing plate of the invention obtained by these methods has, as aforementioned, is formed thereon with an overlapped structure of irregularities of two or more types of periodicity, and is thus superior both in stain resistance and printing durability when it is used as a planographic printing plate. The each process of the surface treatment is described below in detail.

<Mechanical Surface-Roughening Treatment>

Mechanical surface-roughening treatment is an effective means for surface-roughening treatment as it can form a surface having irregularities of an average wavelength of 5 to 100 μm at a lower cost than electrochemical surface-roughening treatment. The method of the mechanical surface-roughening treatment may be, for example, a wire brush graining method to scratch aluminum surface with metal wire, a ball graining method to grain aluminum surface with a abrasive ball and an abrasive, or a brush graining method to grain the surface with a nylon brush and an abrasive, which is described in JP-A No. 6-135175 and 50-40047. In addition, a transfer method to press an irregular surface against an aluminum plate may be used. More specifically, the methods as described in JP-A No. 55-74898, 60-36195, and 60-203496, and a method characterized by performing plural times of transfer, which is described in JP-A No. 6-55871, and a method characterized by an elastic surface, which is described in Japanese Patent Application No. 4-204235 (JP-A No. 6-024168) may be used.

Also may be used are a method to repeatedly perform transfer using a transferring roll etched with fine irregularities by electric discharge machining, shot blast, laser, plasma etching or other means, and a method to contact an irregular surface applied thereon with fine particles with an aluminum plate, and apply a pressure repeatedly onto the surface to repeatedly transfer the irregularities pattern corresponding to the average diameter of the fine particles to the aluminum plate. The method to impart fine irregularities to a transferring roll may be a known method as described in JP-A No. 3-8635, 3-66404 and 63-65017. Alternatively, the roll surface may be formed with fine grooves from two directions using a dice, bite, laser or other means to form rectangular irregularities on the surface. The roll surface may be subjected to known etching treatment or other treatment to round off the formed rectangular irregularities. Quenching, hard chromium plating or other treatment may be performed to increase the hardness of the surface. Other examples of the method for the mechanical surface-roughening treatment include methods as described in JP-A No. 61-162351 and 63-104889. In the invention, the aforementioned methods may be used in combination with others for productivity or other factors. Such mechanical surface-roughening treatment is preferably performed before the electrochemical surface-roughening treatment.

The brush graining method that is preferably used in the mechanical surface-roughening treatment is described below. The brush graining method is usually performed by scrubbing one surfaces or both surfaces of the aluminum plate with rotating nylon brush rollers comprising a cylindrical trunk whose surface is planted with a plenty of synthetic resin brush bristles made of nylon (trade name), propylene, vinyl chloride or other resins, while spraying a slurry containing an abrasive over the brush. Abrasive rollers having an abrasive layer on the surface may be used in place of the combination of the brush rollers and a slurry. When brush rollers are used, the brush rollers preferably have a bend elastic constant of 10,000 to 40,000 kg/cm², more preferably 15,000 to 35,000 kg/cm², a bristle strength of 500 g or less, more preferably 400 g or less, and a bristle diameter of 0.2 to 0.9 mm. The length of the brush bristles can be selected in accordance with the outside diameter of the brush rollers and the diameter of the trunk, but usually 10 to 100 mm.

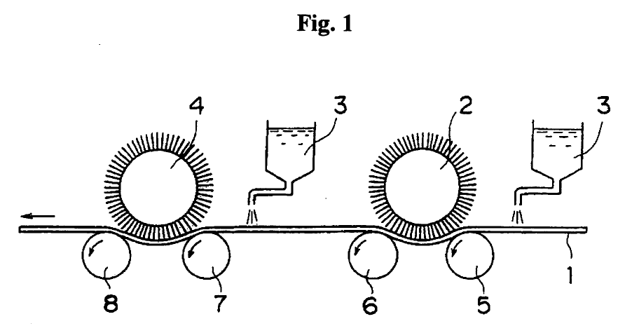

Using a device as shown in FIG. 1, mechanical surface roughing treatment was carried out using a rotating roller-like nylon brush with supplying a suspension of an abrasive agent (pumice) having a specific gravity of 1.12 and water as an abrasive slurry solution to the surface of the aluminum plate. In FIG. 1, reference numeral 1 represents an aluminum plate, 2 and 4 each represent a roller-like brush, 3 represents an abrasive slurry solution and 5, 6, 7, and 8 each represent a support roller. The average particle diameter of the abrasive agent was 40 μm and the maximum particle diameter of the abrasive agent was 100 μm. The material of the nylon brush was 6′10 nylon wherein the hair length was 50 mm and the diameter of the hair was 0.3 mm. The bristles of the nylon brush had been densely planted in the holes opened in a stainless cylinder having a diameter of 300 mm. Three rotary brushes were used. The distance between two support rollers (diameter: 200 mm) under the brush was 300 mm. The brush roller was pressed against the aluminum plate until the load of the drive motor rotating the brush was increased to a load 7 kW higher than the load before the brush was pressed against the aluminum plate. The direction of the rotation of the brush was the same as the direction in which the aluminum plate was moved. The number of rotations of the brush was 200 rpm.

The abrasive may be a known abrasive. Examples thereof include pumice stone, silica sand, aluminum hydroxide, alumina powder, silicon carbide, silicon nitride, volcanic ashes, carborundum, emery, and mixtures thereof. Of these examples, pumice stone and silica sand are preferable.

In particular, silica sand is preferable because it is harder and less fragile than pumice stone, and is superior in surface-roughening efficiency. The average particle diameter of the abrasive is preferably 3 to 50 μm, more preferably 6 to 45 μm for achieving excellent surface-roughening efficiency and a fine grain pitch. The abrasive is used in a slurry state, for example, suspended in water. In addition to the abrasive, the slurry may contain other additives such as a thickener, a dispersant (e.g., surfactant) and a preservative. The specific gravity of the slurry is preferably 0.5 to 2.

Examples of the equipment for the mechanical surface-roughening treatment include the equipment as described in Japanese Patent Application Publication (JP-B) No. 50-40047.

<Electrochemical Surface-Roughening Treatment>

Electrochemical surface-roughening treatment may be performed with electrolytes for use in conventional electrochemical surface-roughening treatment using alternating current. In particular, electrolytes mainly composed of hydrochloric acid or nitric acid electrolyte can form a characteristic irregularity structure on the surface. The electrolyzing treatment in the invention is preferably performed by conducting the first and second electrolyzing treatment using alternating waveform current in an acidic solution before and after the cathodic electrolyzing treatment. The cathodic electrolyzing treatment generates hydrogen gas on the surface of the aluminum plate to form smut, which makes the surface state uniform and enables uniform electrolyzing roughening during the subsequent electrolyzing treatment using alternating waveform current. The electrolyzing treatment can be performed, for example, by an electrochemical graining method (electrolytic graining method) as described in JP-B No. 48-28123 and U.K. Patent No. 896,563. The electrolytic graining method uses alternating current of sine waveform, but may be use a special waveform as described in JP-A No. 52-58602. The waveform as described in JP-A No. 3-79799 may be used. The methods as described in JP-A No. 55-158298, 56-28898, 52-58602, 52-152302, 54-85802, 60-190392, 58-120531, 63-176187, 1-5889, 1-280590, 1-118489, 1-148592, 1-178496, 1-188315, 1-154797, 2-235794, 3-260100, 3-253600, 4-72079, 4-72098, 3-267400 and 1-141094 may be also used. In addition to the methods described above, electrolysis can be performed using alternating current having a special frequency, which is supposed as a production method for electrolytic condensers. The method is, for example, described in U.S. Pat. Nos. 4,276,129 and 4,676,879.

Various electrolytic baths and power sources are suggested, and those described in U.S. Pat. No. 4,203,637 JP-A No. 56-123400, 57-59770, 53-12738, 53-32821, 53-32822, 53-32823, 55-122896, 55-132884, 62-127500, 1-52100, 1-52098, 60-67700, 1-230800 and 3-257199 may be used. In addition, those described in JP-A No. 52-58602, 52-152302, 53-12738, 53-12739, 53-32821, 53-32822, 53-32833, 53-32824, 53-32825, 54-85802, 55-122896, 55-132884, JP-B No. 48-28123, 51-7081, JP-A No. 52-133838, 52-133840, 52-133844, 52-133845, 53-149135 and 54-146234 may be also used.

Examples of the acidic solution as an electrolyte include nitric acid, hydrochloric acid, and electrolytes described in U.S. Pat. Nos. 4,671,859, 4,661,219, 4,618,405, 4,600,482, 4,566,960, 4,566,958, 4,566,959, 4,416,972, 4,374,710, 4,336,113, and 4,184,932.

The concentration of the acidic solution is preferably from 0.5 to 2.5% by mass, and is particularly preferably from 0.7 to 2.0% by mass considering the use thereof in the treatment for removing the above-mentioned smut. The temperature of the solution is preferably from 20 to 80° C., more preferably from 30 to 60° C.

The aqueous solution made mainly of hydrochloric acid or nitric acid can be used in the state of adding, to an aqueous hydrochloric acid or nitric acid solution having a concentration of 1 to 100 g/L, at least one of nitric acid compound having a nitric acid ion (such as aluminum nitride, sodium nitride, or ammonium nitride) and hydrochloric acid compound having an hydrochloric acid ion (such as aluminum chloride, sodium chloride or ammonium chloride) at a concentration ranging from 1 g/L to the saturated concentration thereof. Into the aqueous solution made mainly of hydrochloric acid or nitric acid, a metal contained in aluminum alloy may be dissolved, examples of which include iron, copper, manganese, nickel, titanium, magnesium, or silica. It is preferable to use a solution wherein aluminum chloride, aluminum nitrate or the like is added to an aqueous hydrochloric acid or nitric acid solution having a concentration of 0.5 to 2% by mass so as to set the concentration of aluminum ions into the range of 3 to 50 g/L.

Moreover, the addition of a compound capable of forming a complex with Cu enables uniform graining even on an aluminum plate containing a plenty amount of Cu. Examples of the compound capable of forming a complex with Cu include ammonia; amines obtained by substituting hydrogen atoms of ammonia with hydrocarbon groups (e.g., aliphatic, aromatic) or other groups, such as methylamine, ethylamine, dimethylamine, diethylamine, trimethylamine, cyclohexylamine, triethanolamine, triisopropanolamine and EDTA (ethylenediamine tetraacetate); metal carbonates such as sodium carbonate, potassium carbonate and potassium bicarbonate. Other examples include ammonium salts such as ammonium nitrate, ammonium chloride, sulfuric acid ammonium, ammonium phosphate and ammonium carbonate. The temperature is preferably 10° C. to 60° C., more preferably 20 to 50° C.

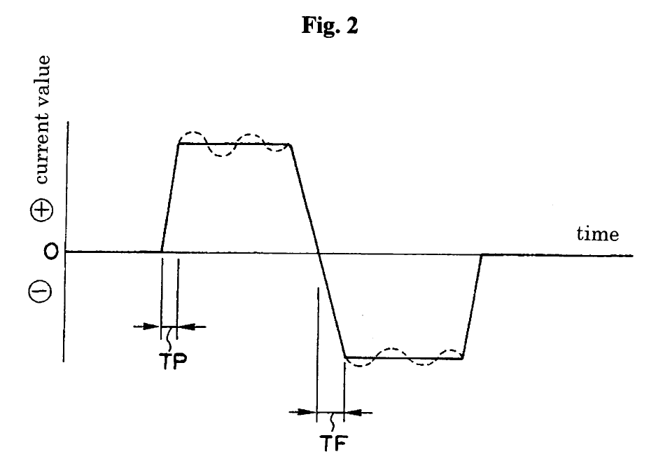

The alternating current wave used in the electrochemical surface-roughening treatment is not particularly limited, and may be a sine wave, a rectangular wave, a trapezoidal wave, a triangular waver, or some other wave. A rectangular wave and a trapezoidal wave are preferable, and the latter is particularly preferable. The trapezoidal wave is a wave illustrated in FIG. 2. In FIG. 2, the vertical axis shows current value and the horizontal axis shows time. TP and TF are the time when electric current rises from zero to a peak In this trapezoidal wave, TP is preferably from 1 to 3 msec. If the TP is less than 1 msec, a treatment-unevenness called a chatter mark and generated perpendicularly in the direction along which the aluminum plate is advanced is easily generated. If the TP is more than 3 msec, the following problem is caused, in particular, in the case of using the nitric acid electrolyte: trace components (typically, ammonium ions) which increase naturally in the electrolyte in the electrolysis produce a bad effect. Thus, uniform graining is not easily performed. As a result, when the plate is used to form a planographic printing plate, the stain resistance thereof tends to lower.

Trapezoidal wave alternating current having a duty ratio of 1:2 to 2:1 can be used. However, under an indirect power feeding system which uses no conductor roll for aluminum as described in JP-A No. 5-195300, those having a duty ratio of 1:1 is preferable. Trapezoidal wave alternating current having a frequency of 0.1 to 120 Hz can be used, but those having a frequency of 50 to 70 Hz are preferable for the facilities. If the frequency is lower than 50 Hz, the main carbon electrode is readily dissolved, and if higher than 70 Hz, the influence of the inductance components on the power source grows, which will increase the power source cost.

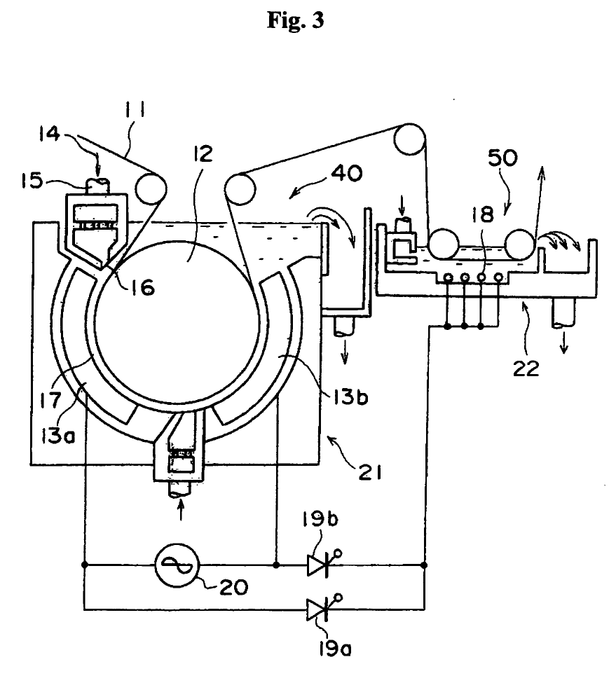

One or more AC power supplies can be connected to the electrolytic bath. In order to control the current ratio between anode and cathode components of the alternating current applied to the aluminum plate, which is opposite to a main electrode, thereby attaining uniform graining and further dissolve carbon of the main electrode, it is preferable to set an auxiliary anode and cause a part of the alternating current to flow dividedly into the auxiliary anode, as illustrated in FIG. 3. In FIG. 3, reference numeral 11 represents an aluminum plate; 12, a radial drum roller; 13a and 13b, main electrodes; 14, an electrolyte; 15, an electrolyte supplying port; 16, a slit; 17, an electrolyte passage; 18, an auxiliary electrode; 19a and 19b, thyristors; 20, an AC power supply; 40, a main electrolytic bath; and 50, an auxiliary cathode bath. By dividing electric current to cause a part thereof to flow, through a rectifying element or switching element, as a direct current into the auxiliary electrode, which is set into a bath different from the bath for the two main electrodes, it is possible to control the ratio between the current value for taking charge of anodic reaction caused on the aluminum plate opposite to the main electrodes and the current value for taking charge of cathodic reaction. On the aluminum plate opposite to the main electrodes, the ratio of the electricity quantity for the cathodic reaction to that for the anodic reaction (i.e., the ratio of the electricity quantity in the cathodic reaction time to that in the anodic reaction time) is preferably from 0.3 to 0.95.

The electrolytic bath may be a known electrolytic bath used in surface treatment, for example, a bath of a lengthwise type, a flat type, a radial type, or some other type. A radial type electrolytic bath, as described in JP-A No. 5-195300, is particularly preferable. The electrolyte passed in the electrolytic bath may be in parallel to or opposite to the direction in which the aluminum plate is advanced.

(Nitric Acid Electrolysis)

Electrochemical surface-roughening treatment using an electrolyte mainly composed of nitric acid can form pits having an average aperture size of 0.5 to 5 μm. When the electricity quantity is relatively high, the electrolysis reaction is concentrated, which can generate honeycomb pits larger than 5 μm. To obtain such grain, the total of the electricity quantity used for the anodic reaction of the aluminum plate at the point when the electrolysis reaction is completed is preferably 1 to 1,000 C/dm², more preferably 50 to 300 C/dm2, and the electric current density at that point is preferably 20 to 100 A/d m². When a concentrated or hot nitric acid electrolyte is used, a small wave structure having an average aperture size of 0.2 μm or less can be formed.

(Hydrochloric Acid Electrolysis)

As hydrochloric acid has a high dissolution power for aluminum, it can form fine irregularities on aluminum surface by the application of slight electrolysis. Such fine irregularities have an average aperture size of 0.01 to 0.2 μm, and are uniformly generated on the entire surface of an aluminum plate. To obtain such grain, the total of the electricity quantity used for the anodic reaction of the aluminum plate at the point when the electrolysis reaction is completed is preferably 1 to 100 C/dm², more preferably 20 to 70 C/dm², and the electric current density is preferably 20 to 50 A/dm².

In this electrochemical surface-roughening treatment using the electrolyte made mainly of hydrochloric acid, large undulations in a crater form can be simultaneously formed by making the total of electricity quantities for taking charge of the anodic reaction as large as a value ranging 400 to 1000 C/dm². In this case, fine irregularities having an average aperture size of 10 to 30 μm are superimposed with the crater undulations, which have an average aperture size of 10 to 30 μm, and the fine irregularities are made in the entire surface.

The aluminum plate is preferably subjected to the cathodic electrolyzing treatment between the first and second electrolyzing treatment performed in an electrolyte such as a nitric acid or hydrochloric acid electrolyte. The cathodic electrolyzing treatment forms smut on the surface of the aluminum plate and at the same time generates hydrogen gas, which allows more uniform electrolyzing treatment. The cathodic electrolyzing treatment is performed in an acidic solution at a cathodic electricity quantity of preferably 3 to 80 C/dm², more preferably 5 to 30 C/dm². The cathodic electricity quantity less than 3 C/dm² is not favorable because it can cause the shortage of smut deposition. The quantity exceeding 80 C/dm² is also not favorable because it can cause excessive smut deposition. The electrolyte may be same as or different from the solution used in the first and second electrolyzing treatment.

<Alkali Etching>

The alkali etching treatment is treatment for bringing the aluminum plate into contact with an alkali solution to dissolve the surface layer thereof.

The object of the alkali etching treatment performed before the electrolyzing treatment is, when no mechanical surface-roughening treatment has been conducted, to remove the rolling oil, stains, natural oxidation film or the like from the surface of the aluminum plate (rolled aluminum), and when the mechanical surface-roughening treatment has been performed, to dissolve the edge of the irregularities formed by the mechanical surface-roughening treatment to modify the surface with steep irregularities into a surface having smooth undulations.

In the case of conducting no mechanical surface-roughening treatment, the alkali etching treatment conducted before the electrochemical surface-roughening treatment is for removing rolling oil, stains, naturally-oxidized film and others on the surface of the aluminum plate (e.g., rolled aluminum). In the case of conducting the mechanical surface-roughening treatment already, this treatment is for dissolving edges of irregularities generated by the mechanical surface-roughening treatment to convert the sharp irregularities to the surface having gently-sloping undulations.

In the case of conducting the mechanical surface-roughening treatment before the alkali etching treatment, the etching amount is preferably from 3 to 20 g/m², more preferably from 5 to 15 g/m². If the etching amount is less than 3 g/m², the irregularities made by the mechanical surface-roughening treatment and so on may not be made smooth. Thus, in the subsequent electrochemical treatment, uniform pits may not be formed. Additionally, staining may increase at the time of printing. On the other hand, if the etching amount is more than 20 g/m2, the irregularities may disappear.

The objects of the alkali etching treatment performed immediately after the electrolyzing treatment are to dissolve smut formed in the acidic electrolyte, and to dissolve the edge of the pits formed by the electrolyzing treatment. The pits formed by the electrolyzing treatment are varied by the type of the electrolyte, and therefore the preferable etching amount is varied. However, the etching amount in the alkali etching treatment performed after the electrolyzing treatment is preferably 0.1 to 5 g/m². When a nitric acid electrolyte is used, the etching amount must be higher than the case when a hydrochloric acid electrolyte is used. When the electrolyzing treatment is conducted plural times, the alkali etching treatment may be performed as needed after each treatment.

Examples of the alkali used in the alkali solution include caustic alkalis and alkali metal salts. Specific examples of the caustic alkalis include caustic soda and caustic potassium. Specific examples of the alkali metal salts include alkali metal silicates such as sodium metasilicate, sodium silicate, potassium metasilicate, and potassium silicate; metal carbonates such as sodium carbonate and potassium carbonate; alkali metal aluminates such as sodium aluminate and potassium aluminate; alkali metal aldonates such as sodium gluconate and potassium gluconate; and alkali metal (hydrogen)phosphates such as disodium hydrogenphosphate, dipotassium hydrogenphosphate, trisodium phosphate, and tripotassium phosphate. A solution of a caustic alkali and a solution containing both of a caustic alkali and an alkali metal aluminate are preferable since the solutions give a high etching rate and are inexpensive. An aqueous caustic soda solution is particularly preferable.

The alkali concentration of the alkali solution, which can be decided dependently on the etching amount, is preferably from 1 to 50% by mass, more preferably from 3 to 35% by mass. In the case that aluminum ions are dissolved in the alkali solution, the concentration of the aluminum ions is preferably from 0.01 to 10% by mass, more preferably from 3 to 8% by mass. The temperature of the alkali solution is preferably from 20 to 90° C. The time for the treatment is preferably from 1 to 120 seconds.

Examples of the method for bringing the aluminum plate into contact with the alkali solution include a method of passing the aluminum plate through a bath in which the alkali solution is put, a method of immersing the aluminum plate into a bath in which the alkali solution is put, and a method of spraying the alkali solution onto the surface of the aluminum plate.

<Desmutting Treatment>

After the electrochemical surface-roughening treatment and the alkali etching treatment, washing with an acid (desmutting treatment) is conducted to remove the smut remaining on the surface. Examples of the used acid include nitric acid, sulfuric acid, phosphoric acid, chromic acid, hydrofluoric acid, and fluoroboric acid.

The desmutting treatment is conducted, for example, by bringing the aluminum plate into contact with an acidic solution which has an acid concentration of 0.05 to 30% by mass, the acid being hydrochloric acid, nitric acid, sulfuric acid or the like, (and may contain 0.01 to 5% by mass of aluminum ions). Examples of the method for bringing the aluminum plate into contact with the acidic solution include a method of passing the aluminum plate through a bath in which the acidic solution is put, a method of immersing the aluminum plate into a bath in which the acidic solution is put, and a method of spraying the acidic solution onto the surface of the aluminum plate. In the desmutting treatment, it is permissible to use, as the acidic solution, waste of the aqueous solution made mainly of nitric acid or the aqueous solution made mainly of hydrochloric acid discharged in the electrochemical surface-roughening treatment, or to use wastes of an aqueous solution made mainly of sulfuric acid discharged in acidic oxidation treatment, which will be detailed later. The liquid temperature in the desmutting treatment is preferably from 25 to 90° C. The time for the treatment is preferably from 1 to 180 seconds. Aluminum and aluminum alloy may be dissolved in the acidic solution used in the desmutting treatment.

The aluminum plate whose surface is roughened as described above is subjected to alkali-etching treatment and neutralizing treatment if necessary. Thereafter, the aluminum plate is subjected to anode-oxidizing treatment if desired, in order to improve the water retentivity or abrasion resistance of the surface. The electrolyte used in the anodic oxidation treatment of the aluminum plate is any one selected from various electrolytes which can form a porous oxide film. Sulfuric acid, phosphoric acid, oxalic acid, chromic acid, or a mixed acid thereof is generally used. The concentration of the electrolyte may be appropriately decided depending on the kind of the electrolyte.

Treatment conditions for the anodic oxidation cannot be specified uniquely since the conditions vary depending on the used electrolyte; however, the following conditions are generally suitable: an electrolyte concentration of 1 to 80% by mass, a solution temperature of 5 to 70° C., a current density of 5 to 60 A/dm2, a voltage of 1 to 100 V, and an electrolyzing time of 10 seconds to 5 minutes. If the amount of the oxide film on anode is less than 2.0 g/m², non-image areas of the planographic printing plate are easily scared so that the so-called “scar blemishes”, resulting from ink adhesion to scared areas at printing, are easily generated. After the anodic oxidation treatment, the aluminum surface is subjected to hydrophilizing treatment with silicate.

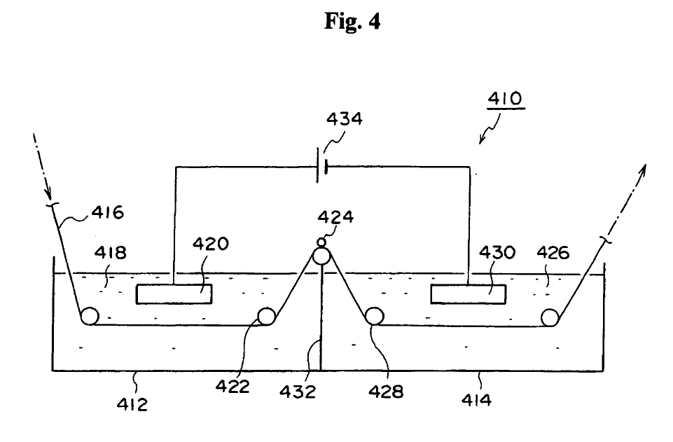

An anodic oxidation device having the structure illustrated in FIG. 4 was used to conduct anodic oxidation treatment. In FIG. 4, reference numeral 11 represents an aluminum plate; 12, a radial drum roller; 13a and 13b, main electrodes; 14, an electrolyte; 15, an electrolyte supplying port; 16, a slit; 17, an electrolyte passage; 18, an auxiliary electrode; 19a and 19b, thyristors; 20, an AC power supply; 40, a main electrolytic bath; and 50, an auxiliary cathode bath.

A hydrophilic layer is formed on the above-described support surface, and the support according to the invention contains a layer having surface hydrophilicity.

[Hydrophilic Layer]

The hydrophilic layer on the support may be a hydrophilized anodic oxidation coating on the support surface, or an independent hydrophilic layer on the support surface formed by application, dipping or other methods.

Hydrophilization of the support surface is further described below.

—Hydrophilic Surface and Hydrophilizing Treatment—

The hydrophilic surface may be an anodic oxidation coating, more preferably a hydrophilized anodic oxidation coating. The hydrophilic surface refers to that having a contact angle with water of smaller than 10° C., and the contact angle is most preferably smaller than 5° C. Furthermore, after the hydrophilizing treatment, the hydrophilized compound is preferably adsorbed to the anodic oxidation coating.

Examples of the hydrophilizing treatment include a potassium zirconium fluoride treatment as described in U.S. Pat. No. 2,946,638, a phosphomolybdate treatment as described in U.S. Pat. No. 3,201,247, an alkyl titanate treatment as described in U.K. Patent No. 1,108,559, a polyacrylic acid treatment as described in German Patent No. 1,091,433, a polyvinylphosphonic acid treatment as described in German Patent No. 1,134,093 and U.K. Patent No. 1,230,447, a phosphonic acid treatment as described in Japanese Patent Application Publication (JP-B) No. 44-6409, a phytic acid treatment as described in U.S. Pat. No. 3,307,951, a treatment with a salt of a hydrophilic organic polymer compound and a divalent metal as described in Japanese Patent Application Laid-Open (JP-A) Nos. 58-16893 and 58-18291, and a dipping treatment with a polyvalent sulfonic acid compound such as tamol.

Furthermore, undercoating of phosphates as described in JP-A No. 62-019494, water-soluble epoxy compounds as described in JP-A No. 62-033692, phosphoric acid-modified starch as described in JP-A No. 62-097892, diamine compounds as described in JP-A No. 63-056498, inorganic or organic acids of amino acids as described in JP-A No. 63-130391, organic phosphonic acids containing carboxyl or hydroxyl groups as described in JP-A No. 63-145092, compounds containing amino groups and phosphonic acid groups as described in JP-A No. 63-165183, specific carboxylic acid derivatives as described in JP-A No. 2-316290, phosphates as described in JP-A No. 3-215095, compounds each having one amino group and one phosphoric oxygen acid group as described in JP-A No. 3-261592, phosphates as described in JP-A No. 3-215095, aliphatic or aromatic phosphonic acids such as phenylphosphonic acid as described in JP-A No. 5-246171, S atom-containing compounds such as thiosalicylic acid as described in JP-A No. 1-307745, and compounds having phosphoric oxygen acid groups as described in JP-A No. 4-282637, and coloring with acidic dyes described in JP-A No. 60-64352 may also be carried out.

<Silicate Treatment>

The embodiment of the direct-writing recording medium for producing the direct-writing planographic printing plate of the invention is characterized by having a silicate layer at a coating weight of 2.0 to 25 mg/m2. The silicate layer is formed by the silicate treatment.

Hydrophilizing treatment using an aqueous solution of alkali metal silicate such as silicate of soda and potassium silicate can be performed in accordance with the methods and procedures as described in U.S. Pat. Nos. 2,714,066 and 3,181,461. Examples of the alkali metal silicate include, sodium silicate, potassium silicate and lithium silicate. The aqueous solution of the alkali metal silicate may contain an appropriate amount of sodium hydroxide, potassium hydroxide, lithium hydroxide or the like. The aqueous solution of the alkali metal silicate may contain alkaline earth metal salts or group 4 (Group IVA) metal salts. Examples of the alkaline earth metal salt include nitric acid salts such as nitric acid calcium, nitric acid strontium, nitric acid magnesium, nitric acid barium; sulfuric acid salts; hydrochloric acid salts; phosphorus acid salts; acetic acid salts; oxalic acid salt; and boric acid salts. Examples of the group 4 (Group IVA) metal salts include titanium tetrachloride, titanium trichloride, potassium fluorotitanate, potassium titanium oxalate, titanium sulfate, titanium tetraiodide, zirconyl chloride octahydrate, zirconium oxychloride and zirconium tetrachloride. These alkaline earth metal salts and group 4 (Group IVA) metal salts may be used alone or in combination of two or more of them.

In the embodiment of the invention, the deposit of silicate must be 2.0 to 25 mg/m2, preferably 2, 0 to 20.0 mg/m², more preferably 5.0 to 15.0 mg/m². When the deposit of silicate is 2.0 mg/m² or more, ink bleeding is reduced and stain resistance is increased. When the deposit of silicate is 20.0 mg/m² or less, the resulting planographic printing plate has favorable printing durability. The characteristics obtained by providing a silicate layer will not be further improved even if the deposit of silicate is increased exceeding 25 mg/m², which is also disadvantageous from the viewpoint of cost. Silicate may be present on the anodic oxidation film in a continuous layer form or an island form.

The amount of silicate is measured, for example, as the amount of Si atoms (mg/m2) by a calibration curve method using an X-ray fluorescence analyzer. More specifically, the amount of Si atoms can be measured from the peak height of Si—Kα spectrum, for example, using an X-ray fluorescence analyzer (trade name: RIX3000, manufactured by Rigaku Corporation) under following conditions.
Equipment: RIX3000 manufactured by Rigaku Corporation
X-ray tube: Rh
Measured spectrum: Si—Kα
Tube voltage: 50 kV
Tube current: 50 mA
Slit: COARSE
Analyzing crystal: RX4
Detector: F—PC
Analyzed area: 30 mm φ
Peak position (2θ): 144.75 deg.
Background (2θ): 140.70 deg, 146.85 deg.
Integration time: 80 seconds/sample

<Sol-Gel Hydrophilic Layer>

In the another embodiment of the invention, before the formation of an ink receiving layer, a hydrophilic layer surface containing a sol-gel structure is provided in place of the hydrophilic layer comprising a silicate layer.

In the invention, a sol-gel hydrophilic layer may be provided before an ink receiving layer is formed on a support (substrate) in the production of a direct-writing recording medium for producing the direct-writing planographic printing plate. The support substrate is not particularly limited as long as it is a dimensionally stable plate-shaped material having necessary strength and durability. Examples thereof include paper, paper laminated with plastic (e.g., polyethylene, polypropylene and polystyrene), metal plates (e.g., aluminum, zinc and copper), plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate and polyvinyl acetal), and paper or plastic films deposited or laminated with the metal.

The composition of the sol-gel hydrophilic layer is described below.

<Hydrophilic Binder>

The sol-gel hydrophilic layer in the invention contains a hydrophilic binder. The hydrophilic binder is preferably a sol-gel transforming material composed of a system of a metal hydroxide and a metal oxide, and particularly preferable is a sol-gel transforming system that forms a gel structure of polysiloxane. The binder serves as a dispersion medium for the constituents of the hydrophilic layer. The composition enhances various factors such as the physical strength of the layer, dispersibility of the constituents of the layer, coatability, printing suitability and convenience in platemaking.

The content of the hydrophilic binder with reference to the total solid of the hydrophilic layer is preferably 30% by mass or higher, more preferably 35% by mass or higher. A content 30% by mass or less is undesirable in that the hydrophilic layer has poor water resistance and abrasion resistance.

The hydrophilic polymer binder preferably used in the hydrophilic layer of the direct-writing recording medium for producing the direct-writing planographic printing plate of the invention may be an organic polymer compound for imparting adequate strength and surface hydrophilicity to the hydrophilic layer. Specific examples include polyvinyl alcohol (PVA), modified PVA such as carboxy modified PVA, starch and derivatives thereof, cellulose derivatives such as carboxy methyl cellulose and hydroxyethyl cellulose, casein, gelatin, polyvinyl pyrrolidone, vinyl acetate-crotonic acid copolymer, styrene-maleic acid copolymer, polyacrylic acid and salts thereof, and water-soluble resins such as water-soluble acrylic copolymer mainly composed of polyacrylamide or water-soluble acrylic monomer such as acrylic acid and acrylamide.

Examples of the water resistant additive for crosslinking and hardening the organic polymer compound include initial condensates of aminoplast such as glyoxal, melamine formaldehyde resins and urea formaldehyde resins, methylolated polyamide resins, polyamide.polyamine.epichlorohydrin adducts, polyamide-epichlorohydrin resins and modified polyamide-polyimide resins. These compounds may be used in combination with a crosslinking catalyst such as ammonium chloride and a silane coupling agent.

The system capable of undergoing the sol-gel transformation that is preferably used in the invention is described in detail in books such as “Science of Sol-Gel Process (Sol-Gel Houno Kagaku)”, by Sumio Sakka, Agune-Shofu-Sha (1988), “Latest Technique for Preparing Functional Thin Film by Sol-Gel Process (Saishin Sol-Gelhouniyoru Kinouseihakumaku Sakuseigijutu)”, by Ken Hirashima, Sogo Gijutu Center (1992).

Linking groups of polyvalent elements are bonded together through oxygen atoms to form a network structure and the polyvalent metal simultaneously has free hydroxyl groups and/or alkoxy groups to thus form a resinous structure in which the foregoing constituents are mixed. Thus, the system is in a sol state before application when it contains much of alkoxy and hydroxyl groups, while the network-like resinous structure is strengthened and the system turns into a gel state as the reaction for forming ether bonds proceeds after application. In addition, the degree of hydrophilicity of the resinous structure is variable, and a part of the hydroxyl groups are linked to solid fine particles to modify the surface of the particles and to thus change the degree of the hydrophilicity. Such polyvalent bonding elements having hydroxyl and alkoxy groups undergoing the sol-gel transformation are aluminum, silicon, titanium and zirconium and either of them can be used in the invention. The sol-gel transformation system, which makes used of siloxane bonds and can more preferably be used in the invention, is described in detail below. Sol-gel transformation using aluminum, titanium and zirconium can be carried out according to the following procedures described in connection with silicon, while these elements are substituted for the silicon.

The hydrophilic matrix formed through such sol-gel transformation is preferably a resin having siloxane bonds and silanol groups. The hydrophilic layer of the direct-writing recording medium for producing the direct-writing planographic printing plate of the invention is formed by applying a coating liquid or a sol system containing a silane compound having at least one silanol group and then drying the coated layer. Thus, the hydrolysis, decomposition and condensation of silanol groups proceed as the elapse of time to thus form a structure having a siloxane skeleton and the gelation thereof proceeds. The siloxane resin having a gel structure is represented by the following formula (I), and the silane compound having at least one silanol group is represented by the following formula (II). The substance system that is contained in the hydrophilic layer and changes from hydrophilic into hydrophobic is not necessarily the silane compound alone represented by the formula (II), but generally may be an oligomer having a partially hydrolytically condensed silane compound, or a mixed composition of a silane compound and its oligomer.

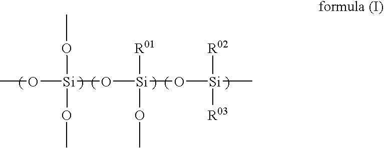

The siloxane-based resin represented by the formula (I) is formed by sol-gel transformation from a dispersion liquid containing at least one silane compound represented by the formula (II). At least one of R⁰¹ to R⁰³ in the formula (I) represents a hydroxyl group, and others independently represent an organic residue selected from R⁰ and Y¹ in the following formula (II).
(R⁰)nSi(Y¹)₄₋ₙ Formula (II)

In the formula (II), R⁰ represents a hydroxyl group, a hydrocarbon group or a heterocycle group, Y¹ represents a hydrogen atom, a halogen atom, —OR¹¹, —OCOR¹² or —N(R¹³)(R¹⁴), wherein R¹¹ and R¹² independently represent a hydrocarbon group, and R¹³ and R¹⁴ independently represent a hydrogen atom or a hydrocarbon group, and may be same or different. n represents 0, 1, 2 or 3.

Examples of the hydrocarbon group or the heterocycle group represented by R⁰ in the formula (II) include straight-chain or branched-chain alkyl groups having a carbon number of 1 to 12 that may be substituted (e.g., methyl group, ethyl group, propyl group, butyl group, pentyl group, hexyl group, heptyl group, octyl group, nonyl group, decyl group and dodecyl group), wherein examples of the substitute include halogen atom such as chlorine atom, fluorine atom and bromine atom, hydroxy group, thiol group, carboxy group, sulfo group, cyano group, epoxy group, —OR¹ group, wherein R¹ represents a methyl group, an ethyl group, a propyl group, a butyl group, a heptyl group, a hexyl group, an octyl group, a decyl group, a propenyl group, a butenyl group, a hexenyl group, an octenyl group, a 2-hydroxyethyl group, a 3-chloropropyl group, a 2-cyanoethyl group, a N,N-dimethylaminoethyl group, a 2-bromoethyl group, a 2-(2-methoxyethyl)oxyethyl group, a 2-methoxycarbonylethyl group, a 3-carboxy propyl group, a benzyl group or other groups, —OCOR² group, wherein R² represents the same group as the R¹, a —COOR group, a —COR² group, a —N(R³)(R³) group, wherein R³represents a hydrogen atom or the same group as the R1, and may be same or different each other, a —NHCONHR2 group, a —NHCOOR2 group, a —Si(R2)3 group, a —CONHR³ group and a —NHCOR² group, and one or more thereof may be present in an alkyl group; a straight-chain or branched-chain alkenyl group having a carbon number of 2 to 12 that may be substituted (e.g., vinyl group, propenyl group, butenyl group, pentenyl group, hexenyl group, octenyl group, decenyl group and dodecenyl group), wherein the substituents may the same as those for the alkyl groups; an aralkyl group having a carbon number of 7 to 14 (e.g., benzyl group, phenethyl group, 3-phenylpropyl group, naphthylmethyl group and 2-naphthylethyl group, wherein the substituents may be the same as those for the alkyl groups, and one or more thereof may be present; an alicyclic group having a carbon number of 5 to 10 that may be substituted (e.g., cyclopentyl group, cyclohexyl group, 2-cyclohexyl ethyl group, 2-cyclopentylethyl group, norbornyl group and adamantyl group), wherein the substituents may be the same as those for the alkyl groups, and one or more thereof may be present; an aryl group having a carbon number of 6 to 12 that may be substituted (e.g., phenyl group and naphthyl group), wherein the substituents may the same as those for the alkyl groups, and one or more thereof may be present; or a heterocycle group containing at least one atom selected from a nitrogen atom, an oxygen atom and a sulfur atom (e.g., pyran ring, furan ring, thiophene ring, morpholine ring, pyrrole ring, thiazole ring, oxazole ring, pyridine ring, piperidine ring, pyrrolidone ring, benzothiazole ring, benzoxazole ring, quinoline ring and tetrahydrofuran ring) that may be fused and substituted, wherein the substituents may be same as those for the alkyl group, and one or more thereof may be present.

The OR¹¹ group, —OCOR¹² group or N(R¹³)(R¹⁴) group represented by Y¹ in the formula (II) independently represent, for example, following groups. In the —OR group, R¹¹ represents an aliphatic group having a carbon number of 1 to 10 that may be substituted (e.g., methyl group, ethyl group, propyl group, butoxy group, heptyl group, hexyl group, pentyl group, octyl group, nonyl group, decyl group, propenyl group, butenyl group, heptenyl group, hexenyl group, octenyl, decenyl group, 2-hydroxyethyl group, 2-hydroxypropyl group, 2-methoxyethyl group, 2-(methoxyethyloxo)ethyl group, 2-(N,N-diethylamino)ethyl group, 2-methoxypropyl group, 2-cyanoethyl group, 3-methyloxapropyl group, 2-chloroethyl group, cyclohexyl group, cyclopentyl group, cyclooctyl group, chlorocyclohexyl group, methoxy cyclohexyl group, benzyl group, phenethyl group, dimethoxy benzyl group, methylbenzyl group and bromobenzyl group). In the OCOR¹² group, R¹² represents the same aliphatic group as R¹¹ or an aromatic group having a carbon number of 6 to 12 that may be substituted, wherein examples of the aromatic group include the same groups as those listed for the aryl group represented by R. In the N(R¹³)(R¹⁴) group, R¹³ and R¹⁴ may be same or different, and independently represent a hydrogen atom or an aliphatic group having a carbon number of 1 to 10 that may be substituted (e.g., same groups as the R¹¹ in the —OR¹¹ group). More preferably, the total carbon number of R¹¹ and R¹² is 16 or less. Specific examples of the silane compound represented by the formula (II) include:

tetrachlorosilane, tetrabromosilane, tetramethoxysilane, tetraethoxysilane, tetraisopropoxysilane, tetrabutoxysilane, methyl trichlorosilane, methyltribromosilane, methyltrimethoxysilane, methyltriethoxysilane, methyltriisopropoxysilane, methyltri-t-butoxysilane, ethyltrichlorosilane, ethyltribromosilane, ethyltrimethoxysilane, ethyltriethoxysilane, ethyltriisopropoxysilane, ethyltri-t-butoxysilane, n-propyltrichlorosilane, n-propyltribromosilane, n-propyltrimethoxysilane, n-propyltriethoxysilane, n-propyltriisopropoxysilane, n-propyltrit-butoxysilane, n-hexyl trichlorosilane, n-hexyltribromosilane, n-hexyltrimethoxysilane, n-hexyltriethoxysilane, n-hexyltriisopropoxysilane, n-hexyltrit-butoxysilane, n-decyltrichlorosilane, n-decyltribromosilane, n-decyltrimethoxysilane, n-decyltriethoxysilane, n-decyltriisopropoxysilane, n-decyltrit-butoxysilane, n-octadecyltrichlorosilane, n-octadecyltribromosilane, n-octadecyltrimethoxysilane, n-octadecyltriethoxysilane, n-octadecyltriisopropoxysilane, n-octadecyltrit-butoxysilane, phenyltrichlorosilane, phenyltribromosilane, phenyltrimethoxysilane, phenyltriethoxysilane, phenyltriisopropoxysilane, phenyltri-t-butoxysilane, dimethoxydiethoxysilane, dimethyldichlorosilane, dimethyldibromosilane, dimethyldimethoxysilane, dimethyldiethoxysilane, diphenyldichlorosilane, diphenyldibromosilane, diphenyldimethoxysilane, diphenyldiethoxysilane, phenylmethyldichlorosilane, phenylmethyldibromosilane, phenylmethyldimethoxysilane, phenylmethyldiethoxysilane, triethoxyhydrosilane, tribromohydrosilane, trimethoxyhydrosilane, isopropoxyhydrosilane, tri-t-butoxyhydrosilane, vinyl trichlorosilane, vinyltribromosilane, vinyltrimethoxysilane, vinyltriethoxysilane, vinyltriisopropoxysilane, vinyltri-t-butoxysilane, trifluoropropyl trichlorosilane, trifluoropropyltribromosilane, trifluoropropyltrimethoxysilane, trifluoropropyltriethoxysilane, trifluoropropyltriisopropoxysilane, trifluoropropyltri-t-butoxysilane, γ-glycidoxypropylmethyldimethoxysilane, γ-glycidoxypropylmethyldiethoxysilane, γ-glycidoxypropyltrimethoxysilane,

γ-glycidoxypropyltriethoxysilane, γ-glycidoxypropyltriisopropoxysilane, γ-glycidoxypropyltrit-butoxysilane, γ-methaacryloxypropylmethyldimethoxysilane, γ-methaacryloxypropylmethyldiethoxysilane, γ-methaacryloxypropyltrimethoxysilane, γ-methaacryloxypropyltriisopropoxysilane, γ-methaacryloxypropyltri-t-butoxysilane, γ-aminopropylmethyldimethoxysilane, γ-aminopropylmethyldiethoxysilane, γ-amino propyltrimethoxysilane, γ-aminopropyltriethoxysilane, γ-aminopropyltriisopropoxysilane, γ-aminopropyltrit-butoxysilane, γ-mercaptopropylmethyldimethoxysilane, γ-mercaptopropylmethyldiethoxysilane, γ-mercaptopropyltrimethoxysilane, γ-mercaptopropyltriethoxysilane, γ-mercaptopropyltriisopropoxysilane, γ-mercaptopropyltrit-butoxysilane, β-(3,4-epoxycyclohexyl)ethyltrimethoxysilane and β-(3,4-epoxycyclohexyl)ethyltriethoxysilane.

The silane compound represented by the formula (II) used in the formation of the hydrophilic layer according to the invention may be used in combination with metal compounds such as Ti, Zn, Sn, Zr and Al compounds that combine with a resin during sol-gel transformation to form a film. Examples of the metal compounds include Ti(OR²)₄ (wherein R² represents a methyl group, an ethyl group, a propyl group, a butyl group, a pentyl group, a hexyl group or other groups), TiCl₄, Zn(OR²)₂, Zn(CH₃COCHCOCH₃)₂, Sn(OR²)₄, Sn(CH₃COCHCOCH₃)₄, Sn(OCOR²)₄, SnCl₄, Zr(OR²)₄, Zr(CH₃COCHCOCH₃)₄ and Al(OR²⁾₃.

The matrix having a gel structure may contain hydrophilic polymers or crosslinking agents having silane coupling groups at the ends of the main chain for the purposes of improving the physical properties such as strength and flexibility and the application properties of the film, and controlling the film hydrophilicity.

Examples of the hydrophilic polymer having silane coupling groups at the ends of the main chain include polymers represented by the following formula (1).

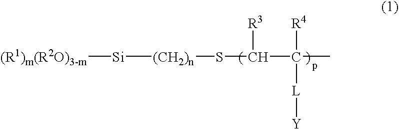

In the formula (1), R¹, R², R³ and R⁴ independently represent a hydrogen atom or a hydrocarbon group having a carbon number 8 or less, m represents 0, 1 or 2, n represents an integral number of 1 to 8, and p represents an integral number of 30 to 300. Y represents —NHCOCH₃, —CONH₂, —CON(CH₃)₂, —COCH₃, —OCH₃, —OH, —CO₂M or CONHC(CH₃)₂SO₃M, and M represents one member selected from a group consisting of a hydrogen atom, an alkali metal, an alkaline earth metal and onium.

L represents a single bond or an organic linking group, wherein the organic linking group represents a polyvalent linking group composed of nonmetal atom, and specifically is a group composed of 1 to 60 carbon atoms, 0 to 10 nitrogen atoms, 0 to 50 oxygen atoms, 1 to 100 hydrogen atoms and 0 to 20 sulfur atoms. More specific examples of the linking group include the structural units shown below or the combination groups thereof.

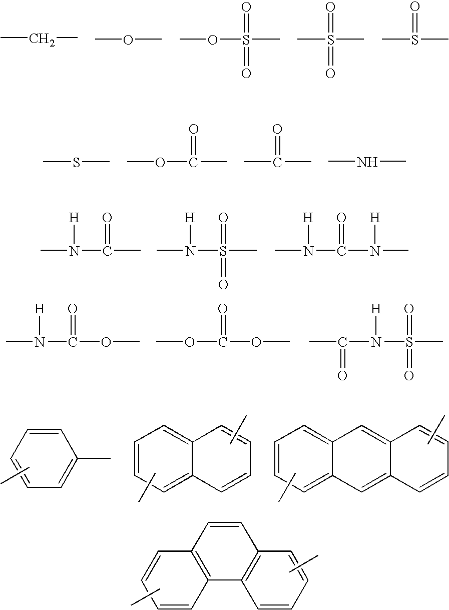

Specific examples of the hydrophilic polymer having a silane coupling group as represented by the formula (1) include the polymers shown below. In the following specific examples, p may be any value between 100 to 250.

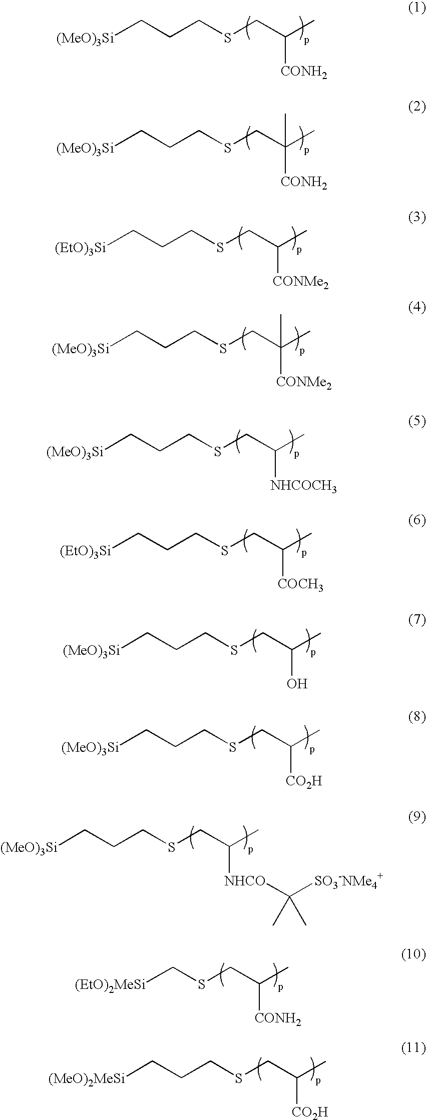

The hydrophilic polymer according to the invention can be synthesized by the radical polymerization of radical polymerizable monomers represented by the following formula (2) and a silane coupling agent represented by the following formula (3) that is capable of chain-transfer in radical polymerization. Since the silane coupling agent represented by the formula (3) is capable of chain transfer, a polymer having a silane coupling group at the ends of the main chain can be synthesized in the radical polymerization. R¹, R², R³, R⁴, L, Y, m and n in the formulae (2) and (3) below represent the same members as those in the formula (1).

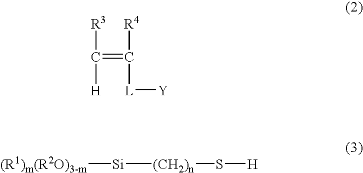

As described above, it is particularly preferable for the recording medium for producing the direct-writing planographic printing plate of the invention to provide a hydrophilic layer formed by a sol-gel process between the ink receiving layer and the support.

<Inorganic Particles>

The hydrophilic layer comprising a sol-gel structure in the invention may contain inorganic particles for the purposes of improving the strength of the cured film in the image area and the developability in the non-image area on machine.

Preferable examples of the inorganic particle include silica, alumina, magnesium oxide, titanium oxide, magnesium carbonate, calcium alginate and mixtures thereof.

These particles, even if they are not photothermal conversion agents, can be used for improving the strength of the film, enhancing the interface adhesiveness by surface roughening, and other purposes.

The average particle diameter of the inorganic particles is preferably 5 nm to 10 μm, more preferably 0.5 μm to 3 μm. Within the range, the particles are stably dispersed in the hydrophilic layer to sufficiently maintain the film strength, and forms a non-image area that has an excellent hydrophilicity and is resistant to stains during printing.

The inorganic particles as described above are readily available as commercial products such as a colloidal silica dispersion.

The content of the inorganic particles with reference to the total solid of the hydrophilic layer is preferably 20% by mass or less, more preferably 10% by mass or less.

<Formation of Sol-Gel Hydrophilic Layer>

The sol-gel hydrophilic layer is formed by dispersing or dissolving the necessary components in a solvent to prepare a coating liquid, and applying the liquid. Examples of the solvent include ethylene dichloride, cyclohexanone, methylethylketone, methanol, ethanol, propanol, ethyleneglycolmonomethyl ether, 1-methoxy-2-propanol, 2-methoxyethyl acetate, 1-methoxy-2-propyl acetate, dimethoxy ethane, methyl lactate, ethyl lactate, N,N-dimethyl acetamide, N,N-dimethylformamide, tetramethylurea, N-methylpyrrolidone, dimethylsulfoxide, sulfolane, γ-butyllactone, toluene and water, but the solvent is not limited to them. These solvents may be used alone or in combination with each other. The solid content of the coating liquid is preferably 1% to 50% by mass.

The sol-gel hydrophilic layer according to the invention may be formed by repeatedly applying and drying multiple coating liquids prepared by dispersing or dissolving the above components, which may be same or different, in same or different solvents.

A sol-gel hydrophilic layer can be formed by applying the hydrophilic coating liquid composition prepared as described above to a support surface, and drying it. The film thickness of the sol-gel hydrophilic layer can be selected in accordance with the intended use, but usually in the range of 0.5 to 5.0 g/m², preferably 1.0 to 3.0 g/m² as the coating weight on a dry base. A coating weight less than 0.5 g/m² is not undesirable in that it develops poor hydrophilicity, and a coating weight exceeding 5.0 g/m² is also not undesirable in that it will deteriorate the film strength.

[Ink Receiving Layer]

The recording medium for planographic printing plate of the invention has an ink receiving layer on the surface of a hydrophilic layer on a support. The ink receiving layer contains one or more compounds selected from the group consisting of organic fluorine compounds having a fluoroalkyl group and compounds having a dimethyl siloxane skeleton (hereinafter may be referred to as specific water-repellent compounds) for the purpose of preventing ink bleeding. The ink receiving layer containing a specific water-repellent compound is preferably combined with a hydrophilic resin for giving the ink receiving layer removability with dampening water or the like, and thereby effectively preventing the formation of stains in the non-image area.

The specific water-repellent compounds are described in the followings.

<Organic Fluorine Compound Having a Fluoroalkyl Group>

A preferable fluorine-based compound according to the invention is represented by the formula RF—Rₚₒₗ, wherein RF represents a straight-chain or branched-chain fluoroalkyl group having 3 or more carbon atoms, Rₚₒₗ represents a polar group such as carboxylic acid or salts thereof, sulfonic acid or salts thereof, phosphoric acid or salts thereof, phosphonic acid or salts thereof, amino groups or salts thereof, quaternary ammonium salts, polyethyleneoxy skeletons, polypropyleneoxy skeletons, sulfonamide groups, ether groups and betaine structures. Of these members, those having a sulfoxylic group or its salt are more preferable because they hardly interact with silicate and thus have good developability on machine. RF is most preferably a member having a CₙF₂ₙ₊₁CₘH₂ₘCOO— skeleton from the viewpoint of reducing ink bleeding, more preferably a member having two or more CₙF₂ₙ₊₁CₘH₂ₘCOO— skeletons per molecule, wherein n is an integral number of 2 or more, and m is an integral number of 1 or more.

Specific examples of the fluorine-based compound preferably used in the invention ([(F-1) to (F-19)] are listed below, but the invention is not limited to them.

The another embodiment of the invention is characterized by providing an ink receiving layer on the surface of a hydrophilic layer selected from the silicate layer or the sol-gel hydrophilic layer. The ink receiving layer contains 1.0 to 50.0 mg/m² of an organic fluorine compound having five or more fluorine atoms per molecule, or contains 1.0 to 50 mg/m2 of an organic fluorine compound having five or more fluorine atoms per molecule and 1.0 to 50.0 mg/m2 of a hydrophilic resin.

Such ink receiving layer is provided on the surface of a hydrophilic layer comprising a silicate layer or a hydrophilic layer containing a sol-gel structure that has been previously provided on a support.

The direct-writing recording medium for producing the direct-writing planographic printing plate of the invention comprises an aluminum substrate and an anodic oxidation film thereon, the surface of the anodic oxidation film having provided thereon a silicate layer by silicate treatment or a sol-gel hydrophilic layer, and the surface of the silicate layer or the sol-gel hydrophilic layer having provided thereon an ink receiving layer. The ink receiving layer may contain an organic fluorine compound having five or more fluorine atoms in the range of 50 mg/m2 or less. When the content of the organic fluorine compound is within the range of 1.0 to 50.0 mg/m2, the plate precursor exhibits both adhesiveness for the image area region and surface hydrophilicity during making a planographic printing plate, by which achieves stain resistance and printing durability of the non-image area.

<Organic Fluorine Compound Having Five or More Fluorine Atoms>

A preferable organic fluorine compound that can be used in the invention have five or more fluorine atoms per molecule or one structural unit of a polymer compound. If the organic fluorine compound has less than five fluorine atoms, it cannot reduce ink bleeding. The organic fluorine compound is preferably water soluble, and also preferably a compound having an surfactant effect.

Preferable fluorine-based compounds according to the invention are represented by the formula RF—Rₚₒₗ, wherein RF represents a straight-chain or branched-chain perfluoroalkyl group having 3 or more carbon atoms, Rₚₒₗ represents a polar group such as carboxylic acid or salts thereof, sulfonic acid or salts thereof, phosphoric acid or salts thereof, phosphonic acid or salts thereof, amino groups or salts thereof, quaternary ammonium salts, polyethyleneoxy skeletons, polypropyleneoxy skeletons, sulfonamide groups, ether groups and betaine structures. Of these members, those having a sulfoxylic group or its salt are more preferable because they hardly interact with silicate and thus have good developability on machine. RF is most preferably a member having a CₙF₂ₙ₊₁CₘH₂ₘCOO— skeleton from the viewpoint of reducing ink bleeding, more preferably a member having two or more CₙF₂ₙ₊₁CₘH₂ₘCOO— skeletons per molecule, wherein n is an integral number of 2 or more, and m is an integral number of 1 or more.

Specific examples of the fluorine-based compound preferably used in the invention ([(F-1) to (F-19)] are listed below, but the invention is not limited to them. 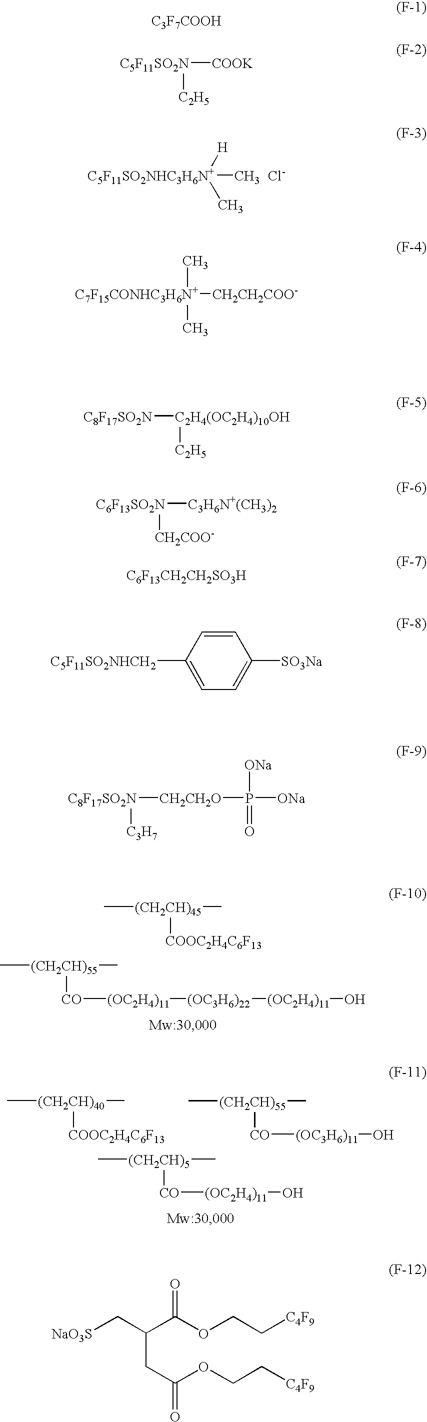 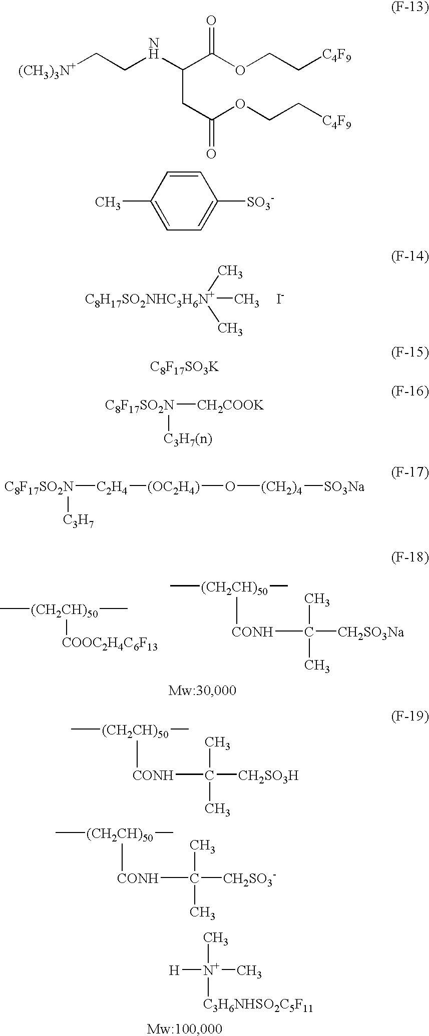
polymer compound. Particularly preferable are water soluble ones having a surfactant effect.

Specific examples of the fluorine-based polymer surfactant include copolymers of an acrylate having a fluoroaliphatic group or a methacrylate having a fluoroaliphatic group and poly(oxyalkylene)acrylate or poly(oxyalkylene)methacrylate. In the copolymer, the monomer unit of the acrylate or methacrylate having a fluoroaliphatic group is preferably 7% to 60% by mass with reference to the mass of the copolymer, and the molecular weight of the copolymer is preferably 3,000 to 100,000.

The fluoroaliphatic group has 3 to 20 carbon atoms, may be straight-chain or branched-chain, and preferably a fluoroaliphatic group containing 40% by mass or more of fluorine, and having at least three sufficiently fluorinated carbon atoms at the end. Specific examples of the acrylate or methacrylate having a fluoroaliphatic group include N-butylperfluorooctanesulfonamide ethylacrylate, N-propylperfluorooctanesulfonamide ethylacrylate and methylperfluorooctanesulfonamide ethylacrylate. The molecular weight of the polyoxyalkylene group in the poly(oxyalkylene)acrylate or methacrylate is preferably 200 to 3,000. Examples of the oxyalkylene group include oxyethylene, oxypropylene and oxybutylene groups, preferably are oxyethylene and oxypropylene groups. For example, acrylate or methacrylate added with 8 to 15 mol of oxyethylene groups are used. As needed, the ends of the polyoxy alkylene group may be added with dimethyl siloxane groups or other groups to reduce the foam forming properties.

The fluorine-based surfactants as described above are commercially available, and such commercial products may be used in the invention. Two or more of the fluorine-based surfactants may be used in combination. Examples of the commercial products include Surflon S-111, S-112, S-113, S-121, S-131, S-141, S-145, S-381 and S-382 manufactured by Asahi Glass Co., Ltd. Megafac F-110, F120, F-142D, F-150, F-171, F177 and F781 manufactured by Dainippon Ink And Chemicals, Incorporated, Fluorad FC-93, FC-95, FC-98, FC-129, FC135, FX-161, FC170C, FC-171 and FC176 manufactured by Sumitomo 3M Limited, and FT-248, FT-448, FT-548, FT-624, FT-718 and FT-738 manufactured by Bayer Japan Ltd.

—Combination with Hydrophilic Resins—

An ink receiving layer can be prepared by blending one or more compounds selected from the group consisting of organic fluorine compounds having a fluoroalkyl group and compounds having a dimethyl siloxane skeleton and a hydrophilic resin. The combination with a hydrophilic resin further improves the stain resistance and reduces ink bleeding. In this instance, the organic fluorine compound is in the range of 0.2 to 50 mg/m², preferably 0.5 to 10 mg/m², and a compound having a dimethyl siloxane skeleton is preferably in the range of below 50 mg/m². The hydrophilic resin is in the range of 1.0 to 200 mg/m², preferably 50.0 to 150.0 mg/m². The combination with a hydrophilic resin further improves the ink repellency and stain resistance in the non-image area region.

The hydrophilic resin is not particularly limited as long as it is a water soluble resin, but preferable examples include water soluble cellulose having carboxylic acid or a salt thereof (e.g., carboxymethyl cellulose), acryl or methacryl polymer or copolymers thereof, acryl, methacryl, vinyl or styrenic hydrophilic resins having a sulfonic acid group or a salt thereof, hydrophilic resins containing an amide group such as polyacrylamide or polyvinylpyrrolidone, hydrophilic resins having an amino group, and hydrophilic resins having a phosphoric acid or a salt thereof, such as a phosphoric acid-modified starch as described in JP-A No. 62-097892.

Also, the undercoat layer preferably contains a compound having an onium group. The compound having an onium salt is described in detail in each publication of JP-A Nos. 2000-10292 and 2000-108538. Also, besides the above compounds, a compound selected from among macromolecular compounds having a structural unit represented by a poly(p-vinylbenzoic acid) may be used. Specific examples of the compound having an onium group include copolymers of a p-vinylbenzoic acid and a vinylbenzyltriethylammonium salt and copolymers of a p-vinylbenzoic acid and a vinylbenzyltrimethylammonium chloride.

Also preferable are copolymers having repeating units containing at least one ethylene-based unsaturated bond as described in JP-A No. 2005-125749 and repeating units containing at least one functional group that interacts with the support surface. Of these compounds, polymers having a sulfonate skeleton is particularly preferable because they reduce ink bleeding and exhibits stain resistance.

The organic ink receiving layer may be provided by following method: a solution, in which the above-described organic compound is dissolved in water or an organic solvent such as methanol, ethanol, methyl ethyl ketone or a mixed solvent thereof, is applied to and drying on an aluminum plate; or an aluminum plate is dipped in a solution, in which the above-described organic compound is dissolved in water or an organic solvent such as methanol, ethanol, methyl ethyl ketone or a mixed solvent thereof, to adsorb the above-described compounds, followed by washing with water or the like, and drying to form an organic undercoating layer.

In the former method (application method), a 0.005 to 10% by mass solution of the organic compound can be applied by various methods. In the latter method (dipping method), the concentration of the solution is 0.01 to 20% by mass, preferably 0.05 to 5% by mass, dipping temperature is 20 to 90° C., preferably 25 to 50° C., and dipping time is 0.1 second to 20 minutes, preferably 2 seconds to 1 minutes.

As the method for forming the ink receiving layer, the application method is more preferable from the viewpoints of preventing the adsorption onto the substrate, and increasing the stain prevention effect during printing.

Thus, the recording medium for planographic printing plate of the invention can be obtained by forming and laminating a hydrophilic layer and an ink receiving layer on a support. The ink receiving layer is appropriately used to receive an ink deposited by an ink jet recording system.

[Ink]

In the invention, various types of ink can be used to form image areas (hydrophobic ink-receiving regions) on a planographic printing plate. From the viewpoint of ejectability, ink preferably has a viscosity in the range of 1 to 1,000 mPa·s, and a surface tension in the range of 1 to 100 mN/m at the ejection temperature, more preferably, a viscosity in the range of 1 to 100 mPa·s, and a surface tension in the range of 1 to 80 mN/m at the ejection temperature. Ink can be prepared from a polymer solution or a heat-melted polymer, but such ink tends to be highly viscous and deteriorate in ejectability. Accordingly, preferable ink is a dispersion liquid in which a polymer is atomized and dispersed in water or an organic solvent. Also preferable is ink containing monomers or oligomers that are polymerized into polymers by radiation or heat after being ejected. Particularly preferable ink in the invention is: (1) dispersion liquids of polymer particles in water or an organic solvent; and (2) solutions or dispersion liquids of radiation-polymerizable monomers or oligomers.

From the viewpoint of reducing ink bleeding, the preferable contact angle between the substrate and the ink (measured 10 seconds after slowly dropping 0.8 μl of water on a substrate) is preferably 30° or more.

[(1) Aqueous Dispersion Liquid of Polymer Particles]

Preferable examples of the aqueous dispersion liquid of polymer particles used in the invention include an aqueous latex obtained by polymerizing material monomers in water. The aqueous latex can be prepared by known methods, for example, a method described in “Chemistry of Polymer Latex (Kobunshi Latex no Kagaku)” (May 5, 1970), by Soichi Muroi, Kobunshi Kankokai.

Examples of the material monomer include (meth)acrylates, (meth)acrylamides, (meth)acrylic acid, styrenes, vinyl ethers and vinyl esters.

The concentration of the polymer particles is preferably in the range of 1% to 70% by mass, more preferably in the range of 10% to 60% by mass. The particle diameter of the polymer particles is preferably 0.01 μm to 10 μm. The aqueous dispersion liquid of the polymer particles is preferably colored for visibility. Coloring may be added to the dispersion liquid, but preferably to the polymer particles. Known dyes and pigments can be used for coloring.

After ink ejection, it is heated as needed to melt and fix the particles on the recording medium, and thus a solid image is formed. Examples of heating means include contact type heating apparatuses such as a hot plate, a heat block and a heat roller, and non-contact heating apparatuses such as a drier and an infrared lamp or hot air. Such heating is preferably performed at a temperature and time that will not cause the deformation of the recording medium, more specifically in the range of 40° C. to 200° C. for 0.01 seconds to 30 minutes.

[(2) Organic Solvent Dispersion Liquid of Polymer Particles]

Preferable examples of the organic solvent dispersion liquid of polymer particles used in the invention include a nonaqueous latex obtained by polymerizing material monomers in an organic solvent. The nonaqueous latex can be prepared by known methods, for example, a method described in U.S. Pat. No. 2,640,288.

Examples of the monomer used in the method include (meth)acrylates, (meth)acryl amides, (meth)acrylic acid, styrenes, vinyl ethers and vinyl esters.

The concentration of the polymer particles is preferably in the range of 1% to 70% by mass, more preferably in the range of 10% to 60% by mass. The particle diameter of polymer particles is preferably 0.01 μm to 10 μm. The aqueous dispersion liquid of the polymer particles is preferably colored for visibility. Coloring may be added to the dispersion liquid, but preferably to the polymer particles. Known dyes and pigments can be used for coloring.

In the invention, a dispersion liquid obtained by dispersing the polymer particles in an organic solvent by a wet dispersion method may be used as the organic solvent dispersion of the polymer particles. Such dispersion liquid can be prepared by known methods such as that described in European Patent Application No. 1,471,121A.

The concentration of the polymer particles is preferably in the range of 1% to 70% by mass, more preferably in the range of 10% to 60% by mass. The particle diameter of the polymer particles is preferably 0.01 μm to 10 μm. The organic solvent dispersion liquid of the polymer particles is preferably colored for visibility. Coloring may be added to the dispersion liquid, but preferably to the polymer particles. Known dyes and pigments can be used for coloring.

After such ink is ejected, it is heated as needed to melt and settle the particles on the recording medium, and thus a solid image is formed. Examples of heating methods include contact heating using a hot plate, a heat block or a heat roller, and non-contact heating using an infrared lamp or hot air. Such heating is preferably performed at a temperature and time that will not cause the deformation of the recording medium, more specifically in the range of 40° C. to 200° C. for 0.01 seconds to 30 minutes.

[(3) Radiation Polymerizable Ink]

The radiation-curable ink preferably used in the invention can be prepared by known methods such as a method described in “Guidebook of Latest UV Curing (Saishin UV Koka Jitsuyobinran)”, by Technical Information Institute Co., Ltd. (published on Feb. 25, 2005). Such ink is mainly composed of a polymerization initiator and polymerizable monomers or oligomers. The method of polymerization may be ion polymerization such as radical polymerization and cation polymerization, either of them can be preferably used in the invention.

(Polymerization Initiator)

Examples of the polymerization initiator appropriately used in the invention include known photoinitiators for radical polymerization or cation polymerization of radiation-curable ink compositions. Another example of the photoinitiator which can be used in the invention is a compound which causes a chemical change through a light action or interaction with a sensitizing dye in an electronically excited state, and generates at least one of radical, acid, and base.

Specific photoinitiators known among those skilled in the art can be used without limitation. Preferable examples of the photoinitiator include aromatic ketones, benzoin and benzoin derivatives such as benzoin ether, onium salts such as sulfonium salts and iodonium salts, organic peroxides, hexaarylbiimidazol compounds, ketoxime esters, borates, azinium compounds, metallocene compounds, and compounds having a carbon-halogen bond. These compounds are capable of initiating polymerization mainly by ultraviolet radiation, and can be spectrally sensitized to visible radiation and infrared radiation by combining them with an appropriate sensitizer.

The content of the polymerization initiator in an ink composition is preferably in the range of 0.01 to 30% by mass, more preferably in the range of 0.1 to 20% by mass.

(Polymerizable Compound)

Examples of the polymerizable monomer or oligomer which can be appropriately used in the invention include known radical polymerizable or cation polymerizable monomers or oligomers. Examples of the monomers or oligomers include (meth)acrylates, (meth)acrylamides, (meth)acrylic acid, maleic acid and derivatives thereof, styrenes, olefins, vinyl ethers, vinyl esters, epoxy compounds, oxetane compounds, and cyclic esters. In the invention, for controlling the dynamic characteristics of the formed image, these compounds may be used in combination of a monofunctional compound having one polymerizable functional group within a molecule and a multifunctional compound having two or more polymerizable functional groups within a molecule.

The content of the polymerizable compound in the ink composition is in the range of 10 to 99% by mass, and preferably in the range of 30 to 95% by mass.

(Other Additives)

In addition to the polymerization initiators and polymerizable compounds, various known additives may be added to the radiation-curable ink composition according to the intended use.

The ink is preferably colored for the visibility of the image. Known dyes and pigments may be used for coloring.

Furthermore, surfactants for improving ejectability and polymerization inhibitors for enhancing ink storage stability may be added. Furthermore, various polymers for improving the dynamic characteristics of the formed image may be added. Specific examples thereof include (meth)acryl-based polymers, polyurethane resins, polyamide resins, polyester resins, epoxy resins, phenol resins, polycarbonate resins, polyvinyl butyral resins, polyvinyl formal resins, polyvinyl alcohol, polyethyleneglycol, polyethylene oxide, polypropylene glycol, shellac resins, vinyl-based resins, rubber-based resins, waxes, and other natural resins

In the invention, solvent-free ink as described above may be used, and mixtures of ink and water or an organic solvent may be used. Examples of the organic solvent to be mixed with ink include ketone-based solvents such as acetone and methylethylketone; alcohol-based such as methanol, ethanol, propanol, 1-methoxy-2-propanol, ethyleneglycol, diethylene glycol, dipropylene glycol, diethylene glycol monoethylether, tripropylene glycol and tripropylene glycol monomethylether; aromatic solvents such as toluene, ester-based solvents such as ethyl acetate, butyl acetate, isopropyl acetate and γ-butyrolactone; ether-based solvents such as tetrahydrofuran, diethylene glycol diethylether, diethylene glycol diethylether, propelene glycol monoethylether, propelene glycol n-butylether, dipropelene glycol dimethylether, 3-methoxy-1-buthanol, and propelene glycol methylether acetate; and hydrocarbon-based solvents such as Isopar G (manufactured by Exxon Corporation).

As a means for curing ink deposited on a recording medium, commonly used mercury vapor lamps, metal halide lamps or the like may be used, and other light sources such as luminescence diodes, semiconductor laser and fluorescent lamps also may be used. Alternatively, light sources and electromagnetic wave that accelerates ink polymerization, such as hot-cathode tube, cold-cathode tube, electron beam and X ray may be used. When a metal halide lamp is used, the lamp preferably has an intensity of 10 to 1,000 W/cm, and an illumination of 1 mW/cm2 to 100 W/cm2 on the surface of a recording medium. The exposure energy is preferably 0.1 mJ/cm2 to 100 J/cm2. When a high-pressure discharge lamp such as a mercury vapor lamp and a metal halide lamp is used, it is preferable to provide an exhaust means to exhaust ozone generated during discharge. The exhaust means is preferably disposed so as to collect the ink mist generated during ink ejection. When radical polymerization is used for ink curing, the polymerization is inhibited by oxygen. Therefore it is preferable to expose ink at a low oxygen level or under an atmosphere of nitrogen gas or the like in that it requires lower energy for polymerization. If such curing energy such as light is radiated to the ink ejecting nozzle, ink mist or the like on the nozzle surface can harden to hinder ink ejection. Accordingly, it is preferable to install any measure such as light shielding for minimizing the radiation to the nozzle. Preferable examples of the measure include a division wall for preventing the radiation to the nozzle plate, and a means to limit the angle of incidence to the media for reducing stray light.

[(4) Ink in Which Polymer is Solved in Organic Solvent]

In the invention, preferable polymer used in the polymer solution-type ink composition is a polymer or a copolymer having acidic groups. Examples of the acidic group include carboxylic acid group, sulfonic acid group and phosphoric acid group, and particularly preferable is carboxylic acid group.

The polymer or copolymer is preferably those obtained by the polymerization of unsaturated double bonds, such as acryl and methacryl polymers. The monomer having acidic groups is preferably acrylic acid, methacrylic acid, maleic acid, anhydrous maleic acid, fumaric acid, anhydrous fumaric acid or 2-acryl amide-2-methyl-1-propane sulfonic acid.

The monomer having acidic groups may be copolymerized with other monomers. Examples of the monomer to be copolymerized include acrylic acid ester, methacrylic acid ester, styrenic monomer, vinyl monomer and acrylonitrile.

These polymers preferably have a weight average molecular weight of 5,000 to 20,0000, and can be added to the ink ingredients at a content of 2% to 50% by mass.

The solvent used in such ink composition are preferably compounds having at least one group of hydroxyl, ether and ester per molecule. Specifically, preferable examples include diethylene glycol diethylether, tripropelene glycol monometylether, ethylene glycol monobuthylether, propelene glycol n-butylether, dipropelene glycol dimethylether, 3-methoxy-1-buthanol, and propelene glycol methylether acetate, ethanol, propanol, ethylene glycol, propylene glycol and diethylene glycol.

The ink composition may also contain coloring agents such as pigments and dyes, and surface tension controlling agents such as surfactants in accordance with the intended use.

In the invention, a fluorine-based compound having a perfluoroalkyl group and a silicon-based compound having a polydimethyl siloxane skeleton, which are contained in the ink receiving layer, are preferably contained from the viewpoint of improving the effect to prevent ink bleeding.

In this instance, there is no need to introduce a component for preventing ink bleeding into the ink receiving layer of the support, and the ink receiving layer may contain or not contain such a component. The content of the fluorine-based compound having a fluoroalkyl group in the ink composition should be 0.05% to 5% by weight or less, and most preferably 0.2 to 3% by weight.

<Formation of Image Area on Planographic Printing Plate>

(1. Image Formation by Ink Jet)

In this instance, the radiation-curable ink composition is deposited by a ink jet recording system on the surface of the recording medium of the invention.

The ink jet recording systems which can be used in this instance include a continuous system wherein continuously ejected ink droplets are divided into those for recording and not for recording by an electrical field or the like, and the ink droplets for recording are deposited on a medium, and a on-demand system wherein only ink droplets required for recording are ejected from a nozzle.

The on-demand system includes a thermal system (bubble system) ejecting ink droplets using pressure of bubbles generated by abruptly heating the ink, and a piezo system using a piezo element (piezoelectric element). The piezo system is classified into a direct mode type and a share mode type according to the direction of distortion of the applied voltage. Another examples of the on-demand system include an electrostatic system wherein ink or particles in ink are electrically charged for electrostatically controlling ink ejection, and a solid ink jet recording system wherein solid ink is heated to melt, and ejected. These ink jet recording systems are described in detail in “Ink Jet Printer Gijutu To Zairyo (Technology and Material of Ink Jet Printer)”, CMC Inc., (Jul. 31, 1998), and “Saishin Ink Jet Gijutu Know-How Shu (Know-How in Latest Ink Jet Technology)”, Technical Information Institute Co., Ltd. (Jun. 24, 2005). In the invention, any of the systems can be appropriately used without limitation.

(2. Ink Curing)

The ink composition used for forming the planographic printing plate of the invention is a radiation-curable ink composition. Therefore, it is cured after deposition by radiation.

As a means for curing ink deposited on a recording medium, commonly used mercury vapor lamps, metal halide lamps or the like may be used, and other light sources such as luminescence diodes, semiconductor laser and fluorescent lamps also may be used. Alternatively, light sources and electromagnetic wave that accelerates ink polymerization, such as hot-cathode tube, cold-cathode tube, electron beam and X ray may be used.

When a metal halide lamp is used the lamp preferably has an intensity of 10 to 1,000 W/cm, and an illumination of 1 mW/cm² to 100 W/cm² on the surface of a recording medium.

The exposure energy is preferably 0.1 mJ/cm² to 100 J/cm². When a high-pressure discharge lamp such as a mercury vapor lamp and a metal halide lamp is used, it is preferable to provide an exhaust means to exhaust ozone generated during discharge. The exhaust means is preferably disposed so as to collect the ink mist generated during ink ejection.

When radical polymerization is used for ink curing, the polymerization is inhibited by oxygen. Therefore it is preferable to expose ink at a low oxygen level or under an atmosphere of nitrogen gas or the like in that it requires lower energy for polymerization. If such curing energy such as light is radiated to the ink ejecting nozzle, ink mist or the like on the nozzle surface can harden to hinder ink ejection. Accordingly, it is preferable to install any measure such as light shielding for minimizing the radiation to the nozzle. Preferable examples of the measure include a division wall for preventing the radiation to the nozzle plate, and a means to limit the angle of incidence to the media for reducing stray light.

(3. Fixing and Gum Treatment)

The image formed as described above can be cured and fixed by radiation as described in the section of the radiation-curable ink. Furthermore, gum treatment may be carried out between the fixing and printing processes using a gum mainly composed of gum arabic, starch derivatives, surfactants and the like. Preferable examples of the gum are those described in JP-B Nos. 62-16834, 62-25118, and 63-52600, and JP-A Nos. 62-7595, 62-11693, and 62-83194. In the gum treatment, the ink receiving layer is preferably dissolved and removed with a gum solution. The thus obtained plate can be used for usual printing using a planographic printing machine.

When the ink receiving layer contain a hydrophilic resin or an water-soluble organic fluorine-based compound, the region where no ink has been deposited (non-image area) can be removed with gum used in the gum treatment.

As described above, the radiation-curable ink is imagewisely applied and cured to form an image area on the planographic printing plate, and then ink and dampening water are supplied to the plate for printing.

The dampening water and ink supplied to the planographic printing plate of the invention for printing may be general-purpose products, and commonly used planographic printing machines can be used for printing.

<Dampening Water>

As a dampening system, Dahlgren system is supposed and has been widely used, wherein an aqueous solution containing about 20 to 25% isopropyl alcohol is used as dampening water. However, isopropyl alcohol has a specific unpleasant odor and possess some toxicity, thus it is regulated by Ordinance on Prevention of Organic Solvents Poisoning as Class 2 Organic Solvent. Accordingly, a technique for substituting isopropyl alcohol, or a technique using a nonvolatile or a high-boiling point compound as the alternative compound to isopropyl alcohol have been developed. Furthermore, for example, dampening water compositions containing a specific alkylene oxide-based nonionic surfactant or an ethylene oxide or propylene oxide adduct of alkylene diamine are supposed. Any of these can be used for printing using the planographic printing plate of the invention.

The dampening water using the technique for substituting isopropyl alcohol is described in detail in, for example, JP-A Nos. 5-92677, 5-318958, 2001-287476, 2-269094, 3-63187, 3-90389, 3-90390, 4-363297, 5-112085, 11-78281, 11-105449, 2001-130164, 2001-138659, 2001-180146, 2001-18553, 2001-71658, 2002-187375, 2002-187376, and 2002-192853. The dampening water compositions containing a specific alkylene oxide-based nonionic surfactant are described in detail in, for example, JP-A No. 51-72507, and the dampening water compositions containing an ethylene oxide or a propylene oxide adduct of alkylene diamine are described in detail in, for example, JP-A No. 2002-254852. These dampening waters can be also used for printing using the planographic printing plate of the invention.

In the recording medium of the invention, when the ink receiving layer contains a hydrophilic resin or a fluorine-based compound, the ink receiving layer in the region where no ink has been deposited (non-image area) can be readily removed with such dampening water during printing, and hydrophilic surface is exposed. Accordingly, staining of the non-image area is effectively prevented.

### EXAMPLES

The invention is illustrated by following Examples, but the invention is not limited to these embodiments described in Examples.

### I. Examples A to H

[Production of Direct-Writing Planographic Printing Plate Precursors 1 to 19]

(Aluminum Plate)

An aluminum alloy comprising 0.06% by mass of Si, 0.30% by mass of Fe, 0.005% by mass of Cu, 0.001% by mass of Mn, 0.001% by mass of Mg, 0.001% by mass of Zn and 0.03% by mass of Ti, with the balance made of Al and inevitable impurities, was used to prepare a molten metal. The molten metal was filtrated, and then an ingot having a thickness of 500 mm and a width of 1200 mm was produced by DC casting.

Its surface was shaved by a thickness of 10 mm on average with a surface-shaving machine, and then the ingot was kept at 550° C. for about 5 hours. When the temperature thereof lowered to 400° C., a hot rolling machine was used to produce a rolled plate having a thickness of 2.7 mm. Furthermore, a continuous annealing machine was used to thermally treat the plate thermally at 500° C. Thereafter, the plate was finished by cold rolling so as to have a thickness of 0.24 mm. In this way, an aluminum plate in accordance with JIS 1050 was yielded. The aluminum plates were trimed in a width of 1030 mm and were subjected to the following surface treatments.

<Surface Treatment>

Surface treatment was performed by continuously conducting following treatments (a) to (j). Liquid was cleared away using a nip roller after each treatment and water washing.

(a) Mechanical Surface-Roughening Treatment

An apparatus as shown in FIG. 1 was used to mechanically roughen a surface of the aluminum plate with rotating nylon brush rollers while applying a suspension of an abrasive material (pumice) having a specific gravity of 1.12 in water as an abrasive slurry to the aluminum plate surface. In FIG. 1, numeral 1 represents an aluminum plate, numerals 2 and 4 represent brush rollers, numeral 3 represents an abrasive slurry, numerals 5, 6, 7 and 8 represent supporting rollers. The abrasive material had an average particle diameter of 40 μm, and a maximum diameter of 100 μm. The nylon brushes were made of nylon-6, 10 and had a bristle length of 50 mm and a bristle diameter of 0.3 mm. Three rotating brush rollers were used, which each comprised a perforated stainless-steel cylinder having a diameter of 300 mm and bundles of such nylon bristles densely attached thereto by filling them into the perforations. The apparatus had under the brush rollers two supporting rollers (φ200 mm) apart from each other at a distance of 300 mm. The brush rollers were pressed against the aluminum plate in such a degree that the load imposed on the driving motor rotating the brush rollers increased to a value higher by 7 kW than that as measured before the brush rollers were pressed against the aluminum sheet. The direction of rotation of the brush rollers was the same as the direction of running of the aluminum plate, and the rotational speed thereof was 200 rpm.

(b) Alkali Etching Treatment

The aluminum plate obtained above was etched by spraying with an aqueous solution having a caustic soda concentration of 2.6% by mass and an aluminum ion concentration of 6.5% by mass at a temperature of 70° C. to dissolve away a surface layer of the aluminum plate in an amount of 6 g/m². Thereafter, the aluminum plate was washed with water by spraying.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with sprayed water. The aqueous nitric acid solution used in the desmutting treatment was waste liquid from a process of conducting electrochemical surface-roughening treatment using alternating current in an aqueous nitric acid solution.

(d) Electrochemical Surface-Roughening Treatment

A 60 Hz AC voltage was used to continuously conduct an electrochemical surface-roughening treatment. The electrolytic solution used was a 10.5 g/L aqueous nitric acid solution (containing 5 g/L of aluminum ions and 0.007% by mass of ammonium ions) having a temperature of 50° C. The AC power source used was one providing a trapezoidal rectangular wave alternating current having a waveform as shown in FIG. 2, wherein the TP, which is the time required for the current value to increase from zero to a peak, was 0.8 msec and the duty ratio was 1:1. A carbon electrode was used as a counter electrode to conduct the electrochemical surface-roughening treatment using ferrite as an auxiliary anode. The electrolytic bath as shown in FIG. 3 was used. The current density was 30 A/dm² in terms of peak value, and the electricity quantity was 220 C/dmm² in terms of the sum of electricity at the time when the aluminum plate was functioning as an anode. 5% of the current flowing from the power source was supplied to the auxiliary anode. After this surface-roughening treatment, the aluminum plate was washed with water by spraying.

(e) Alkali Etching Treatment

The aluminum plate was etched by spraying with an aqueous solution having a caustic soda concentration of 26% by mass and an aluminum ion concentration of 6.5% by mass at 32° C. to dissolve away a surface layer of the aluminum plate in an amount of 0.25 g/m². Thus, the smut ingredients consisting mainly of aluminum hydroxide generated by the preceding step of electrochemical surface roughening with an alternating current were removed and, simultaneously therewith, the edges of the formed pits were dissolved away and rounded to be smooth. Thereafter, the aluminum plate was washed with water by spraying.

(f) Desmutting Treatment

The aluminum plate was subjected to desmut treatment with a 30° C. aqueous solution having a nitric acid concentration of 15% by mass (and containing 4.5% by mass of aluminum ions), which solution was sprayed. The aluminum plate was then washed with sprayed water. The aqueous nitric acid solution used in the desmut treatment was waste liquid from the process of conducting the electrochemical surface-roughening treatment using the alternating current in the aqueous nitric acid solution.

(g) Electrochemical Surface-Roughening Treatment

A 60 Hz AC voltage was used to continuously conduct an electrochemical surface-roughening treatment. The electrolytic solution used was a 7.5 g/L aqueous chloric acid solution (containing 5 g/L of aluminum ions) having a temperature of 35° C. The AC power source used was one providing a trapezoidal rectangular wave alternating current having a waveform as shown in FIG. 2, wherein the TP, which is the time required for the current value to increase from zero to a peak, was 0.8 msec and the duty ratio was 1:1. A carbon electrode was used as a counter electrode to conduct the electrochemical surface-roughening treatment using ferrite as an auxiliary anode. The electrolytic bath as shown in FIG. 3 was used. The current density was 25 A/dm² in terms of peak value, and the electricity quantity was 50 C/dmm² in terms of the sum of electricity at the time when the aluminum plate was functioning as an anode. After this surface-roughening treatment, the aluminum plate was washed with water by spraying.

(h) Alkali Etching Treatment

The aluminum plate was etched by spraying with an aqueous solution having a caustic soda concentration of 26% by mass and an aluminum ion concentration of 6.5% by mass at 32° C. to dissolve away a surface layer of the aluminum plate in an amount of 0.10 g/m². Thus, the smut ingredients consisting mainly of aluminum hydroxide generated by the preceding step of electrochemical surface roughening with an alternating current were removed and, simultaneously therewith, the edges of the formed pits were dissolved away and rounded to be smooth. Thereafter, the aluminum plate was washed with water by spraying.

(i) Desmutting Treatment

The aluminum plate was subjected to a desmutting treatment by spraying with an aqueous solution having a sulfuric acid concentration of 25% by mass (containing 0.5% by mass aluminum ions) and a temperature of 60° C. Thereafter, the aluminum plate was washed with water by spraying.

(j) Anodic Oxidation Treatment

An anodic oxidation device having the structure illustrated in FIG. 4 was used to conduct anodic oxidation treatment to yield a planographic printing plate precursor support of Example 1. The electrolytes supplied into first and second electrolyzing sections were each sulfuric acid. The electrolytes were each an electrolyte having a sulfuric acid concentration of 170 g/L (and containing 0.5% by mass of aluminum ions), and the temperature thereof was 38° C. Thereafter, the support was washed with sprayed water. The final amount of the oxidation film was 2.7 g/m².

The support obtained as above had a center line average roughness of 0.55 μm, large waves having an average wavelength of 65 μm, medium waves having an average aperture size of 1.4 μm, and small waves having an average aperture size of 0.14 μm. The ratio of the depth to the average aperture size of the small waves was 0.46.

(k) Alkali Metal Silicate Treatment

(Silicate Treatment [I] and Formation of Ink Receiving Layer)

The aluminum support obtained by the anodic oxidation treatment was subjected to an alkali metal silicate treatment (silicate treatment) by immersing into a treatment bath containing a 2.5% by mass aqueous No. 3 silicate of soda solution at a temperature of 70° C. for 15 seconds. Thereafter, the support was washed with well water by spraying. A support having a surface hydrophilized with silicate was thus obtained. The quantity of silicate was measured with X-ray fluorescence and found to be 15.0 mg/m². The thus obtained aluminum support after the alkali metal silicate treatment was applied thereon with an undercoat having the composition below using a wire bar, and dried at a temperature of 80° C. for 15 seconds to form a coating film. The coating weight after drying was 4.0 mg/m².

(Silicate Treatment [II] and Formation of Ink Receiving Layer)

The aluminum support obtained by the anodic oxidation treatment was subjected to an alkali metal silicate treatment (silicate treatment) by immersing into a treatment bath containing a 3.0% by mass aqueous No. 3 silicate of soda solution at a temperature of 70° C. for 20 seconds. Thereafter, the support was washed with well water by spraying. A support having a surface hydrophilized with silicate was thus obtained. The quantity of silicate was measured with X-ray flourescence and found to be 20.0 mg/m². The thus obtained aluminum support after the alkali metal silicate treatment was applied thereon with an undercoat having the composition below using a wire bar, and dried at a temperature of 80° C. for 15 seconds to form a coating film. The coating weight after drying was 4.0 mg/m².

(Silicate Treatment [IV] and Formation of Ink Receiving Layer)

The aluminum support obtained by the anodic oxidation treatment was subjected to an alkali metal silicate treatment (silicate treatment) by immersing into a treatment bath containing a 0.5% by mass aqueous No. 3 silicate of soda solution at a temperature of 25° C. for 10 seconds. Thereafter, the support was washed with well water by spraying. A support having a surface hydrophilized with silicate was thus obtained. The quantity of silicate was measured with X-ray flourescence and found to be 1.0 mg/m². The thus obtained aluminum support after the alkali metal silicate treatment was applied thereon with an undercoat having the composition below using a wire bar, and dried at a temperature of 80° C. for 15 seconds to form a coating film. The coating weight after drying was 4.0 mg/m².

(Silicate Treatment [V] and Formation of Ink Receiving Layer)

The aluminum support obtained by the anodic oxidation treatment was subjected to an alkali metal silicate treatment (silicate treatment) by immersing into a treatment bath containing a 4.0% by mass aqueous No. 3 silicate of soda solution at a temperature of 70° C. for 30 seconds. Thereafter, the support was washed with well water by spraying. A support having a surface hydrophilized with silicate was thus obtained. The quantity of silicate was measured with X-ray flourescence and found to be 30.0 mg/m². The thus obtained aluminum support after the alkali metal silicate treatment was applied thereon with an undercoat having the composition below using a wire bar, and dried at a temperature of 80° C. for 15 seconds to form a coating film. The coating weight after drying was 4.0 mg/m².

<Composition of Coating Liquid for Ink Receiving Layer>

| | |
|---|---|
| Compounds listed in Tables 2 to 7 below | 0.08 g |
| Water | 100 g |

[Production of Direct-Writing Planographic Printing Plate Precursors 20 to 26]

The aluminum support was subjected to treatments (a) to (j) in the same manner as the direct-writing planographic printing plate precursor 1 (direct-writing recording medium 1 for producing the direct-writing planographic printing plate). Thereafter, the aluminum support was subjected to the silicate treatment (k) as described below.

(k) Alkali Metal Silicate Treatment

(Silicate Treatment [I] and Formation of Ink Receiving Layer)

The aluminum support obtained by the anodic oxidation treatment was subjected to an alkali metal silicate treatment (silicate treatment) by immersing into a treatment bath containing a 2.5% by mass aqueous No. 3 silicate of soda solution at a temperature of 70° C. for 15 seconds. Thereafter, the support was washed with well water by spraying. A support having a surface hydrophilized with silicate was thus obtained. The quantity of silicate was measured with X-ray flourescence and found to be 15.0 mg/m². The thus obtained aluminum support after the alkali metal silicate treatment was applied thereon with an undercoat having the composition below using a wire bar, and dried at a temperature of 80° C. for 15 seconds to form a coating film. The coating weight after drying was achieved by adjusting the moisture content on the wire bar.

<Composition of Coating Liquid for Ink Receiving Layer>

| | |
|---|---|
| Compounds listed in Tables 8 to 13 below | 0.08 g |
| Water | 100 g |

[Production of Direct-Writing Planographic Printing Plate Precursors 27 to 49]

The aluminum support was subjected to treatments (a) to (j) in the same manner as the direct-writing planographic printing plate precursor 1. Thereafter, the aluminum support was subjected to the silicate treatment (k) as described below.

(k) Alkali Metal Silicate Treatment

(Silicate Treatment [I] and Formation of Ink Receiving Layer)

The aluminum support obtained by the anodic oxidation treatment was subjected to an alkali metal silicate treatment (silicate treatment) by immersing into a treatment bath containing a 2.5% by mass aqueous No. 3 silicate of soda solution at a temperature of 70° C. for 15 seconds. Thereafter, the support was washed with well water by spraying. A support having a surface hydrophilized with silicate was thus obtained. The quantity of silicate was measured with X-ray flourescence and found to be 15.0 mg/m². The thus obtained aluminum support after the alkali metal silicate treatment was applied thereon with an undercoat containing a fluorine-based compound and a hydrophilic resin at amounts listed in Table 1 below using a wire bar, and dried at a temperature of 80° C. for 15 seconds to form a coating film.

The hydrophilic resin in the table below regarding following examples is (1)poly(2-acrylamide-2-methyl-1-propanesulfonic acid).

The coating liquids listed in Table 1 below were used to adjust the ink receiving layers listed in Tables 14 to 21.

TABLE 1

| | | | | Fluorine | |
|---|---|---|---|---|---|
| | Fluorine | Hydrophilic | | compound | Hydrophilic |
| | compound | resin | Water | coating weight | resin coating |
| | Part by weight | Part by weight | Part by weight | (mg/m²) | weight (mg/m²) |
| Coating liquid | 0.014 | 0.014 | 100 | 1 | 1 |
| composition 1 | | | | | |
| (Example) | | | | | |
| Coating liquid | 0.055 | 0.083 | 100 | 4 | 6 |
| composition 2 | | | | | |
| (Example) | | | | | |
| Coating liquid | 0.014 | 0.7 | 100 | 1 | 50 |
| composition 3 | | | | | |
| (Example) | | | | | |
| Coating liquid | 0.7 | 0.014 | 100 | 50 | 1 |
| composition 4 | | | | | |
| (Example) | | | | | |
| Coating liquid | 0.7 | 0.7 | 100 | 50 | 50 |
| composition 5 | | | | | |
| (Example) | | | | | |
| Coating liquid | 0.0028 | 1.4 | 100 | 0.2 | 100 |
| composition 6 | | | | | |
| (Example) | | | | | |
| Coating liquid | 0.014 | 1.4 | 100 | 1.0 | 100 |
| composition 7 | | | | | |
| (Example) | | | | | |
| Coating liquid | 0.014 | 2.1 | 100 | 1.0 | 100 |
| composition 8 | | | | | |
| (Example) | | | | | |
| Coating liquid | 0.014 | 2.8 | 100 | 1.0 | 200 |
| composition 9 | | | | | |
| (Comparative | | | | | |
| example) | | | | | |
| Coating liquid | 0.84 | 0 | 100 | 60 | 0 |
| composition 10 | | | | | |
| (Comparative | | | | | |
| example) | | | | | |
| Coating liquid | 0.014 | 3.08 | 100 | 1.0 | 220 |
| composition 11 | | | | | |
| (Comparative | | | | | |
| example) | | | | | |
| Coating liquid | 0 | 1.4 | 100 | 0 | 100 |
| composition 12 | | | | | |
| (Comparative | | | | | |
| example) | | | | | |

[Production of Direct-Writing Planographic Printing Plate Precursors 50 to 60]

[Direct-Writing Planographic Printing Plates Having Hydrophilic Layer]

(Aluminum Support Substrate)

The aluminum support was subjected to treatments (a) to (j) in the same manner as the direct-writing planographic printing plate precursor 1. Thereafter, the silicate treated layer was applied thereon with a coating liquid for hydrophilic layer having the following composition using a wire bar, and dried at a temperature of 80° C. for 10 minutes in an oven to form a hydrophilic layer having a coating weight of 3.0 g/m² on a dry basis. A direct-writing recording medium for producing the direct-writing planographic printing plate was thus produced.

<Coating Lliquid for Hydrophilic Layer>
20% by mass aqueous colloidal silica dispersion (trade name: Snowtex C) 100 g
Sol-gel preparation described below 500 g
5% by mass aqueous solution of an anionic surfactant (trade name: Nikkol OTP-75, manufactured by Nikko Chemicals Co., Ltd. 30 g
Purified water 450 g

<Sol-Gel Preparation>

1.04 g of tetramethoxysilane (manufactured by Tokyo Chemical Industry Co., Ltd.) and 0.34 g of the following hydrophilic polymer having terminal silane coupling groups were added to 19.2 g of ethyl alcohol, 0.86 g of acetylacetone, 0.98 g of tetraethyl orthotitanate and 8.82 g of purified water, and aged at room temperature for two hours. Thus a sol-gel preparation was obtained.

<Synthesis of Hydrophilic Polymer Having Terminal Silane Coupling Groups>

25 g of acrylamide, 3.5 g of 3-mercaptopropyltrimethoxysilane and 51.3 g of dimethylformamide were placed in a three-necked flask, heated to a temperature of 65° C. under nitrogen gas stream and 0.25 g of 2,2′-azobis(2,4-dimethylvaleronitrile) were added to initiate the reaction. After stirring for 6 hours, the mixture was cooled to room temperature and put into 1.5 L of ethyl acetate to deposit a solid. Subsequently, the mixture was filtered, and the solid was thoroughly washed with ethyl acetate and dried (yield: 21 g). The solid was determined by GPC (polystyrene standard) and found to be a polymer having an average molecular weight of 5,000.

On the polymer, an undercoat having the following composition was applied with a wire bar, and dried at a temperature of 80° C. for 15 seconds to form a coating film. The covering amount of the coating film on a dry base was achieved by controlling the moisture content on the wire bar.

<Composition of Coating Liquid for Ink Receiving Layer>
Compounds listed in Tables 20 to 25 below 0.08 g
Water 100 g

[Production of Direct-Writing Planographic Printing Plate Precursors 61 to 68]

The aluminum support was subjected to treatments (a) to (j) in the same manner as the direct-writing planographic printing plate precursor 42.

The thus obtained sol-gel hydrophilic layer aluminum support having provided thereon an undercoat having the following composition was applied with a wire bar, and dried at a temperature of 80° C. for 15 seconds to form a coating film. The covering amount of the coating film on a dry base was achieved by controlling the moisture content on the wire bar.

<Composition of Coating Liquid for Ink Receiving Layer>
Compounds listed in Tables 26 to 31 below 0.08 g
Water 100 g

[Production of Direct-Writing Planographic Printing Plate Precursors 69 to 76]

(PET Support)

<Preparation of Contact Layer>

An coating liquid having the following composition was prepared, and applied to a polyester film having a highly adhesive surface and a thickness of 188 μm (trade name: A4100, manufactured by Toyobo Co., Ltd.) to form a contact layer having a thickness of 1.0 g/m^{2.}

<Composition of Coating Liquid for Contact Layer>
10% solution of Butyral resin (trade name: BM-S, manufactured by Sekisui Chemical Co., Ltd.) in MEK 59 g
Carbon black dispersion (solid content: 21%) 13.5 g
MEK (methylethylketone)62.7 g

<Formation of Hydrophilic Layer>

A coating liquid for hydrophilic layer having the following composition was applied to the support using a wire bar, and dried at a temperature of 80° C. for 10 minutes in an oven to form a hydrophilic layer of a coating weight of 3.0 g/m² on a dry basis. Thus a direct-writing planographic printing plate precursor was produced.

<Composition of Coating Liquid for Hydrophilic Layer>

20% by mass aqueous colloidal silica dispersion (trade name: Snowtex C)

100 g
Sol-gel preparation described below 500 g
5% by mass aqueous solution of an anionic surfactant (trade name: Nikkol OTP-75, manufactured by Nikko Chemicals Co., Ltd. 30 g
Purified water 450 g

<Sol-Gel Preparation>

1.04 g of tetramethoxysilane (manufactured by Tokyo Chemical Industry Co., Ltd.) and 0.34 g of the following hydrophilic polymer having a terminal silane coupling group were added to 19.2 g of ethyl alcohol, 0.86 g of acetylacetone, 0.98 g of tetraethyl orthotitanate and 8.82 g of purified water, and aged at room temperature for two hours. Thus a sol-gel preparation was obtained.

<Synthesis of Hydrophilic Polymer Having Terminal Silane Coupling Group>

25 g of acrylamide, 3.5 g of 3-mercaptopropyltrimethoxysilane and 51.3 g of dimethylformamide were placed in a three-necked flask, heated to a temperature of 65° C. under nitrogen gas stream, and 0.25 g of 2,2′-azobis(2,4-dimethylvaleronitrile) were added to initiate the reaction. After stirring for 6 hours, the mixture was cooled to room temperature and put into 1.5 L of ethyl acetate to deposit a solid. Subsequently, the mixture was filtered, and the solid was thoroughly washed with ethyl acetate and dried (yield: 21 g). The solid was determined by GPC (polystyrene standard) and found to be a polymer having an average molecular weight of 5,000.

The coating liquids as listed in Table 1 above were applied to the obtained aluminum support having a sol-gel hydrophilic layer with a wire bar, and dried at a temperature of 80° C. for 15 seconds to form ink receiving layers listed in Tables 32 to 37 below.

[Preparation of Ink A]

<Preparation of Cationic Polymerizable UV Ink>

10 g of Cyan pigment (Pigment Blue15:4), 5 g a dispersing agent (trade name: Solsperse 32000, manufactured by Avecia Ltd), 10 g of vinylether compound (trade name: DVE-3, manufactured by ISP), 25 g of an oxirane compound (trade name: CEL2081, manufactured by Daicel Chemical Industries, Ltd.) and 40.0 g of an oxetane compound (trade name: OXT221, manufactured by Toagosei Co., Ltd.) were dispersed with a bead mill using ceramic beads. Subsequently, 10 g a cationic polymerization initiator (trade name: SP-152, manufactured by Asahi Denka Company Limited) and 100 g of diethyleneglycol diethylether were added and stirred. Thus a radiation polymerizable ink [J-1] was obtained.

(Physical Properties of Ink)

The viscosity of the ink [J-1] at 25° C. was determined with a viscometer (trade name: DV-1+, manufactured by Brookfield Engineering Laboratories, Inc.) and found to be 3.8 mPa·s. The surface tension at 25° C. was determined with a surface tensiometer (trade name: CBVP-Z, manufactured by Kyowa Interface Science Co., Ltd.) and found to be 28 mN/m.

[Preparation of Ink B]

<Preparation of Radical Polymerizable Aqueous UV Ink>

40 g of Cyan pigment (Pigment Blue15:3), 4.8 g a dispersing agent (trade name: Solsperse 27000, manufactured by Avecia Ltd), 1.2 g 2-dimethylamino-2-methyl-1-propanol as pH controlling agent, 5 g of a humectant (trade name: Humectant GRB2, manufactured by Avecia Ltd), 1 g of an antifoam agent (trade name: Dehydran 1620, manufactured by Henkel) and 48 g of deionized water were dispersed with a bead mill using ceramic beads. Thus a pigment dispersion [B-1] was obtained. Subsequently, 10 g the obtained pigment dispersion [B-1], 24 g of polyethyleneglycol diacrylate as radical polymerizable compound, 11 g of ethoxylated trimethylol propanetriacrylate, 3 g of 1-[4-(2-hydroxyethoxy)-phenyl]-2-hydroxy-2-methyl-1-propane-1-one as polymerization initiator and 52 g of deionized water were stirred with a high shear mixer (trade name: L4RT, manufactured by Silverson Machines Limited). A radiation polymerizable aqueous ink [J-2] was thus obtained.

(Physical Properties of Ink)

The viscosity of the ink [J-2] at 25° C. was determined with a viscometer (trade name: DV-1+, manufactured by Brookfield Engineering Laboratories, Inc.) and found to be 6 mPa·s. The surface tension at 25° C. was determined with a surface tensiometer (trade name: CBVP-Z, manufactured by Kyowa Interface Science Co., Ltd.) and found to be 35 mN/m.

[Preparation of Ink C]

<Preparation of Aqueous Dispersion Ink>

A flask was equipped with a stirrer, a thermometer, an addition funnel, a nitrogen inlet tube and a reflux condenser. With introducing a nitrogen into the flask to substitute oxygen, 800 ml of distilled water was place in the flask, and 1.0 g dodecyl sulfuric acid sodium as dispersant and 3.5 g of 1N NaOH were added, and heated until the internal temperature reached 80° C. To the mixture 0.46 g of K₂S₂O₈ dissolved in 11 g of distilled water, 0.25 mol of 4-vinylpyridine and 0.75 mol of styrene were independently added over a period of 3 hours as initiators. Thereafter, 0.46 g of K₂S₂O₈ dissolved in 11 g of distilled water and 3.5 g of 1N NaOH were additionally added, and allowed to react for two hours to obtain water dispersible particles. The resulting dispersion had a polymerization rate of 98.1%, an average particle diameter of 0.09 μm, and a Mw of 4.1×10⁴. The particle size was measured with CAPA-500 (manufactured by Horiba, Ltd.).

Victoria pure blue was added to the obtained water dispersible particles in an amount of 5% by weight to the solid content of the particles, and allowed to react at 50° C. for 4 hours. After the completion of the reaction, the solution was filtered through a 4-μm filter. Thus blue color ink [J-3] was obtained.

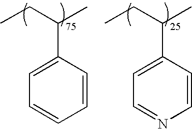

[Preparation of Ink D]

<Preparation of Polymerization Granulated Particles Ink>

Synthesis of the Dispersant (C-1)

A mixed solution of 96 g of octadecyl methacrylate, 4 g of 4-(2-methacryloyloxyethyloxycarbonyl)butyric acid and 250 g of toluene was heated to a temperature of 80° C. under nitrogen gas stream. To the solution 1.5 g of 2,2′-azobis(isobutyronitrile) (abbreviated as A.I.B.N.) was added as a polymerization initiator, followed by reacting for 4 hours. Then, 0.8 g of A.I.B.N. was added to the reaction mixture, and the mixture was heated to a temperature of 80° C. and allowed to react for 4 hours.

After cooling the reaction mixture to room temperature, 6 g of allyl alcohol was added and then a mixed solution of 10 g of dicyclohexylcarbodiimide (abbreviated as D.C.C.), 0.1 g of 4-(N,N-diethylamino)pyridine and 30 g of methylene chloride was dropwise added thereto over a period of one hour, followed by reacting for 3 hours to complete the reaction. Subsequently, to the reaction mixture 10 g of a 80% aqueous solution of formic acid was added and the resulting mixture was stirred for one hour. After removing the insoluble substance by filtration, the filtrate was reprecipitated in 2.5 L of methanol. The resulting precipitate was collected by filtration and dissolved in 200 g of toluene. After removing the insoluble substance by filtration, the filtrate was reprecipitated in 1 L of methanol. The resulting precipitate was collected by filtration and dried. The structure was identified by NMR and IR.

The yield of the obtained polymer was 85% and the Mw was 4.9×10⁴.

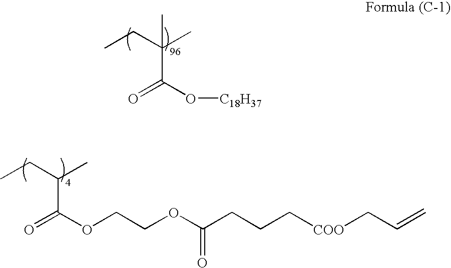

[Synthesis of Polymerization Granulated Particles (X-1)]

A mixed solution of 20 g of the dispersant (C-1) and 40 g of methyl methacrylate, 40 g of methyl acrylate and 20 g of methacrylic acid 200 g of Isopar G was heated to a temperature of 70° C. under nitrogen gas stream with stirring. 1.5 g of A.I.V.N. was added to the solution as a polymerization initiator followed by reacting for 3 hours. Then, 1.0 g of A.I.B.N. was added to the solution as an initiator, and heated to a temperature of 80° C., followed by reacting for 4 hours. Subsequently the reaction mixture was heated to a temperature of 100° C., and stirred for 1 hour. After removing the unreacted monomers, the solution was passed through a nylon cloth of 200 mesh. The obtained white dispersion contained particles of a polymerization rate of 99.2%, an average particle diameter of 1.2 μm and a Mw of 5.8×10⁴. The particle diameter was measured by CAPA-500 (manufactured by Horiba Ltd.).

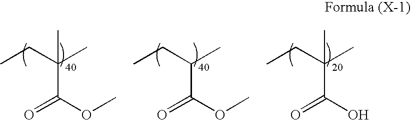

Victoria pure blue was added to the obtained polymerization granulated particles in an amount of 5% by weight to the solid content of the particles, followed by reacting at 50° C. for 4 hours. After the completion of the reaction, the reaction mixture was passed through a 4-μm filter to obtain blue color ink [J-4].

[Preparation of Ink E]

<Polymer Solution-Type Ink>

10 g of methyl methacrylate-methacrylic acid copolymer (copolymerization ratio: methyl methacrylate 60 mol %/methacrylic acid 40 mol %, weight average molecular weight: 40,000) was dissolved in a mixture of 30 g of 1-methoxy-2-propanol and 60 g of water. To the solution 1.5 g of trimethylamine was added. Thus ink composition [J-5] was obtained.

[Preparation of Ink F]

10 g of methyl methacrylate-methacrylic acid copolymer (copolymerization ratio: methyl methacrylate 60 mol %/methacrylic acid 40 mol %, weight average molecular weight: 60,000) was dissolved in 90 g of diethylene glycol diethylether. Thus ink composition [J-6] was obtained.

[Preparation of Ink G]

20 g of radical polymerizable UV ink (manufactured by Mimaki Engineering Co. Ltd.)was dissolved in 80 g of diethylene glycol diethylether. Thus ink composition [J-7] was obtained.

(Application of Ink by Ink Jet Recording Method 1)

A radical polymerizable UV ink (manufactured by Mimaki Engineering Co. Ltd.) and the ink compositions [J-1], [J-4], [J-6] and [J-7] obtained above were applied to direct-writing planographic printing plate precursors with an ink jet printer (trade name: UJF-605C, manufactured by Mimaki Engineering Co. Ltd.) equipped with a piezo-type head and a UV radiation device. The radical polymerizable UV ink (manufactured by Mimaki Engineering Co. Ltd.) and [J-1] were UV cured. [J-4] was heated at a temperature of 100° C. for 10 second after inkjet recording. [J-6] was heated at a temperature of 100° C. for 10 second after ink jet recording. [J-7] was UV cured.

(Application of Ink by Ink Jet Recording Method 2)

The ink compositions [J-2], [J-3] and [J-5] were independently applied to the direct-writing planographic printing plate precursors in a droplet amount of 1.5 pl with an ink jet printer (trade name: PX-G920, manufactured by Seiko Epson Corporation) equipped with a piezo-type head. Subsequently, [J-2] was exposed to a mercury vapor lamp for polymerization. [J-3] and [J-5] were heated at a temperature of 100° C. for 10 second after ink jet recording.

[Evaluation of Printing Durability]

The thus obtained planographic printing plates were used for printing with a printer (trade name: Lithron, manufactured by Komori Corporation) using black ink (trade name: DIC-GEOS(N), manufactured by Dainippon Ink And Chemicals, Inc. The printing durability was evaluated by the number of sheets printed before decrease in the image density of the solid image began to be recognized with the naked eye. The more the number of sheets, higher the printing durability.

[Evaluation of Stain Resistance]

The obtained planographic printing plates were used for printing with a printer (trade name: Mitsubishi Daiya type F2, manufactured by Mitsubishi Heavy Industries, Ltd.) using a 3% aqueous solution of a fountain solution (trade name: Ecolity-2) and red ink (trade name: DIC-GEOS(s)). After contacting the moistened roller with the 10 rotating plate, printing was initiated upon the application of ink. The number of sheets before a fine printed sheet was obtained was counted. The fewer the number of sheets, the higher the hydrophilicity and better ink removing properties, which means the higher stain resistance.

The results of these evaluations are shown below.

The result of the evaluation for the planographic printing plates produced by applying the radical polymerizable UV ink (manufactured by Mimaki Engineering Co. Ltd.) to each recording medium for producing the direct-writing planographic printing plate are indicated by “Examples A-1 to A-52 (Comparative examples A-1 to A-24)”, and those for the cation polymerizable ink composition [J-1], the radical polymerizable aqueous ink composition [J-2], the solvent disperstion-type ink composition [J-3], the water dispersion-type ink composition [J-4] and the polymer solution-type ink composition [J-5] are indicated by “Examples B-1 to B-52 (Comparative examples B-1 to B-24)”, “Examples C-1 to C-52 (Comparative examples C-1 to C-24)”, “Examples D-1 to D-52 (Comparative examples D-1 to D-24)”, “Examples E-1 to E-52 (Comparative examples E-1 to E-16)” and “Examples F-1 to F-52 (Comparative examples F-1 to F-24”), respectively. The results of ink composition [J-6] and [J-7] are indicated by “Examples G-17 to G-34 (Comparative examples G-10 to G-15)” and “Examples H-17 to H-34 (Comparative examples H-1 to H-16” respectively.

The evaluation results for the planographic printing plates formed thereon with an image area by applying the aforementioned ink compositions to the direct-writing planographic printing plate precursors 1 to 19 are shown in Table 2 to Table 7.

TABLE 2

| | Direct-writing | | | | | | | |
|---|---|---|---|---|---|---|---|---|
| | planographic | | | Dot | | | Contact angle | |
| | printing plate | Silicate | Fluorine-based | diameter | Number of | Printing | Ink drops in | Water drops in |
| | precursor | treatment | compound | (μm) | stained sheets | durability | air | air |
| Example A-1 | 1 | I | F-5 | 50 | 30 | 60000 | 40 | 5 |
| Example A-2 | 2 | I | F-7 | 50 | 25 | 60000 | 40 | 5 |
| Example A-3 | 3 | I | F-10 | 40 | 25 | 60000 | 45 | 5 |
| Example A-4 | 4 | I | F-12 | 30 | 20 | 60000 | 60 | 5 |
| Example A-5 | 5 | I | F-13 | 40 | 35 | 60000 | 45 | 5 |
| Example A-6 | 6 | I | F-14 | 50 | 50 | 60000 | 40 | 5 |
| Example A-7 | 7 | I | F-16 | 50 | 40 | 60000 | 40 | 5 |
| Example A-8 | 8 | I | F-19 | 30 | 20 | 60000 | 50 | 5 |
| Example A-9 | 9 | II | F-12 | 30 | 30 | 60000 | 50 | 5 |
| Example A-10 | 10 | II | F-19 | 30 | 30 | 60000 | 50 | 5 |
| Example A-11 | 11 | III | F-12 | 30 | 20 | 50000 | 60 | 5 |
| Example A-12 | 12 | III | F-19 | 30 | 20 | 50000 | 60 | 5 |
| Comparative | 13 | IV | F-12 | 40 | 100 | 60000 | 20 | 10 |
| Example A-1 | | | | | | | | |
| Comparative | 14 | IV | F-19 | 40 | 100 | 60000 | 20 | 10 |
| Example A-2 | | | | | | | | |
| Comparative | 15 | V | F-12 | 60 | 20 | 1000 | 50 | 10 |
| Example A-3 | | | | | | | | |
| Comparative | 16 | V | F-19 | 55 | 20 | 1000 | 50 | 10 |
| Example A-4 | | | | | | | | |
| Comparative | 17 | I | — | 120 | 20 | 60000 | 10 | 5 |
| Example A-5 | | | | | | | | |
| Comparative | 18 | II | — | 120 | 20 | 60000 | 10 | 5 |
| Example A-6 | | | | | | | | |
| Comparative | 19 | III | — | 120 | 20 | 60000 | 10 | 5 |
| Example A-7 | | | | | | | | |

TABLE 3

| | Direct-writing | | | | | | | |
|---|---|---|---|---|---|---|---|---|
| | planographic | | | | | | Contact angle | |
| | printing plate | Silicate | Fluorine-based | Dot diameter | Number of | Printing | Ink drops in | Water drops in |
| | precursor | treatment | compound | (μm) | stained sheets | durability | air | air |
| Example B-1 | 1 | I | F-5 | 45 | 20 | 50000 | 40 | 5 |
| Example B-2 | 2 | I | F-7 | 45 | 20 | 50000 | 40 | 5 |
| Example B-3 | 3 | I | F-10 | 40 | 20 | 50000 | 45 | 5 |
| Example B-4 | 4 | I | F-12 | 35 | 20 | 50000 | 55 | 5 |
| Example B-5 | 5 | I | F-13 | 35 | 30 | 50000 | 45 | 5 |
| Example B-6 | 6 | I | F-14 | 45 | 40 | 50000 | 40 | 5 |
| Example B-7 | 7 | I | F-16 | 50 | 30 | 50000 | 40 | 5 |
| Example B-8 | 8 | I | F-19 | 35 | 20 | 50000 | 45 | 5 |
| Example B-9 | 9 | II | F-12 | 35 | 20 | 50000 | 40 | 5 |
| Example B-10 | 10 | II | F-19 | 40 | 20 | 50000 | 40 | 5 |
| Example B-11 | 11 | III | F-12 | 30 | 20 | 45000 | 60 | 5 |
| Example B-12 | 12 | III | F-19 | 30 | 20 | 45000 | 50 | 5 |
| Comparative | 13 | IV | F-12 | 60 | 100 | 50000 | 20 | 10 |
| Example B-1 | | | | | | | | |
| Comparative | 14 | IV | F-19 | 60 | 100 | 50000 | 20 | 10 |
| Example B-2 | | | | | | | | |
| Comparative | 15 | V | F-12 | 30 | 20 | 1000 | 60 | 5 |
| Example B-3 | | | | | | | | |
| Comparative | 16 | V | F-19 | 30 | 20 | 1000 | 60 | 5 |
| Example B-4 | | | | | | | | |
| Comparative | 17 | I | — | 120 | 20 | 55000 | 10 | 5 |
| Example B-5 | | | | | | | | |
| Comparative | 18 | II | — | 120 | 20 | 55000 | 10 | 5 |
| Example B-6 | | | | | | | | |
| Comparative | 19 | III | — | 120 | 20 | 55000 | 10 | 5 |
| ExampleB-7 | | | | | | | | |

TABLE 4

| | Direct-writing | | | | | | Contact angle | |
|---|---|---|---|---|---|---|---|---|
| | planographic printing | Silicate | Fluorine-based | Dot diameter | Number of | Printing | Ink drops | Water drops |
| | plate precursor | treatment | compound | (μm) | stained sheets | durability | in air | in air |
| Example C-1 | 1 | I | F-5 | 40 | 20 | 40000 | 35 | 5 |
| Example C-2 | 2 | I | F-7 | 40 | 20 | 40000 | 35 | 5 |
| Example C-3 | 3 | I | F-10 | 30 | 20 | 40000 | 40 | 5 |
| Example C-4 | 4 | I | F-12 | 30 | 20 | 40000 | 50 | 5 |
| Example C-5 | 5 | I | F-13 | 30 | 30 | 40000 | 40 | 5 |
| Example C-6 | 6 | I | F-14 | 40 | 40 | 40000 | 35 | 5 |
| Example C-7 | 7 | I | F-16 | 45 | 30 | 40000 | 35 | 5 |
| Example C-8 | 8 | I | F-19 | 30 | 20 | 40000 | 40 | 5 |
| Example C-9 | 9 | II | F-12 | 30 | 20 | 40000 | 35 | 5 |
| Example C-10 | 10 | II | F-19 | 30 | 20 | 40000 | 35 | 5 |
| Example C-11 | 11 | III | F-12 | 28 | 20 | 30000 | 50 | 5 |
| Example C-12 | 12 | III | F-19 | 28 | 20 | 30000 | 45 | 5 |
| Comparative | 13 | IV | F-12 | 55 | 100 | 40000 | 15 | 10 |
| Example C-1 | | | | | | | | |
| Comparative | 14 | IV | F-19 | 55 | 100 | 40000 | 15 | 10 |
| Example C-2 | | | | | | | | |
| Comparative | 15 | V | F-12 | 28 | 20 | 800 | 60 | 5 |
| Example C-3 | | | | | | | | |
| Comparative | 16 | V | F-19 | 28 | 20 | 800 | 60 | 5 |
| Example C-4 | | | | | | | | |
| Comparative | 17 | I | — | 100 | 20 | 45000 | 5 | 5 |
| Example C-5 | | | | | | | | |
| Comparative | 18 | II | — | 100 | 20 | 45000 | 5 | 5 |
| Example C-6 | | | | | | | | |
| Comparative | 19 | III | — | 100 | 20 | 45000 | 5 | 5 |
| ExampleC-7 | | | | | | | | |

TABLE 5

| | Direct-writing | | | | | | Contact angle | |
|---|---|---|---|---|---|---|---|---|
| | planographic printing | Silicate | Fluorine-based | Dot diameter | Number of | Printing | Ink drops | Water drops |
| | plate precursor | treatment | compound | (μm) | stained sheets | durability | in air | in air |
| Example D-1 | 1 | I | F-5 | 35 | 20 | 20000 | 45 | 5 |
| Example D-2 | 2 | I | F-7 | 35 | 20 | 20000 | 45 | 5 |
| Example D-3 | 3 | I | F-10 | 30 | 20 | 20000 | 50 | 5 |
| Example D-4 | 4 | I | F-12 | 30 | 20 | 20000 | 60 | 5 |
| Example D-5 | 5 | I | F-13 | 30 | 30 | 20000 | 50 | 5 |
| Example D-6 | 6 | I | F-14 | 35 | 40 | 20000 | 45 | 5 |
| Example D-7 | 7 | I | F-16 | 40 | 30 | 20000 | 45 | 5 |
| Example D-8 | 8 | I | F-19 | 30 | 20 | 20000 | 55 | 5 |
| Example D-9 | 9 | II | F-12 | 30 | 30 | 20000 | 45 | 5 |
| Example D-10 | 10 | II | F-19 | 30 | 30 | 20000 | 45 | 5 |
| Example D-11 | 11 | III | F-12 | 30 | 20 | 15000 | 60 | 5 |
| Example D-12 | 12 | III | F-19 | 30 | 20 | 15000 | 60 | 5 |
| Comparative | 13 | IV | F-12 | 50 | 100 | 20000 | 25 | 10 |
| Example D-1 | | | | | | | | |
| Comparative | 14 | IV | F-19 | 50 | 100 | 20000 | 25 | 10 |
| Example D-2 | | | | | | | | |
| Comparative | 15 | V | F-12 | 30 | 20 | 500 | 60 | 5 |
| Example D-3 | | | | | | | | |
| Comparative | 16 | V | F-19 | 30 | 20 | 500 | 60 | 5 |
| Example D-4 | | | | | | | | |
| Comparative | 17 | I | — | 90 | 20 | 20000 | 15 | 5 |
| Example D-5 | | | | | | | | |
| Comparative | 18 | II | — | 90 | 20 | 20000 | 15 | 5 |
| Example D-6 | | | | | | | | |
| Comparative | 19 | III | — | 90 | 20 | 20000 | 15 | 5 |
| Example D-7 | | | | | | | | |

TABLE 6

| | Direct-writing | | | | | | Contact angle | |
|---|---|---|---|---|---|---|---|---|
| | planographic printing | Silicate | Fluorine-based | Dot diameter | Number of | Printing | Ink drops | Water drops |
| | plate precursor | treatment | compound | (μm) | stained sheets | durability | in air | in air |
| Example E-1 | 1 | I | F-5 | 45 | 20 | 30000 | 40 | 5 |
| Example E-2 | 2 | I | F-7 | 45 | 20 | 30000 | 40 | 5 |
| Example E-3 | 3 | I | F-10 | 40 | 20 | 30000 | 45 | 5 |
| Example E-4 | 4 | I | F-12 | 35 | 20 | 30000 | 55 | 5 |
| Example E-5 | 5 | I | F-13 | 40 | 30 | 30000 | 45 | 5 |
| Example E-6 | 6 | I | F-14 | 45 | 40 | 30000 | 40 | 5 |
| Example E-7 | 7 | I | F-16 | 45 | 30 | 30000 | 40 | 5 |
| Example E-8 | 8 | I | F-19 | 35 | 20 | 30000 | 45 | 5 |
| Example E-9 | 9 | II | F-12 | 35 | 20 | 30000 | 45 | 5 |
| Example E-10 | 10 | II | F-19 | 35 | 20 | 30000 | 45 | 5 |
| Example E-11 | 11 | III | F-12 | 30 | 20 | 25000 | 60 | 5 |
| Example E-12 | 12 | III | F-19 | 30 | 20 | 25000 | 55 | 5 |
| Comparative | 13 | IV | F-12 | 60 | 100 | 30000 | 20 | 10 |
| Example E-1 | | | | | | | | |
| Comparative | 14 | IV | F-19 | 60 | 100 | 30000 | 20 | 10 |
| Example E-2 | | | | | | | | |
| Comparative | 15 | V | F-12 | 30 | 20 | 500 | 60 | 5 |
| Example E-3 | | | | | | | | |
| Comparative | 16 | V | F-19 | 30 | 20 | 500 | 60 | 5 |
| Example E-4 | | | | | | | | |
| Comparative | 17 | I | — | 125 | 20 | 30000 | 8 | 5 |
| Example E-5 | | | | | | | | |
| Comparative | 18 | II | — | 125 | 20 | 30000 | 8 | 5 |
| Example E-6 | | | | | | | | |
| Comparative | 19 | III | — | 125 | 20 | 30000 | 8 | 5 |
| Example E-7 | | | | | | | | |

TABLE 7

| | Direct-writing | | | Dot | | | Contact angle | |
|---|---|---|---|---|---|---|---|---|
| | planographic printing | Silicate | Fluorine-based | diameter | Number of | Printing | Ink drops | Water drops |
| | plate precursor | treatment | compound | (μm) | stained sheets | durability | in air | in air |
| Example F-1 | 1 | I | F-5 | 40 | 20 | 30000 | 35 | 5 |
| Example F-2 | 2 | I | F-7 | 40 | 20 | 30000 | 35 | 5 |
| Example F-3 | 3 | I | F-10 | 30 | 20 | 30000 | 40 | 5 |
| Example F-4 | 4 | I | F-12 | 30 | 20 | 30000 | 50 | 5 |
| Example F-5 | 5 | I | F-13 | 30 | 30 | 30000 | 40 | 5 |
| Example F-6 | 6 | I | F-14 | 40 | 40 | 30000 | 35 | 5 |
| Example F-7 | 7 | I | F-16 | 45 | 30 | 30000 | 35 | 5 |
| Example F-8 | 8 | I | F-19 | 30 | 20 | 30000 | 40 | 5 |
| Example F-9 | 9 | II | F-12 | 30 | 20 | 30000 | 35 | 5 |
| Example F-10 | 10 | II | F-19 | 30 | 20 | 30000 | 35 | 5 |
| Example F-11 | 11 | III | F-12 | 30 | 20 | 20000 | 50 | 5 |
| Example F-12 | 12 | III | F-19 | 30 | 20 | 20000 | 40 | 5 |
| Comparative | 13 | IV | F-12 | 55 | 100 | 30000 | 15 | 10 |
| Example F-1 | | | | | | | | |
| Comparative | 14 | IV | F-19 | 55 | 100 | 30000 | 15 | 10 |
| Example F-2 | | | | | | | | |
| Comparative | 15 | V | F-12 | 30 | 20 | 1000 | 50 | 5 |
| Example F-3 | | | | | | | | |
| Comparative | 16 | V | F-19 | 30 | 20 | 1000 | 40 | 5 |
| Example F-4 | | | | | | | | |
| Comparative | 17 | I | — | 100 | 20 | 30000 | 5 | 5 |
| Example F-5 | | | | | | | | |
| Comparative | 18 | II | — | 100 | 20 | 30000 | 5 | 5 |
| Example F-6 | | | | | | | | |
| Comparative | 19 | III | — | 100 | 20 | 30000 | 5 | 5 |
| Example F-7 | | | | | | | | |

The evaluation results for the planographic printing plates formed thereon with an image area by applying the ink compositions to the direct-writing planographic printing plate precursors 20 to 25 are shown in Table 8 to Table 13.

TABLE 8

| | Direct-writing | | | | | | | |
|---|---|---|---|---|---|---|---|---|
| | planographic | | | | | | Contact angle | |
| | printing plate | Fluorine-based | Coating | Dot diameter | Number of stained | Printing | Ink drops | Water drops |
| | precursor | compound | weight | (μm) | sheets | durability | in air | in air |
| Example A-13 | 20 | F-12 | 1.0 | 40 | 15 | 60000 | 40 | 5 |
| Example A-14 | 21 | F-12 | 5.0 | 30 | 20 | 60000 | 60 | 5 |
| Example A-15 | 22 | F-12 | 10.0 | 28 | 30 | 40000 | 65 | 6 |
| Example A-16 | 23 | F-12 | 50.0 | 40 | 40 | 20000 | 60 | 7 |
| Comparative | 24 | — | — | 120 | 20 | 60000 | 10 | 5 |
| Example A-8 | | | | | | | | |
| Comparative | 25 | F-12 | 60.0 | 50 | 100 | 2000 | 55 | 9 |
| Example A-9 | | | | | | | | |

TABLE 9

| | Direct-writing | | | | | | | |
|---|---|---|---|---|---|---|---|---|
| | planographic | | | | | | Contact angle | |
| | printing plate | Fluorine-based | Coating | Dot diameter | Number of | Printing | Ink drops | Water drops |
| | precursor | compound | weight | (μm) | stained sheets | durability | in air | in air |
| Example B-13 | 20 | F-12 | 1.0 | 45 | 15 | 55000 | 35 | 5 |
| Example B-14 | 21 | F-12 | 5.0 | 35 | 20 | 50000 | 50 | 5 |
| Example B-15 | 22 | F-12 | 10.0 | 30 | 30 | 45000 | 55 | 6 |
| Example B-16 | 23 | F-12 | 50.0 | 45 | 40 | 40000 | 50 | 7 |
| Comparative | 24 | — | 0.0 | 120 | 20 | 40000 | 10 | 5 |
| Example B-8 | | | | | | | | |
| Comparative | 25 | F-12 | 60.0 | 50 | 100 | 2000 | 55 | 9 |
| Example B-9 | | | | | | | | |

TABLE 10

| | Direct-writing | | | | | | | |
|---|---|---|---|---|---|---|---|---|
| | planographic | | | Dot | | | Contact angle | |
| | printing plate | Fluorine-based | Coating | diameter | Number of | | Ink drops | Water drops |
| | precursor | compound | weight | (μm) | stained sheets | Printing durability | in air | in air |
| Example C-13 | 20 | F-12 | 1.0 | 40 | 15 | 45000 | 30 | 5 |
| Example C-14 | 21 | F-12 | 5.0 | 35 | 20 | 40000 | 45 | 5 |
| Example C-15 | 22 | F-12 | 10.0 | 30 | 30 | 40000 | 50 | 6 |
| Example C-16 | 23 | F-12 | 50.0 | 35 | 40 | 35000 | 45 | 7 |
| Comparative | 24 | — | 0.0 | 100 | 20 | 45000 | 5 | 5 |
| Example C-8 | | | | | | | | |
| Comparative | 25 | F-12 | 60.0 | 40 | 100 | 1000 | 50 | 9 |
| Example C-9 | | | | | | | | |

TABLE 11

| | Direct-writing | | | | | | | |
|---|---|---|---|---|---|---|---|---|
| | planographic printing | Fluorine-based | Coating | Dot diameter | Number of | Printing | Contact angle | |
| | plate precursor | compound | weight | (μm) | stained sheets | durability | Ink drops in air | Water drops in air |
| Example D-13 | 20 | F-12 | 1.0 | 40 | 15 | 20000 | 45 | 5 |
| Example D-14 | 21 | F-12 | 5.0 | 30 | 20 | 20000 | 60 | 5 |
| Example D-15 | 22 | F-12 | 10.0 | 30 | 30 | 20000 | 65 | 6 |
| Example D-16 | 23 | F-12 | 50.0 | 30 | 40 | 10000 | 55 | 7 |
| Comparative | 24 | — | 0.0 | 90 | 20 | 20000 | 15 | 5 |
| Example D-8 | | | | | | | | |
| Comparative | 25 | F-12 | 60.0 | 35 | 100 | 1000 | 60 | 9 |
| Example D-9 | | | | | | | | |

TABLE 12

| | Direct-writing | | | | | | | |
|---|---|---|---|---|---|---|---|---|
| | planographic printing | Fluorine-based | Coating | Dot diameter | Number of | Printing | Contact angle | |
| | plate precursor | compound | weight | (μm) | stained sheets | durability | Ink drops in air | Water drops in air |
| Example E-13 | 20 | F-12 | 1.0 | 45 | 15 | 30000 | 30 | 5 |
| Example E-14 | 21 | F-12 | 5.0 | 35 | 20 | 20000 | 40 | 5 |
| Example E-15 | 22 | F-12 | 10.0 | 30 | 30 | 20000 | 45 | 6 |
| Example E-16 | 23 | F-12 | 50.0 | 45 | 40 | 10000 | 40 | 7 |
| Comparative | 24 | — | 0.0 | 125 | 20 | 20000 | 8 | 5 |
| Example E-8 | | | | | | | | |
| Comparative | 25 | F-12 | 60.0 | 55 | 100 | 1000 | 45 | 9 |
| Example E-9 | | | | | | | | |

TABLE 13

| | Direct-writing | | | | | | | |
|---|---|---|---|---|---|---|---|---|
| | planographic printing | Fluorine-based | Coating | Dot diameter | Number of | Printing | Contact angle | |
| | plate precursor | compound | weight | (μm) | stained sheets | durability | Ink drops in air | Water drops in air |
| Example F-13 | 20 | F-12 | 1.0 | 40 | 15 | 30000 | 30 | 5 |
| Example F-14 | 21 | F-12 | 5.0 | 35 | 20 | 20000 | 45 | 5 |
| Example F-15 | 22 | F-12 | 10.0 | 30 | 30 | 20000 | 50 | 6 |
| Example F-16 | 23 | F-12 | 50.0 | 35 | 40 | 10000 | 45 | 7 |
| Comparative | 24 | — | 0.0 | 100 | 20 | 20000 | 5 | 5 |
| Example F-8 | | | | | | | | |
| Comparative | 25 | F-12 | 60.0 | 40 | 100 | 1000 | 50 | 9 |
| Example F-9 | | | | | | | | |

The results of the evaluations of the planographic printing plates produced by forming an image area on the direct-writing planographic printing plate precursors 26 to 49 using the ink compositions are shown in Table 14 to Table 21.

TABLE 14

| | Direct-writing | Fluorine- | | Hydrophilic | | | | | | |
|---|---|---|---|---|---|---|---|---|---|---|
| | planographic | based compound | | resin | | Dot | | | Contact angle | |
| | printing plate | | Coating | | Coating | diameter | Number of | Printing | Ink drops | Water drops |
| | precursor | Compound | weight | Compound | weight | (μm) | stained sheets | durability | in air | in air |
| Example A-17 | 26 | F-12 | 1.0 | (1) | 1.0 | 35 | 10 | 60000 | 60 | 5 |
| Example A-18 | 27 | F-12 | 4.0 | (1) | 6.0 | 25 | 10 | 60000 | 85 | 5 |
| Example A-19 | 28 | F-12 | 1.0 | (1) | 50.0 | 40 | 20 | 20000 | 55 | 5 |
| Example A-20 | 29 | F-12 | 50.0 | (1) | 1.0 | 50 | 30 | 20000 | 60 | 5 |
| Example A-21 | 30 | F-12 | 50.0 | (1) | 50.0 | 45 | 30 | 16000 | 60 | 5 |
| Example A-22 | 31 | F-19 | 1.0 | (1) | 1.0 | 40 | 10 | 60000 | 55 | 5 |
| Example A-23 | 32 | F-19 | 4.0 | (1) | 6.0 | 25 | 10 | 60000 | 85 | 5 |
| Example A-24 | 33 | F-19 | 1.0 | (1) | 50.0 | 40 | 15 | 30000 | 55 | 5 |
| Example A-25 | 34 | F-19 | 50.0 | (1) | 1.0 | 50 | 25 | 30000 | 60 | 5 |
| Example A-26 | 35 | F-19 | 50.0 | (1) | 50.0 | 50 | 25 | 20000 | 60 | 5 |
| Example A-27 | 36 | F-12 | 0.2 | (1) | 100 | 50 | 20 | 18000 | 40 | 5 |
| Example A-28 | 37 | F-12 | 1.0 | (1) | 100 | 40 | 20 | 18000 | 50 | 5 |
| Example A-29 | 38 | F-12 | 1.0 | (1) | 150 | 40 | 20 | 17000 | 50 | 5 |
| Example A-30 | 39 | F-12 | 1.0 | (1) | 200 | 40 | 25 | 16000 | 50 | 5 |
| Example A-31 | 40 | F-19 | 0.2 | (1) | 100 | 45 | 20 | 18000 | 55 | 5 |
| Example A-32 | 41 | F-19 | 1.0 | (1) | 100 | 35 | 20 | 17000 | 60 | 5 |
| Example A-33 | 42 | F-19 | 1.0 | (1) | 150 | 35 | 25 | 16000 | 60 | 5 |
| Example A-34 | 43 | F-19 | 1.0 | (1) | 200 | 35 | 25 | 16000 | 60 | 5 |
| Comparative | 44 | — | 0.0 | — | 0.0 | 120 | 20 | 6000 | 10 | 5 |
| Example A-10 | | | | | | | | | | |
| Comparative | 45 | F-12 | 60 | (1) | 0.0.0 | 55 | 100 | 2000 | 55 | 9 |
| Example A-11 | | | | | | | | | | |
| Comparative | 46 | F-12 | 1.0 | (1) | 220 | 40 | 30 | 3000 | 55 | 5 |
| Example A-12 | | | | | | | | | | |
| Comparative | 47 | F-19 | 60.0 | (1) | 0.0 | 40 | 100 | 2000 | 40 | 11 |
| Example A-13 | | | | | | | | | | |
| Comparative | 48 | F-19 | 1.0 | (1) | 220 | 35 | 30 | 3000 | 60 | 5 |
| Example A-14 | | | | | | | | | | |
| Comparative | 49 | — | 0.0 | (1) | 100 | 150 | 25 | 18000 | 10 | 5 |
| Example A-15 | | | | | | | | | | |

TABLE 15

| | Direct-writing | Fluorine-based | | Hydrophilic | | | | | | |
|---|---|---|---|---|---|---|---|---|---|---|
| | planographic | compound | | resin | | | Number of | | Contact angle | |
| | printing plate | | Coating | | Coating | Dot diameter | stained | Printing | Ink drops | Water drops |
| | precursor | Compound | weight | Compound | weight | (μm) | sheets | durability | in air | in air |
| Example B-17 | 26 | F-12 | 1.0 | (1) | 1.0 | 40 | 10 | 50000 | 55 | 5 |
| Example B-18 | 27 | F-12 | 4.0 | (1) | 6.0 | 30 | 10 | 50000 | 80 | 5 |
| Example B-19 | 28 | F-12 | 1.0 | (1) | 50.0 | 40 | 20 | 20000 | 50 | 5 |
| Example B-20 | 29 | F-12 | 50.0 | (1) | 1.0 | 50 | 30 | 20000 | 55 | 5 |
| Example B-21 | 30 | F-12 | 50.0 | (1) | 50.0 | 45 | 30 | 15000 | 55 | 5 |
| Example B-22 | 31 | F-19 | 1.0 | (1) | 1.0 | 45 | 10 | 55000 | 50 | 5 |
| Example B-23 | 32 | F-19 | 4.0 | (1) | 6.0 | 30 | 10 | 55000 | 80 | 5 |
| Example B-24 | 33 | F-19 | 1.0 | (1) | 50.0 | 45 | 15 | 25000 | 50 | 5 |
| Example B-25 | 34 | F-19 | 50.0 | (1) | 1.0 | 55 | 25 | 25000 | 55 | 5 |
| Example B-26 | 35 | F-19 | 50.0 | (1) | 50.0 | 55 | 25 | 20000 | 55 | 5 |
| Example B-27 | 36 | F-12 | 0.2 | (1) | 100 | 50 | 20 | 17000 | 55 | 5 |
| Example B-28 | 37 | F-12 | 1.0 | (1) | 100 | 40 | 20 | 17000 | 50 | 5 |
| Example B-29 | 38 | F-12 | 1.0 | (1) | 150 | 40 | 20 | 17000 | 50 | 5 |
| Example B-30 | 39 | F-12 | 1.0 | (1) | 200 | 40 | 25 | 16000 | 50 | 5 |
| Example B-31 | 40 | F-19 | 0.2 | (1) | 100 | 55 | 20 | 17000 | 55 | 5 |
| Example B-32 | 41 | F-19 | 1.0 | (1) | 100 | 45 | 20 | 17000 | 50 | 5 |
| Example B-33 | 42 | F-19 | 1.0 | (1) | 150 | 45 | 25 | 17000 | 50 | 5 |
| Example B-34 | 43 | F-19 | 1.0 | (1) | 200 | 45 | 25 | 16000 | 50 | 5 |
| Comparative | 44 | — | 0.0 | — | 0.0 | 120 | 20 | 60000 | 10 | 5 |
| Example B-10 | | | | | | | | | | |
| Comparative | 45 | F-12 | 60.0 | (1) | 0.0 | 50 | 100 | 2000 | 55 | 9 |
| Example B-11 | | | | | | | | | | |
| Comparative | 46 | F-12 | 1.0 | (1) | 220 | 40 | 30 | 4000 | 55 | 5 |
| Example B-12 | | | | | | | | | | |
| Comparative | 47 | F-19 | 60.0 | (1) | 0.0 | 40 | 100 | 2000 | 40 | 11 |
| Example B-13 | | | | | | | | | | |
| Comparative | 48 | F-19 | 1.0 | (1) | 220 | 45 | 30 | 4000 | 60 | 5 |
| Example B-14 | | | | | | | | | | |
| Comparative | 49 | — | 0.0 | (1) | 100 | 150 | 25 | 16000 | 20 | 5 |
| Example B-15 | | | | | | | | | | |

TABLE 16

| | Direct-writing | Fluorine-based | | Hydrophilic | | | | | | |
|---|---|---|---|---|---|---|---|---|---|---|
| | planographic | compound | | resin | | Dot | Number of | | Contact angle | |
| | printing plate | | Coating | | Coating | diameter | stained | Printing | Ink drops | Water |
| | precursor | Compound | weight | Compound | weight | (μm) | sheets | durability | in air | drops in air |
| Example C-17 | 26 | F-12 | 1.0 | (1) | 1.0 | 35 | 10 | 45000 | 50 | 5 |
| Example C-18 | 27 | F-12 | 4.0 | (1) | 6.0 | 28 | 10 | 45000 | 75 | 5 |
| Example C-19 | 28 | F-12 | 1.0 | (1) | 50.0 | 40 | 20 | 20000 | 45 | 5 |
| Example C-20 | 29 | F-12 | 50.0 | (1) | 1.0 | 40 | 30 | 20000 | 50 | 5 |
| Example C-21 | 30 | F-12 | 50.0 | (1) | 50.0 | 45 | 30 | 10000 | 50 | 5 |
| Example C-22 | 31 | F-19 | 1.0 | (1) | 1.0 | 35 | 10 | 45000 | 45 | 5 |
| Example C-23 | 32 | F-19 | 4.0 | (1) | 6.0 | 25 | 10 | 45000 | 75 | 5 |
| Example C-24 | 33 | F-19 | 1.0 | (1) | 50.0 | 50 | 15 | 25000 | 45 | 5 |
| Example C-25 | 34 | F-19 | 50.0 | (1) | 1.0 | 50 | 25 | 25000 | 50 | 5 |
| Example C-26 | 35 | F-19 | 50.0 | (1) | 50.0 | 50 | 25 | 20000 | 50 | 5 |
| Example C-27 | 36 | F-12 | 0.2 | (1) | 100 | 45 | 20 | 19000 | 45 | 5 |
| Example C-28 | 37 | F-12 | 1.0 | (1) | 100 | 35 | 20 | 20000 | 50 | 5 |
| Example C-29 | 38 | F-12 | 1.0 | (1) | 150 | 35 | 20 | 20000 | 50 | 5 |
| Example C-30 | 39 | F-12 | 1.0 | (1) | 200 | 35 | 25 | 18000 | 50 | 5 |
| Example C-31 | 40 | F-19 | 0.2 | (1) | 100 | 45 | 20 | 20000 | 45 | 5 |
| Example C-32 | 41 | F-19 | 1.0 | (1) | 100 | 35 | 20 | 22000 | 50 | 5 |
| Example C-33 | 42 | F-19 | 1.0 | (1) | 150 | 35 | 20 | 22000 | 50 | 5 |
| Example C-34 | 43 | F-19 | 1.0 | (1) | 200 | 35 | 25 | 20000 | 50 | 5 |
| Comparative | 44 | — | 0.0 | — | 0.0 | 90 | 20 | 20000 | 15 | 5 |
| Example D-10 | | | | | | | | | | |
| Comparative | 45 | F-12 | 60.0 | (1) | 0.0 | 35 | 100 | 1000 | 60 | 9 |
| Example D-11 | | | | | | | | | | |
| Comparative | 46 | F-12 | 1.0 | (1) | 220 | 35 | 30 | 2000 | 60 | 5 |
| Example D-12 | | | | | | | | | | |
| Comparative | 47 | F-19 | 60.0 | (1) | 0.0 | 30 | 100 | 1000 | 55 | 11 |
| Example D-13 | | | | | | | | | | |
| Comparative | 48 | F-19 | 1.0 | (1) | 220 | 40 | 30 | 2000 | 60 | 5 |
| Example D-14 | | | | | | | | | | |
| Comparative | 49 | — | 0.0 | (1) | 100 | 135 | 25 | 500 | 10 | 5 |
| Example D-15 | | | | | | | | | | |

TABLE 17

| | Direct-writing | Fluorine-based | | Hydrophilic | | | | | | |
|---|---|---|---|---|---|---|---|---|---|---|
| | planographic | compound | | resin | | Dot | Number of | | Contact angle | |
| | printing plate | | Coating | | Coating | diameter | stained | Printing | Ink drops | Water drops |
| | precursor | Compound | weight | Compound | weight | (μm) | sheets | durability | in air | in air |
| Example D-17 | 26 | F-12 | 1.0 | (1) | 1.0 | 30 | 10 | 20000 | 60 | 5 |
| Example D-18 | 27 | F-12 | 4.0 | (1) | 6.0 | 30 | 10 | 20000 | 85 | 5 |
| Example D-19 | 28 | F-12 | 1.0 | (1) | 50.0 | 40 | 20 | 10000 | 55 | 5 |
| Example D-20 | 29 | F-12 | 50.0 | (1) | 1.0 | 35 | 30 | 10000 | 60 | 5 |
| Example D-21 | 30 | F-12 | 50.0 | (1) | 50.0 | 40 | 30 | 8000 | 60 | 5 |
| Example D-22 | 31 | F-19 | 1.0 | (1) | 1.0 | 35 | 10 | 20000 | 55 | 5 |
| Example D-23 | 32 | F-19 | 4.0 | (1) | 6.0 | 28 | 10 | 20000 | 85 | 5 |
| Example D-24 | 33 | F-19 | 1.0 | (1) | 50.0 | 50 | 15 | 15000 | 55 | 5 |
| Example D-25 | 34 | F-19 | 50.0 | (1) | 1.0 | 40 | 25 | 15000 | 60 | 5 |
| Example D-26 | 35 | F-19 | 50.0 | (1) | 50.0 | 50 | 25 | 10000 | 60 | 5 |
| Example D-27 | 36 | F-12 | 0.2 | (1) | 100 | 40 | 20 | 10000 | 60 | 5 |
| Example D-28 | 37 | F-12 | 1.0 | (1) | 100 | 35 | 20 | 10000 | 65 | 5 |
| Example D-29 | 38 | F-12 | 1.0 | (1) | 150 | 35 | 20 | 10000 | 65 | 5 |
| Example D-30 | 39 | F-12 | 1.0 | (1) | 200 | 35 | 25 | 9000 | 65 | 5 |
| Example D-31 | 40 | F-19 | 0.2 | (1) | 100 | 45 | 20 | 10000 | 55 | 5 |
| Example D-32 | 41 | F-19 | 1.0 | (1) | 100 | 40 | 20 | 10000 | 60 | 5 |
| Example D-33 | 42 | F-19 | 1.0 | (1) | 150 | 40 | 25 | 10000 | 60 | 5 |
| Example D-34 | 43 | F-19 | 1.0 | (1) | 200 | 40 | 25 | 10000 | 60 | 5 |
| Comparative | 36 | — | 0.0 | — | 0.0 | 90 | 20 | 20000 | 15 | 5 |
| Example D-10 | | | | | | | | | | |
| Comparative | 37 | F-12 | 60.0 | (1) | 0.0 | 35 | 100 | 1000 | 60 | 9 |
| Example D-11 | | | | | | | | | | |
| Comparative | 38 | F-19 | 60.0 | (1) | 0.0 | 30 | 100 | 1000 | 45 | 11 |
| Example D-12 | | | | | | | | | | |
| Comparative | 39 | — | 0.0 | (1) | 60.0 | 135 | 25 | 2000 | 15 | 5 |
| Example D-13 | | | | | | | | | | |
| Comparative | 40 | F-12 | 60.0 | (1) | 60.0 | 85 | 100 | 500 | 25 | 10 |
| Example D-14 | | | | | | | | | | |
| Comparative | 41 | F-19 | 60.0 | (1) | 60.0 | 75 | 100 | 500 | 20 | 12 |
| Example D-15 | | | | | | | | | | |

TABLE 18

| | Direct-writing | Fluorine-based | | Hydrophilic | | | | | | |
|---|---|---|---|---|---|---|---|---|---|---|
| | planographic | compound | | resin | | Dot | Number of | | Contact angle | |
| | printing plate | | Coating | | Coating | diameter | stained | Printing | Ink drops | Water |
| | precursor | Compound | weight | Compound | weight | (μm) | sheets | durability | in air | drops in air |
| Example E-17 | 26 | F-12 | 1.0 | (1) | 1.0 | 40 | 10 | 30000 | 55 | 5 |
| Example E-18 | 27 | F-12 | 4.0 | (1) | 6.0 | 30 | 10 | 30000 | 80 | 5 |
| Example E-19 | 28 | F-12 | 1.0 | (1) | 50.0 | 45 | 20 | 10000 | 50 | 5 |
| Example E-20 | 29 | F-12 | 50.0 | (1) | 1.0 | 50 | 30 | 10000 | 55 | 5 |
| Example E-21 | 30 | F-12 | 50.0 | (1) | 50.0 | 50 | 30 | 8000 | 55 | 5 |
| Example E-22 | 31 | F-12 | 1.0 | (1) | 1.0 | 40 | 10 | 30000 | 50 | 5 |
| Example E-23 | 32 | F-19 | 4.0 | (1) | 6.0 | 30 | 10 | 30000 | 80 | 5 |
| Example E-24 | 33 | F-19 | 1.0 | (1) | 50.0 | 45 | 15 | 15000 | 50 | 5 |
| Example E-25 | 34 | F-19 | 50.0 | (1) | 1.0 | 50 | 25 | 15000 | 55 | 5 |
| Example E-26 | 35 | F-19 | 50.0 | (1) | 50.0 | 50 | 25 | 10000 | 55 | 5 |
| Example E-27 | 36 | F-12 | 0.2 | (1) | 100 | 50 | 20 | 10000 | 45 | 5 |
| Example E-28 | 37 | F-12 | 1.0 | (1) | 100 | 45 | 20 | 10000 | 50 | 5 |
| Example E-29 | 38 | F-12 | 1.0 | (1) | 150 | 45 | 20 | 9000 | 50 | 5 |
| Example E-30 | 39 | F-12 | 1.0 | (1) | 200 | 45 | 25 | 9000 | 50 | 5 |
| Example E-31 | 40 | F-19 | 0.2 | (1) | 100 | 50 | 20 | 10000 | 45 | 5 |
| Example E-32 | 41 | F-19 | 1.0 | (1) | 100 | 45 | 20 | 10000 | 50 | 5 |
| Example E-33 | 42 | F-19 | 1.0 | (1) | 150 | 45 | 25 | 9000 | 50 | 5 |
| Example E-34 | 43 | F-19 | 1.0 | (1) | 200 | 45 | 25 | 9000 | 50 | 5 |
| Comparative | 44 | — | 0.0 | — | 0.0 | 125 | 20 | 20000 | 8 | 5 |
| Example E-10 | | | | | | | | | | |
| Comparative | 45 | F-12 | 60.0 | (1) | 0.0 | 55 | 100 | 1000 | 40 | 9 |
| Example E-11 | | | | | | | | | | |
| Comparative | 46 | F-12 | 1.0 | (1) | 220 | 45 | 30 | 2000 | 50 | 5 |
| Example E-12 | | | | | | | | | | |
| Comparative | 47 | F-19 | 60.0 | (1) | 0.0 | 45 | 100 | 1000 | 45 | 11 |
| Example E-13 | | | | | | | | | | |
| Comparative | 48 | F-19 | 1.0 | (1) | 220 | 45 | 30 | 2000 | 50 | 5 |
| Example E-14 | | | | | | | | | | |
| Comparative | 41 | — | 0.0 | (1) | 100 | 150 | 25 | 1000 | 8 | 5 |
| Example E-15 | | | | | | | | | | |

TABLE 19

| | Direct-writing | Fluorine-based | | Hydrophilic | | | | | | |
|---|---|---|---|---|---|---|---|---|---|---|
| | planographic | compound | | resin | | Dot | Number of | | Contact angle | |
| | printing plate | | Coating | | Coating | diameter | stained | Printing | Ink drops | Water |
| | precursor | Compound | weight | Compound | weight | (μm) | sheets | durability | in air | drops in air |
| Example F-17 | 26 | F-12 | 1.0 | (1) | 1.0 | 35 | 10 | 30000 | 50 | 5 |
| Example F-18 | 27 | F-12 | 4.0 | (1) | 6.0 | 28 | 10 | 30000 | 75 | 5 |
| Example F-19 | 28 | F-12 | 1.0 | (1) | 50.0 | 40 | 20 | 10000 | 45 | 5 |
| Example F-20 | 29 | F-12 | 50.0 | (1) | 1.0 | 40 | 30 | 10000 | 50 | 5 |
| Example F-21 | 30 | F-12 | 50.0 | (1) | 50.0 | 45 | 30 | 8000 | 50 | 5 |
| Example F-22 | 31 | F-12 | 1.0 | (1) | 1.0 | 35 | 10 | 30000 | 45 | 5 |
| Example F-23 | 32 | F-19 | 4.0 | (1) | 6.0 | 25 | 10 | 30000 | 75 | 5 |
| Example F-24 | 33 | F-19 | 1.0 | (1) | 50.0 | 50 | 15 | 15000 | 45 | 5 |
| Example F-25 | 34 | F-19 | 50.0 | (1) | 1.0 | 50 | 25 | 15000 | 50 | 5 |
| Example F-26 | 35 | F-19 | 50.0 | (1) | 50.0 | 50 | 25 | 10000 | 50 | 5 |
| Example F-27 | 36 | F-12 | 0.2 | (1) | 100 | 45 | 20 | 10000 | 45 | 5 |
| Example F-28 | 37 | F-12 | 1.0 | (1) | 100 | 40 | 20 | 10000 | 50 | 5 |
| Example F-29 | 38 | F-12 | 1.0 | (1) | 150 | 40 | 20 | 10000 | 50 | 5 |
| Example F-30 | 39 | F-12 | 1.0 | (1) | 200 | 40 | 25 | 9000 | 50 | 5 |
| Example F-31 | 40 | F-19 | 0.2 | (1) | 100 | 60 | 20 | 15000 | 40 | 5 |
| Example F-32 | 41 | F-19 | 1.0 | (1) | 100 | 50 | 20 | 15000 | 50 | 5 |
| Example F-33 | 42 | F-19 | 1.0 | (1) | 150 | 50 | 25 | 15000 | 50 | 5 |
| Example F-34 | 43 | F-19 | 1.0 | (1) | 200 | 50 | 25 | 14000 | 50 | 5 |
| Comparative | 44 | — | 0.0 | — | 0.0 | 100 | 20 | 20000 | 5 | 5 |
| Example F-10 | | | | | | | | | | |
| Comparative | 45 | F-12 | 60.0 | (1) | 0.0 | 40 | 100 | 1000 | 50 | 9 |
| Example F-11 | | | | | | | | | | |
| Comparative | 46 | F-12 | 1.0 | (1) | 220 | 35 | 30 | 2000 | 50 | 5 |
| Example F-12 | | | | | | | | | | |
| Comparative | 47 | F-19 | 60.0 | (1) | 0.0 | 140 | 100 | 1000 | 55 | 11 |
| Example F-13 | | | | | | | | | | |
| Comparative | 48 | F-19 | 1.0 | (1) | 220 | 90 | 30 | 2000 | 50 | 5 |
| Example F-14 | | | | | | | | | | |
| Comparative | 49 | — | 0/0 | (1) | 100 | 80 | 25 | 2000 | 15 | 5 |
| Example F-15 | | | | | | | | | | |

TABLE 20

| | Direct-writing | Fluorine-based | | Hydrophilic | | | | | | |
|---|---|---|---|---|---|---|---|---|---|---|
| | planographic | compound | | resin | | Dot | Number of | | Contact angle | |
| | printing plate | | Coating | | Coating | diameter | stained | Printing | Ink drops | Water |
| | precursor | Compound | weight | Compound | weight | (μm) | sheets | durability | in air | drops in air |
| Example G-17 | 26 | F-12 | 1.0 | (1) | 1.0 | 35 | 10 | 40000 | 50 | 5 |
| Example G-18 | 27 | F-12 | 4.0 | (1) | 6.0 | 30 | 10 | 35000 | 55 | 5 |
| Example G-19 | 28 | F-12 | 1.0 | (1) | 50.0 | 30 | 20 | 30000 | 55 | 5 |
| Example G-20 | 29 | F-12 | 50.0 | (1) | 1.0 | 35 | 30 | 25000 | 50 | 5 |
| Example G-21 | 30 | F-12 | 50.0 | (1) | 50.0 | 35 | 30 | 30000 | 50 | 5 |
| Example G-22 | 31 | F-19 | 1.0 | (1) | 1.0 | 40 | 10 | 45000 | 45 | 5 |
| Example G-23 | 32 | F-19 | 4.0 | (1) | 6.0 | 35 | 10 | 35000 | 50 | 5 |
| Example G-24 | 33 | F-19 | 1.0 | (1) | 50.0 | 35 | 15 | 30000 | 50 | 5 |
| Example G-25 | 34 | F-19 | 50.0 | (1) | 1.0 | 40 | 25 | 25000 | 45 | 5 |
| Example G-26 | 35 | F-19 | 50.0 | (1) | 50.0 | 40 | 25 | 25000 | 45 | 5 |
| Example G-27 | 36 | F-12 | 0.2 | (1) | 100 | 35 | 20 | 30000 | 50 | 5 |
| Example G-28 | 37 | F-12 | 1.0 | (1) | 100 | 30 | 20 | 30000 | 55 | 5 |
| Example G-29 | 38 | F-12 | 1.0 | (1) | 150 | 30 | 20 | 30000 | 55 | 5 |
| Example G-30 | 39 | F-12 | 1.0 | (1) | 200 | 30 | 25 | 25000 | 55 | 5 |
| Example G-31 | 40 | F-19 | 0.2 | (1) | 100 | 35 | 20 | 30000 | 45 | 5 |
| Example G-32 | 41 | F-19 | 1.0 | (1) | 100 | 35 | 20 | 30000 | 50 | 5 |
| Example G-33 | 42 | F-19 | 1.0 | (1) | 150 | 35 | 25 | 30000 | 50 | 5 |
| Example G-34 | 43 | F-19 | 1.0 | (1) | 200 | 35 | 25 | 25000 | 50 | 5 |
| Comparative | 44 | — | 0.0 | — | 0.0 | 120 | 20 | 50000 | 10 | 5 |
| Example G-10 | | | | | | | | | | |
| Comparative | 45 | F-12 | 60.0 | (1) | 0.0 | 50 | 100 | 5000 | 40 | 9 |
| Example G-11 | | | | | | | | | | |
| Comparative | 46 | F-12 | 1.0 | (1) | 220 | 35 | 30 | 5000 | 55 | 5 |
| Example G-12 | | | | | | | | | | |
| Comparative | 47 | F-19 | 60.0 | (1) | 0.0 | 50 | 100 | 5000 | 40 | 11 |
| Example G-13 | | | | | | | | | | |
| Comparative | 48 | F-19 | 1.0 | (1) | 220 | 45 | 30 | 5000 | 55 | 5 |
| Example G-14 | | | | | | | | | | |
| Comparative | 49 | — | 0/0 | (1) | 100 | 110 | 2 | 40000 | 10 | 5 |
| Example G-15 | | | | | | | | | | |

TABLE 21

| | Direct-writing | Fluorine-based | | | | | | | | |
|---|---|---|---|---|---|---|---|---|---|---|
| | planographic | compound | | Hydrophilic resin | | | Number of | | Contact angle | |
| | printing plate | | Coating | | Coating | Dot diameter | stained | Printing | Ink drops | Water |
| | precursor | Compound | weight | Compound | weight | (μm) | sheets | durability | in air | drops in air |
| Example H-17 | 26 | F-12 | 1.0 | (1) | 1.0 | 35 | 10 | 40000 | 55 | 5 |
| Example H-18 | 27 | F-12 | 4.0 | (1) | 6.0 | 30 | 10 | 35000 | 60 | 5 |
| Example H-19 | 28 | F-12 | 1.0 | (1) | 50.0 | 30 | 20 | 30000 | 60 | 5 |
| Example H-20 | 29 | F-12 | 50.0 | (1) | 1.0 | 35 | 30 | 25000 | 55 | 5 |
| Example H-21 | 30 | F-12 | 50.0 | (1) | 50.0 | 35 | 30 | 30000 | 55 | 5 |
| Example H-22 | 31 | F-19 | 1.0 | (1) | 1.0 | 40 | 10 | 45000 | 50 | 5 |
| Example H-23 | 32 | F-19 | 4.0 | (1) | 6.0 | 35 | 10 | 35000 | 55 | 5 |
| Example H-24 | 33 | F-19 | 1.0 | (1) | 50.0 | 35 | 15 | 30000 | 55 | 5 |
| Example H-25 | 34 | F-19 | 50.0 | (1) | 1.0 | 40 | 25 | 25000 | 50 | 5 |
| Example H-26 | 35 | F-19 | 50.0 | (1) | 50.0 | 40 | 25 | 25000 | 50 | 5 |
| Example H-27 | 36 | F-12 | 0.2 | (1) | 100 | 35 | 20 | 30000 | 55 | 5 |
| Example H-28 | 37 | F-12 | 1.0 | (1) | 100 | 30 | 20 | 30000 | 60 | 5 |
| Example H-29 | 38 | F-12 | 1.0 | (1) | 150 | 30 | 20 | 30000 | 60 | 5 |
| Example H-30 | 39 | F-12 | 1.0 | (1) | 200 | 30 | 25 | 25000 | 60 | 5 |
| Example H-31 | 40 | F-19 | 0.2 | (1) | 100 | 40 | 20 | 30000 | 50 | 5 |
| Example H-32 | 41 | F-19 | 1.0 | (1) | 100 | 35 | 20 | 30000 | 55 | 5 |
| Example H-33 | 42 | F-19 | 1.0 | (1) | 150 | 35 | 25 | 30000 | 55 | 5 |
| Example H-34 | 43 | F-19 | 1.0 | (1) | 200 | 35 | 25 | 25000 | 55 | 5 |
| Comparative | 44 | — | 0.0 | — | 0.0 | 110 | 20 | 40000 | 12 | 5 |
| Example H-10 | | | | | | | | | | |
| Comparative | 45 | F-12 | 60.0 | (1) | 0.0 | 45 | 100 | 3000 | 40 | 9 |
| Example H-11 | | | | | | | | | | |
| Comparative | 46 | F-12 | 1.0 | (1) | 220 | 30 | 30 | 3000 | 55 | 5 |
| Example H-12 | | | | | | | | | | |
| Comparative | 47 | F-19 | 60.0 | (1) | 0.0 | 45 | 100 | 3000 | 40 | 11 |
| Example H-13 | | | | | | | | | | |
| Comparative | 48 | F-19 | 1.0 | (1) | 220 | 40 | 30 | 3000 | 55 | 5 |
| Example H-14 | | | | | | | | | | |
| Comparative | 49 | — | 0/0 | (1) | 100 | 100 | 25 | 30000 | 10 | 5 |
| Example H-15 | | | | | | | | | | |

The results of the evaluations of the planographic printing plates produced by forming an image area on the direct-writing planographic printing plate precursors 42 to 52 using the ink compositions are shown below.

TABLE 22

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops | drops in |
| | precursor | compound | weight | (μm) | sheets | durability | in air | air |
| Example A-35 | 50 | F-12 | 1.0 | 30 | 10 | 25000 | 55 | 3 |
| Example A-36 | 51 | F-12 | 4.0 | 28 | 15 | 20000 | 60 | 3 |
| Example A-37 | 52 | F-12 | 10.0 | 25 | 20 | 20000 | 55 | 4 |
| Example A-38 | 53 | F-12 | 50.0 | 30 | 25 | 12000 | 45 | 5 |
| Example A-39 | 54 | F-19 | 1.0 | 35 | 10 | 30000 | 45 | 3 |
| Example A-40 | 55 | F-19 | 4.0 | 30 | 15 | 20000 | 55 | 3 |
| Example A-41 | 56 | F-19 | 10.0 | 30 | 25 | 15000 | 65 | 4 |
| Example A-42 | 57 | F-19 | 50.0 | 40 | 25 | 10000 | 60 | 5 |
| Comparative | 58 | — | — | 100 | 10 | 30000 | 10 | 2 |
| Example A-16 | | | | | | | | |
| Comparative | 59 | F-12 | 60.0 | 50 | 25 | 500 | 45 | 5 |
| Example A-17 | | | | | | | | |
| Comparative | 60 | F-19 | 60.0 | 50 | 25 | 500 | 50 | 5 |
| Example A-18 | | | | | | | | |

TABLE 23

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops | drops in |
| | precursor | compound | weight | (μm) | sheets | durability | in air | air |
| Example B-35 | 50 | F-12 | 1.0 | 35 | 10 | 20000 | 55 | 3 |
| Example B-36 | 51 | F-12 | 4.0 | 30 | 15 | 20000 | 60 | 3 |
| Example B-37 | 52 | F-12 | 10.0 | 28 | 20 | 15000 | 55 | 4 |
| Example B-38 | 53 | F-12 | 50.0 | 30 | 25 | 10000 | 45 | 5 |
| Example B-39 | 54 | F-19 | 1.0 | 35 | 10 | 25000 | 45 | 3 |
| Example B-40 | 55 | F-19 | 4.0 | 35 | 15 | 20000 | 55 | 3 |
| Example B-41 | 56 | F-19 | 10.0 | 30 | 25 | 10000 | 65 | 4 |
| Example B-42 | 57 | F-19 | 50.0 | 35 | 25 | 8000 | 60 | 5 |
| Comparative | 58 | — | — | 100 | 10 | 20000 | 10 | 2 |
| Example B-16 | | | | | | | | |
| Comparative | 59 | F-12 | 60.0 | 50 | 25 | 500 | 45 | 5 |
| Example B-17 | | | | | | | | |
| Comparative | 60 | F-19 | 60.0 | 50 | 25 | 500 | 50 | 5 |
| Example B-18 | | | | | | | | |

TABLE 24

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops | drops in |
| | precursor | compound | weight | (μm) | sheets | durability | in air | air |
| Example C-35 | 50 | F-12 | 1.0 | 35 | 10 | 15000 | 50 | 3 |
| Example C-36 | 51 | F-12 | 4.0 | 30 | 15 | 15000 | 55 | 3 |
| Example C-37 | 52 | F-12 | 10.0 | 28 | 20 | 13000 | 50 | 4 |
| Example C-38 | 53 | F-12 | 50.0 | 30 | 25 | 8000 | 40 | 5 |
| Example C-39 | 54 | F-19 | 1.0 | 35 | 10 | 20000 | 40 | 3 |
| Example C-40 | 55 | F-19 | 4.0 | 30 | 15 | 20000 | 50 | 3 |
| Example C-41 | 56 | F-19 | 10.0 | 28 | 25 | 10000 | 60 | 4 |
| Example C-42 | 57 | F-19 | 50.0 | 40 | 25 | 8000 | 55 | 5 |
| Comparative | 58 | — | — | 90 | 10 | 15000 | 8 | 2 |
| Example C-16 | | | | | | | | |
| Comparative | 59 | F-12 | 60.0 | 45 | 25 | 500 | 40 | 5 |
| Example C-17 | | | | | | | | |
| Comparative | 60 | F-19 | 60.0 | 45 | 25 | 500 | 45 | 5 |
| Example C-18 | | | | | | | | |

TABLE 25

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops | drops in |
| | precursor | compound | weight | (μm) | sheets | durability | in air | air |
| Example D-35 | 50 | F-12 | 1.0 | 35 | 10 | 15000 | 60 | 3 |
| Example D-36 | 51 | F-12 | 4.0 | 30 | 15 | 10000 | 65 | 3 |
| Example D-37 | 52 | F-12 | 10.0 | 28 | 20 | 10000 | 60 | 4 |
| Example D-38 | 53 | F-12 | 50.0 | 30 | 25 | 7000 | 50 | 5 |
| Example D-39 | 54 | F-19 | 1.0 | 35 | 10 | 16000 | 50 | 3 |
| Example D-40 | 55 | F-19 | 4.0 | 30 | 15 | 12000 | 60 | 3 |
| Example D-41 | 56 | F-19 | 10.0 | 28 | 25 | 11000 | 70 | 4 |
| Example D-42 | 57 | F-19 | 50.0 | 40 | 25 | 8000 | 65 | 5 |
| Comparative | 50 | — | — | 90 | 10 | 20000 | 15 | 2 |
| Example D-16 | | | | | | | | |
| Comparative | 51 | F-12 | 60.0 | 45 | 25 | 300 | 50 | 5 |
| Example D-17 | | | | | | | | |
| Comparative | 52 | F-19 | 60.0 | 45 | 25 | 300 | 55 | 5 |
| Example D-18 | | | | | | | | |

TABLE 26

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops in | drops in |
| | precursor | compound | weight | (μm) | sheets | durability | air | air |
| Example E-35 | 50 | F-12 | 1.0 | 35 | 10 | 20000 | 50 | 3 |
| Example E-36 | 51 | F-12 | 4.0 | 30 | 15 | 15000 | 55 | 3 |
| Example E-37 | 52 | F-12 | 10.0 | 30 | 20 | 15000 | 50 | 4 |
| Example E-38 | 53 | F-12 | 50.0 | 35 | 25 | 7000 | 40 | 5 |
| Example E-39 | 54 | F-19 | 1.0 | 40 | 10 | 14000 | 40 | 3 |
| Example E-40 | 55 | F-19 | 4.0 | 35 | 15 | 12000 | 50 | 3 |
| Example E-41 | 56 | F-19 | 10.0 | 35 | 25 | 11000 | 60 | 4 |
| Example E-42 | 57 | F-19 | 50.0 | 45 | 25 | 8000 | 55 | 5 |
| Comparative | 50 | — | — | 105 | 10 | 20000 | 8 | 2 |
| Example E-16 | | | | | | | | |
| Comparative | 51 | F-12 | 60.0 | 55 | 25 | 300 | 40 | 5 |
| Example E-17 | | | | | | | | |
| Comparative | 52 | F-19 | 60.0 | 55 | 25 | 300 | 45 | 5 |
| Example E-18 | | | | | | | | |

TABLE 27

| | Direct-writing | | | | Number | | Contact angle | |
|---|---|---|---|---|---|---|---|---|
| | planographic | Fluorine- | | Dot | of | | Ink | Water |
| | printing plate | based | Coating | diameter | stained | Printing | drops in | drops in |
| | precursor | compound | weight | (μm) | sheets | durability | air | air |
| Example F-35 | 50 | F-12 | 1.0 | 35 | 10 | 20000 | 50 | 3 |
| Example F-36 | 51 | F-12 | 4.0 | 30 | 15 | 15000 | 55 | 3 |
| Example F-37 | 52 | F-12 | 10.0 | 28 | 20 | 15000 | 50 | 4 |
| Example F-38 | 53 | F-12 | 50.0 | 30 | 25 | 7000 | 40 | 5 |
| Example F-39 | 54 | F-19 | 1.0 | 35 | 10 | 14000 | 40 | 3 |
| Example F-40 | 55 | F-19 | 4.0 | 30 | 15 | 12000 | 50 | 3 |
| Example F-41 | 56 | F-19 | 10.0 | 28 | 25 | 11000 | 60 | 4 |
| Example F-39 | 57 | F-19 | 50.0 | 40 | 25 | 8000 | 55 | 5 |
| Comparative | 50 | — | — | 90 | 10 | 20000 | 8 | 2 |
| Example F-16 | | | | | | | | |
| Comparative | 51 | F-12 | 60.0 | 45 | 25 | 300 | 40 | 5 |
| Example F-17 | | | | | | | | |
| Comparative | 52 | F-19 | 60.0 | 45 | 25 | 300 | 45 | 5 |
| Example F-18 | | | | | | | | |

The results of the evaluations of the planographic printing plates prepared by forming an image area on the direct-writing planographic printing plate precursors 61 to 68 using the ink compositions are shown in Table 28 to Table 33.

TABLE 28

| | Direct-writing | Fluorine-based | | Hydrophilic | | | | | | |
|---|---|---|---|---|---|---|---|---|---|---|
| | planographic | compound | | resin | | Dot | Number | | Contact angle | |
| | printing plate | | Coating | | Coating | diameter | of stained | Printing | Ink drops | Water |
| | precursor | Compound | weight | Compound | weight | (μm) | sheets | durability | in air | drops in air |
| Example A-43 | 61 | F-12 | 1.0 | (1) | 1.0 | 30 | 10 | 25000 | 60 | 3 |
| Example A-44 | 62 | F-12 | 4.0 | (1) | 6.0 | 25 | 10 | 15000 | 85 | 3 |
| Example A-45 | 63 | F-12 | 1.0 | (1) | 50.0 | 40 | 10 | 10000 | 30 | 2 |
| Example A-46 | 64 | F-12 | 50.0 | (1) | 1.0 | 45 | 40 | 10000 | 45 | 5 |
| Example A-47 | 65 | F-12 | 50.0 | (1) | 50.0 | 40 | 20 | 8000 | 40 | 3 |
| Comparative | 66 | — | 0.0 | — | 0.0 | 100 | 10 | 30000 | 10 | 2 |
| Example A-19 | | | | | | | | | | |
| Comparative | 67 | F-12 | 60.0 | (1) | 0.0 | 50 | 25 | 500 | 45 | 5 |
| Example A-20 | | | | | | | | | | |
| Comparative | 68 | F-12 | 60.0 | (1) | 60.0 | 150 | 30 | 500 | 20 | 6 |
| Example A-21 | | | | | | | | | | |

TABLE 29

| | Direct-writing | Fluorine-based | | Hydrophilic | | | | | Contact angle | |
|---|---|---|---|---|---|---|---|---|---|---|
| | planographic | compound | | resin | | Dot | Number of | | Ink | Water |
| | printing plate | | Coating | | Coating | diameter | stained | Printing | drops in | drops |
| | precursor | Compound | weight | Compound | weight | (μm) | sheets | durability | air | in air |
| Example B-43 | 61 | F-12 | 1.0 | (1) | 1.0 | 35 | 10 | 15000 | 55 | 3 |
| Example B-44 | 62 | F-12 | 4.0 | (1) | 6.0 | 30 | 10 | 12000 | 85 | 3 |
| Example B-45 | 63 | F-12 | 1.0 | (1) | 50.0 | 45 | 10 | 10000 | 30 | 2 |
| Example B-46 | 64 | F-12 | 50.0 | (1) | 1.0 | 45 | 40 | 8000 | 45 | 5 |
| Example B-47 | 65 | F-12 | 50.0 | (1) | 50.0 | 50 | 20 | 6000 | 40 | 3 |
| Comparative | 66 | — | 0.0 | — | 0.0 | 100 | 10 | 17000 | 10 | 2 |
| Example B-19 | | | | | | | | | | |
| Comparative | 67 | F-12 | 60.0 | (1) | 0.0 | 50 | 25 | 500 | 45 | 5 |
| Example B-20 | | | | | | | | | | |
| Comparative | 68 | F-12 | 60.0 | (1) | 60.0 | 150 | 30 | 500 | 20 | 6 |
| Example B-21 | | | | | | | | | | |

TABLE 30

| | Direct-writing | Fluorine-based | | | | | | | Contact angle | |
|---|---|---|---|---|---|---|---|---|---|---|
| | planographic | compound | | Hydrophilic resin | | Dot | Number of | | Ink | Water |
| | printing plate | | Coating | | Coating | diameter | stained | Printing | drops | drops |
| | precursor | Compound | weight | Compound | weight | (μm) | sheets | durability | in air | in air |
| Example C-43 | 61 | F-12 | 1.0 | (1) | 1.0 | 30 | 10 | 15000 | 50 | 3 |
| Example C-44 | 62 | F-12 | 4.0 | (1) | 6.0 | 28 | 10 | 12000 | 80 | 3 |
| Example C-45 | 63 | F-12 | 1.0 | (1) | 50.0 | 40 | 10 | 10000 | 30 | 2 |
| Example C-46 | 64 | F-12 | 50.0 | (1) | 1.0 | 40 | 40 | 8000 | 40 | 5 |
| Example C-47 | 65 | F-12 | 50.0 | (1) | 50.0 | 45 | 20 | 6000 | 35 | 3 |
| Comparative | 66 | — | 0.0 | — | 0.0 | 90 | 10 | 15000 | 8 | 2 |
| Example C-19 | | | | | | | | | | |
| Comparative | 67 | F-12 | 60.0 | (1) | 0.0 | 45 | 25 | 500 | 40 | 5 |
| Example C-20 | | | | | | | | | | |
| Comparative | 68 | F-12 | 60.0 | (1) | 60.0 | 130 | 30 | 500 | 15 | 6 |
| Example C-21 | | | | | | | | | | |

TABLE 31

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water |
| | precursor | Compound | Coating weight | Compound | weight | (μm) | sheets | durability | in air | drops in air |
| Example D-43 | 61 | F-12 | 1.0 | (1) | 1.0 | 30 | 10 | 15000 | 60 | 3 |
| Example D-44 | 62 | F-12 | 4.0 | (1) | 6.0 | 28 | 10 | 10000 | 90 | 3 |
| Example D-45 | 63 | F-12 | 1.0 | (1) | 50.0 | 40 | 10 | 7000 | 35 | 2 |
| Example D-46 | 64 | F-12 | 50.0 | (1) | 1.0 | 40 | 40 | 7000 | 50 | 5 |
| Example D-47 | 65 | F-12 | 50.0 | (1) | 50.0 | 45 | 20 | 5000 | 45 | 3 |
| Comparative | 66 | — | 0.0 | — | 0.0 | 90 | 10 | 15000 | 15 | 2 |
| Example D-19 | | | | | | | | | | |
| Comparative | 67 | F-12 | 60.0 | (1) | 0.0 | 45 | 25 | 300 | 50 | 5 |
| Example D-20 | | | | | | | | | | |
| Comparative | 68 | F-12 | 60.0 | (1) | 60.0 | 130 | 30 | 100 | 25 | 6 |
| Example D-21 | | | | | | | | | | |

TABLE 32

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example E-43 | 61 | F-12 | 1.0 | (1) | 1.0 | 35 | 10 | 20000 | 55 | 3 |
| Example E-44 | 62 | F-12 | 4.0 | (1) | 6.0 | 30 | 10 | 15000 | 80 | 3 |
| Example E-45 | 63 | F-12 | 1.0 | (1) | 50.0 | 45 | 10 | 7000 | 30 | 2 |
| Example E-46 | 64 | F-12 | 50.0 | (1) | 1.0 | 50 | 40 | 7000 | 40 | 5 |
| Example E-47 | 65 | F-12 | 50.0 | (1) | 50.0 | 45 | 20 | 5000 | 35 | 3 |
| Comparative | 66 | — | 0.0 | — | 0.0 | 105 | 10 | 20000 | 8 | 2 |
| Example E-19 | | | | | | | | | | |
| Comparative | 67 | F-12 | 60.0 | (1) | 0.0 | 55 | 25 | 300 | 40 | 5 |
| Example E-20 | | | | | | | | | | |
| Comparative | 68 | F-12 | 60.0 | (1) | 60.0 | 150 | 30 | 100 | 10 | 6 |
| Example E-21 | | | | | | | | | | |

TABLE 33

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example F-43 | 61 | F-12 | 1.0 | (1) | 1.0 | 30 | 10 | 20000 | 50 | 3 |
| Example F-44 | 62 | F-12 | 4.0 | (1) | 6.0 | 28 | 10 | 15000 | 80 | 3 |
| Example F-45 | 63 | F-12 | 1.0 | (1) | 50.0 | 40 | 10 | 7000 | 30 | 2 |
| Example F-46 | 64 | F-12 | 50.0 | (1) | 1.0 | 40 | 40 | 7000 | 40 | 5 |
| Example F-47 | 65 | F-12 | 50.0 | (1) | 50.0 | 45 | 20 | 5000 | 35 | 3 |
| Comparative | 66 | F-12 | 0.0 | — | 0.0 | 35 | 10 | 20000 | 8 | 2 |
| Example F-19 | | | | | | | | | | |
| Comparative | 67 | F-12 | 60.0 | (1) | 0.0 | 45 | 25 | 300 | 40 | 5 |
| Example F-20 | | | | | | | | | | |
| Comparative | 68 | F-12 | 60.0 | (1) | 60.0 | 130 | 30 | 100 | 15 | 6 |
| Example F-21 | | | | | | | | | | |

The evaluation results for the planographic printing plates formed thereon with an image area by applying the ink compositions to the direct-writing planographic printing plate precursors 69 to 76 are shown in Table 34 to Table 39.

TABLE 34

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example A-48 | 69 | F-12 | 1.0 | (1) | 6.0 | 30 | 10 | 15000 | 60 | 3 |
| Example A-49 | 70 | F-12 | 4.0 | (1) | 6.0 | 25 | 10 | 12000 | 85 | 3 |
| Example A-50 | 71 | F-12 | 10.0 | (1) | 6.0 | 40 | 10 | 8000 | 30 | 2 |
| Example A-51 | 72 | F-12 | 50.0 | (1) | 6.0 | 45 | 40 | 8000 | 45 | 5 |
| Example A-52 | 73 | F-12 | 0.0 | (1) | 6.0 | 40 | 20 | 6000 | 40 | 3 |
| Comparative | 74 | F-12 | 60.0 | (1) | 0.0 | 100 | 10 | 15000 | 10 | 2 |
| Example A-22 | | | | | | | | | | |
| Comparative | 75 | F-12 | 0.0 | (1) | 55.0 | 50 | 25 | 200 | 45 | 5 |
| Example A-23 | | | | | | | | | | |
| Comparative | 76 | F-12 | 30.0 | (1) | 30.0 | 150 | 30 | 100 | 20 | 6 |
| Example A-24 | | | | | | | | | | |

TABLE 35

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example B-48 | 69 | F-12 | 1.0 | (1) | 6.0 | 35 | 10 | 13000 | 55 | 3 |
| Example B-49 | 70 | F-12 | 4.0 | (1) | 6.0 | 30 | 10 | 10000 | 85 | 3 |
| Example B-50 | 71 | F-12 | 10.0 | (1) | 6.0 | 45 | 10 | 7000 | 30 | 2 |
| Example B-51 | 72 | F-12 | 50.0 | (1) | 6.0 | 45 | 40 | 6000 | 45 | 5 |
| Example B-52 | 73 | F-12 | 0.0 | (1) | 6.0 | 50 | 20 | 5000 | 40 | 3 |
| Comparative | 74 | F-12 | 60.0 | (1) | 0.0 | 100 | 10 | 13000 | 10 | 2 |
| Example B-22 | | | | | | | | | | |
| Comparative | 75 | F-12 | 0.0 | (1) | 55.0 | 50 | 25 | 200 | 45 | 5 |
| Example B-23 | | | | | | | | | | |
| Comparative | 76 | F-12 | 30.0 | (1) | 30.0 | 150 | 30 | 100 | 20 | 6 |
| Example B-24 | | | | | | | | | | |

TABLE 36

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example C-48 | 69 | F-12 | 1.0 | (1) | 6.0 | 30 | 10 | 10000 | 50 | 3 |
| Example C-49 | 70 | F-12 | 4.0 | (1) | 6.0 | 28 | 10 | 8000 | 80 | 3 |
| Example C-50 | 71 | F-12 | 10.0 | (1) | 6.0 | 40 | 10 | 7000 | 30 | 2 |
| Example C-51 | 72 | F-12 | 50.0 | (1) | 6.0 | 40 | 40 | 6000 | 40 | 5 |
| Example C-52 | 73 | F-12 | 0.0 | (1) | 6.0 | 45 | 20 | 5000 | 35 | 3 |
| Comparative | 74 | F-12 | 60.0 | (1) | 0.0 | 90 | 10 | 13000 | 8 | 2 |
| Example C-22 | | | | | | | | | | |
| Comparative | 75 | F-12 | 0.0 | (1) | 55.0 | 40 | 25 | 200 | 40 | 5 |
| Example C-23 | | | | | | | | | | |
| Comparative | 76 | F-12 | 30.0 | (1) | 30.0 | 130 | 30 | 100 | 15 | 6 |
| Example C-24 | | | | | | | | | | |

TABLE 37

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example D-48 | 69 | F-12 | 1.0 | (1) | 6.0 | 30 | 10 | 12000 | 60 | 3 |
| Example D-49 | 70 | F-12 | 4.0 | (1) | 6.0 | 28 | 10 | 9000 | 90 | 3 |
| Example D-50 | 71 | F-12 | 10.0 | (1) | 6.0 | 40 | 10 | 6000 | 35 | 2 |
| Example D-51 | 72 | F-12 | 50.0 | (1) | 6.0 | 40 | 40 | 6000 | 50 | 5 |
| Example D-52 | 73 | F-12 | 0.0 | (1) | 6.0 | 45 | 20 | 5000 | 45 | 3 |
| Comparative | 74 | F-12 | 60.0 | (1) | 0.0 | 90 | 10 | 13000 | 15 | 2 |
| Example D-22 | | | | | | | | | | |
| Comparative | 75 | F-12 | 0.0 | (1) | 55.0 | 40 | 25 | 100 | 50 | 5 |
| Example D-23 | | | | | | | | | | |
| Comparative | 76 | F-12 | 30.0 | (1) | 30.0 | 130 | 30 | 0 | 25 | 6 |
| Example D-24 | | | | | | | | | | |

TABLE 38

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example E-48 | 69 | F-12 | 1.0 | (1) | 6.0 | 35 | 10 | 15000 | 55 | 3 |
| Example E-49 | 70 | F-12 | 4.0 | (1) | 6.0 | 30 | 10 | 10000 | 80 | 3 |
| Example E-50 | 71 | F-12 | 10.0 | (1) | 6.0 | 45 | 10 | 7000 | 30 | 2 |
| Example E-51 | 72 | F-12 | 50.0 | (1) | 6.0 | 50 | 40 | 7000 | 40 | 5 |
| Example E-52 | 73 | F-12 | 0.0 | (1) | 6.0 | 45 | 20 | 5000 | 35 | 3 |
| Comparative | 74 | F-12 | 60.0 | (1) | 0.0 | 105 | 10 | 15000 | 8 | 2 |
| Example E-22 | | | | | | | | | | |
| Comparative | 75 | — | 0.0 | (1) | 55.0 | 55 | 25 | 100 | 40 | 5 |
| Example E-23 | | | | | | | | | | |
| Comparative | 76 | F-12 | 30.0 | (1) | 30.0 | 150 | 30 | 0 | 10 | 6 |
| Example E-24 | | | | | | | | | | |

TABLE 39

| | Direct-writing | | | | | | | | | |
|---|---|---|---|---|---|---|---|---|---|---|
| | planographic | | | Hydrophilic resin | | Dot | Number of | | Contact angle | |
| | printing plate | Fluorine-based compound | | | Coating | diameter | stained | Printing | Ink drops | Water drops |
| | precursor | Compound | Coating weight | Compound | weight | (μm) | sheets | durability | in air | in air |
| Example F-48 | 69 | F-12 | 1.0 | (1) | 6.0 | 30 | 10 | 15000 | 50 | 3 |
| Example F-49 | 70 | F-12 | 4.0 | (1) | 6.0 | 28 | 10 | 10000 | 80 | 3 |
| Example F-50 | 71 | F-12 | 10.0 | (1) | 6.0 | 40 | 10 | 7000 | 30 | 2 |
| Example F-51 | 72 | F-12 | 50.0 | (1) | 6.0 | 40 | 40 | 7000 | 40 | 5 |
| Example F-52 | 73 | F-12 | 0.0 | (1) | 6.0 | 45 | 20 | 5000 | 35 | 3 |
| Comparative | 74 | F-12 | 60.0 | (1) | 0.0 | 35 | 10 | 15000 | 8 | 2 |
| Example F-22 | | | | | | | | | | |
| Comparative | 75 | — | 0.0 | (1) | 55.0 | 40 | 25 | 100 | 40 | 5 |
| Example F-23 | | | | | | | | | | |
| Comparative | 76 | F-12 | 30.0 | (1) | 30.0 | 130 | 30 | 0 | 15 | 6 |
| Example F-24 | | | | | | | | | | |

The results listed in the tables above show that the direct-writing planographic printing plate precursors (supports) according to the invention can achieve excellent surface ink repellency and surface hydrophilicity in the hydrophobic image area formed using any ink prepared by cation polymerization, UV curing, water dispersion, polymerization granulation or polymer dissolution, and that the direct-writing planographic printing plates obtained using the planographic printing plate precursors can form more fine images, and have higher ink resistance of the non-image area and printing durability than Comparative Examples.

### II. Examples I to P

(Aluminum Plate)

An aluminum alloy comprising 0.06% by mass of Si, 0.30% by mass of Fe, 0.005% by mass of Cu, 0.001% by mass of Mn, 0.001% by mass of Mg, 0.001% by mass of Zn and 0.03% by mass of Ti, with the balance made of Al and inevitable impurities, was used to prepare a molten metal. The molten metal was filtrated, and then an ingot having a thickness of 500 mm and a width of 1200 mm was produced by DC casting.

Its surface was shaved by a thickness of 10 mm on average with a surface-shaving machine, and then the ingot was kept at 550° C. for about 5 hours. When the temperature thereof lowered to 400° C., a hot rolling machine was used to produce a rolled plate having a thickness of 2.7 mm. Furthermore, a continuous annealing machine was used to thermally treat the plate thermally at 500° C. Thereafter, the plate was finished by cold rolling so as to have a thickness of 0.24 mm. In this way, an aluminum plate in accordance with JIS 1050 was yielded. The aluminum plates were trimed in a width of 1030 mm and were subjected to the following surface treatments.

<Surface Treatment>

(Surface Treament 1)

Surface treatment was performed by continuously conducting following treatments (b) to (j). Liquid was cleared away using a nip roller after each treatment and water washing.

(b) Alkali Etching Treatment

The aluminum plate obtained above was etched by spraying with an aqueous solution having a caustic soda concentration of 2.6% by mass and an aluminum ion concentration of 6.5% by mass at a temperature of 70° C. to dissolve away a surface layer of the aluminum plate in an amount of 6 g/m². Thereafter, the aluminum plate was washed with water by spraying.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with sprayed water. The aqueous nitric acid solution used in the desmutting treatment was waste liquid from a process of conducting electrochemical surface-roughening treatment using alternating current in an aqueous nitric acid solution.

(d) Electrochemical Surface-Roughening Treatment

A 60 Hz AC voltage was used to continuously conduct an electrochemical surface-roughening treatment. The electrolytic solution used was a 10.5 g/L aqueous nitric acid solution (containing 5 g/L of aluminum ions and 0.007% by mass of ammonium ions) having a temperature of 50° C. The AC power source used was one providing a trapezoidal rectangular wave alternating current having a waveform as shown in FIG. 2, wherein the TP, which is the time required for the current value to increase from zero to a peak, was 0.8 msec and the duty ratio was 1:1. A carbon electrode was used as a counter electrode to conduct the electrochemical surface-roughening treatment using ferrite as an auxiliary anode. The electrolytic bath as shown in FIG. 3 was used. The current density was 30 A/dm² in terms of peak value, and the electricity quantity was 220 C/dmm² in terms of the sum of electricity at the time when the aluminum plate was functioning as an anode. 5% of the current flowing from the power source was supplied to the auxiliary anode. After this surface-roughening treatment, the aluminum plate was washed with water by spraying.

(e) Alkali Etching Treatment

The aluminum plate was etched by spraying with an aqueous solution having a caustic soda concentration of 26% by mass and an aluminum ion concentration of 6.5% by mass at 32° C. to dissolve away a surface layer of the aluminum plate in an amount of 0.25 g/m². Thus, the smut ingredients consisting mainly of aluminum hydroxide generated by the preceding step of electrochemical surface roughening with an alternating current were removed and, simultaneously therewith, the edges of the formed pits were dissolved away and rounded to be smooth. Thereafter, the aluminum plate was washed with water by spraying.

(f) Desmutting Treatment

The aluminum plate was subjected to desmut treatment with a 30 □C aqueous solution having a nitric acid concentration of 15% by mass (and containing 4.5% by mass of aluminum ions), which solution was sprayed. The aluminum plate was then washed with sprayed water. The aqueous nitric acid solution used in the desmut treatment was waste liquid from the process of conducting the electrochemical surface-roughening treatment using the alternating current in the aqueous nitric acid solution.

(g) Electrochemical Surface-Roughening Treatment

A 60 Hz AC voltage was used to continuously conduct an electrochemical surface-roughening treatment. The electrolytic solution used was a 7.5 g/L aqueous chloric acid solution (containing 5 g/L of aluminum ions) having a temperature of 35° C. The AC power source used was one providing a trapezoidal rectangular wave alternating current having a waveform as shown in FIG. 2, wherein the TP, which is the time required for the current value to increase from zero to a peak, was 0.8 msec and the duty ratio was 1:1. A carbon electrode was used as a counter electrode to conduct the electrochemical surface-roughening treatment using ferrite as an auxiliary anode. The electrolytic bath as shown in FIG. 3 was used. The current density was 25 A/dm² in terms of peak value, and the electricity quantity was 50 C/dmm² in terms of the sum of electricity at the time when the aluminum plate was functioning as an anode. After this surface-roughening treatment, the aluminum plate was washed with water by spraying.

(h) Alkali Etching Treatment

The aluminum plate was etched by spraying with an aqueous solution having a caustic soda concentration of 26% by mass and an aluminum ion concentration of 6.5% by mass at 32° C. to dissolve away a surface layer of the aluminum plate in an amount of 0.10 g/m². Thus, the smut ingredients consisting mainly of aluminum hydroxide generated by the preceding step of electrochemical surface roughening with an alternating current were removed and, simultaneously therewith, the edges of the formed pits were dissolved away and rounded to be smooth. Thereafter, the aluminum plate was washed with water by spraying.

(i) Desmutting Treatment

The aluminum plate was subjected to a desmutting treatment by spraying with an aqueous solution having a sulfuric acid concentration of 25% by mass (containing 0.5% by mass aluminum ions) and a temperature of 60° C. Thereafter, the aluminum plate was washed with water by spraying.

(j) Anodic Oxidation Treatment

An anodic oxidation device having the structure illustrated in FIG. 4 was used to conduct anodic oxidation treatment to yield a planographic printing plate precursor support of Example I-1. The electrolytes supplied into first and second electrolyzing sections were each sulfuric acid. The electrolytes were each an electrolyte having a sulfuric acid concentration of 170 g/L (and containing 0.5% by mass of aluminum ions), and the temperature thereof was 38° C. Thereafter, the support was washed with sprayed water. The final amount of the oxidation film was 2.7 g/m2.

(Surface Treatments 2 and 3)

The planographic printing plate supports subjected to surface treatments 2 and 3 were obtained in the same manner as described in surface treatment 1, except that the etching amount of the aluminum plate was changed to 0.2 g/m² and 0.5 g/m², respectively, in the procedure (h).

(Surface Treatment 4)

The planographic printing plate support subjected to surface treatment 4 was obtained in the same manner as described in surface treatment 1, except that the frequency of an alternating current was changed to 30 Hz in the procedure (g), and the procedure (h) was not carried out.

(Surface Treatments 5 and 6)

The planographic printing plate supports subjected to surface treatments 5 and 6 were obtained in the same manner as described in surface treatment 1, except that the frequency of an alternating current was changed to 300 Hz and 500 Hz, respectively, in the procedure (g).

(Surface Treatment 7)

The planographic printing plate support subjected to surface treatment 7 was obtained in the same manner as described in surface treatment 1, except that the electric current density was changed to 15 A/dm² at a peak current in the procedure (d).

(Surface treatment 8)

The planographic printing plate support subjected to surface treatment 8 was obtained in the same manner as described in surface treatment 1, except that the liquid temperature of the electrolyte was changed to 70° C. in the procedure (d).

(Surface treatment 9)

The planographic printing plate support subjected to surface treatment 9 was obtained in the same manner as described in surface treatment 1, except that the following procedure (a) was carried out before the procedure (b).

(a) Mechanical Surface-Roughening Treatment

Using a device as shown in FIG. 1, mechanical surface roughing treatment was carried out using a rotating roller-like nylon brush with supplying a suspension of an abrasive agent (pumice) having a specific gravity of 1.12 and water as an abrasive slurry solution to the surface of the aluminum plate. In FIG. 1, reference numeral 1 represents an aluminum plate, 2 and 4 each represent a roller-like brush, 3 represents an abrasive slurry solution and 5, 6, 7, and 8 each represent a support roller. The average particle diameter of the abrasive agent was 40 μm and the maximum particle diameter of the abrasive agent was 100 μm. The material of the nylon brush was 6′10 nylon wherein the hair length was 50 mm and the diameter of the hair was 0.3 mm. The bristles of the nylon brush had been densely planted in the holes opened in a stainless cylinder having a diameter of 300 mm. Three rotary brushes were used. The distance between two support rollers (diameter: 200 mm) under the brush was 300 mm. The brush roller was pressed against the aluminum plate until the load of the drive motor rotating the brush was increased to a load 7 kW higher than the load before the brush was pressed against the aluminum plate. The direction of the rotation of the brush was the same as the direction in which the aluminum plate was moved. The number of rotations of the brush was 200 rpm.

(Surface Treatment 10: Surface Treatment 1 for Comparative Example)

The planographic printing plate support subjected to surface treatment 10 was obtained in the same manner as described in surface treatment 3, except that the frequency of an alternating current was changed to 10 Hz in the procedure (g).

(Surface Treatment 11: Surface Treatment 2 for Comparative Example)

The planographic printing plate support subjected to surface treatments 11 was obtained in the same manner as described in surface treatment 1, except that the frequency of an alternating current was changed to 10 Hz in the procedure (g), and the etching amount of the aluminum plate was changed to 1.0 g/m² in the procedure (h).

(Surface Treatment 12: Surface Treatment 3 for Comparative Example)

The planographic printing plate support subjected to surface treatments 12 was obtained in the same manner as described in surface treatment 1, except that the frequency of an alternating current was changed to 15 Hz in the procedure (d).

(Surface Treatment 13: Surface Treatment 4 for Comparative Example)

The planographic printing plate support subjected to surface treatments 13 was obtained in the same manner as described in surface treatment 1, except that the liquid temperature of the electrolyte was changed to 80° C., and TP was changed to 0 msec in the procedure (d).

(Surface Treatment 14: Surface Treatment 5 for Comparative Example)

The planographic printing plate support subjected to surface treatments 14 was obtained in the same manner as described in surface treatment 8, except that the frequency of an alternating current was changed to 10 Hz in the procedure (g), and the etching amount of the aluminum plate was changed to 1.0 g/m² in the procedure (h).

(Surface Treatment 15: Surface Treatment 6 for Comparative Example)

The planographic printing plate support subjected to surface treatments 15 was obtained in the same manner as described in surface treatment 1, except that the procedures (g), (h), and (i) were not carried out.

(Surface Treatment 16: Surface Treatment 7 for Comparative Example)

The planographic printing plate support subjected to surface treatments 16 was obtained in the same manner as described in surface treatment 1, except that the procedures (d), (e), and (f) were not carried out.

(Surface Treatment 17: Surface Treatment 8 for Comparative Example)

The planographic printing plate support subjected to surface treatments 17 was obtained in the same manner as described in surface treatment 1, except that a mixed solution of hydrochloric acid and acetic acid (hydrochloric acid concentration: 7.5 g/L, acetic acid concentration: 15 g/L) was used as the electrolyte in the procedure (g).

2.Measurement of Surface Form of Planographic Printing Plate Supports

The following measurements (1) to (4) were carried out on the recesses on the surface of the planographic printing plate supports obtained above. The results are summarized in Table 38. In Table 38, “-” represents the absence of recesses of corresponding wavelength.

(1) Average Aperture Size of Medium Wave Structure

The support surface was photographed from immediately above with SEM at a magnification of 2,000 times. In the obtained SEM photograph, 50 pits of medium wave structure (medium wave pit), in which the pits were circularly connected each other at the outer edge, were extracted, and the diameter was measured as the aperture, and the average aperture was calculated.

(2) Average Aperture Size of Small Wave Structure

The support surface was photographed from immediately above with high resolution SEM at a magnification of 50,000 times. In the obtained SEM photograph, 50 pits of small wave structure (small wave pit) were extracted, and the diameter was measured as the aperture, and the average aperture was calculated.

(3) Average Ratio of the Depth to the Aperture Size of Small Wave Structure

The broken surface of a support was photographed from immediately above with high resolution SEM at a magnification of 50,000 times. In the obtained SEM photograph, 20 small wave pits with an aperture size of 0.3 μm or less were extracted, and the aperture and the depth were measured to calculate the average ratio of the depth to the aperture size of small wave structure.

(4) Average Wavelength of Large Wave Structure

Two-dimensional roughness was measured using a stylus profilemeter (Sufcom575, manufactured by Tokyo Seimitu Co., Ltd.). The average peak-to-peak distance Sm as specified in ISO4287 was measured five times, and the average was used as the average wavelength. The two-dimensional roughness measurement was carried out under following conditions: cut off: 0.8, grade correction: FLAT-ML, gauge length: 3 mm, longitudinal magnification: 10,000 times, scanning rate: 0.3 mm/sec, stylus tip diameter: 2 μm.

TABLE 40

| | Surface form of support | | | |
|---|---|---|---|---|
| | Large wave | Medium wave | Small wave | Average ratio of |
| | structure | structure | structure | depth to aperture |
| | Average | Average aperture | Average aperture | size of small |
| | wavelength (μm) | (μm) | (μm) | wave structure |
| Surface | — | 1.4 | 0.14 | 0.46 |
| treatment 1 | | | | |
| Surface | — | 1.4 | 0.16 | 0.22 |
| treatment 2 | | | | |
| Surface | — | 1.4 | 0.15 | 0.16 |
| treatment 3 | | | | |
| Surface | — | 1.4 | 0.18 | 0.22 |
| treatment 4 | | | | |
| Surface | — | 1.4 | 0.07 | 0.22 |
| treatment 5 | | | | |
| Surface | — | 1.4 | 0.03 | 0.30 |
| treatment 6 | | | | |
| Surface | — | 3.5 | 0.14 | 0.46 |
| treatment 7 | | | | |
| Surface | — | 1.0 | 0.14 | 0.46 |
| treatment 8 | | | | |
| Surface | 65 | 1.4 | 0.14 | 0.46 |
| treatment 9 | | | | |
| Surface | — | 1.4 | 0.25 | 0.20 |
| treatment 10 | | | | |
| Surface | — | 1.4 | 0.25 | 0.12 |
| treatment 11 | | | | |
| Surface | — | 5.5 | 0.14 | 0.46 |
| treatment 12 | | | | |
| Surface | — | 0.4 | 0.14 | 0.46 |
| treatment 13 | | | | |
| Surface | — | 1.0 | 0.25 | 0.12 |
| treatment 14 | | | | |
| Surface | — | 1.4 | — | — |
| treatment 15 | | | | |
| Surface | — | — | 0.14 | 0.46 |
| treatment 16 | | | | |
| Surface | — | 5.8 | 0.25 | 0.26 |
| treatment 17 | | | | |

<Formation of Hydrophilic Layer>

The planographic printing plate supports obtained above were subjected to hydrophilizing treatment.

(Hydrophilizing Treatment with Polyvinylphosphonic Acid Compound: Hydrophilic Layers 1 to 3)

The supports were dipped in aqueous solutions of polyvinylphosphonic acid at concentrations as listed in Table 41, washed with water, and dried.

(Hydrophilizing Treatment with Silicate: Hydrophilic Layers 4 to 6)

The supports were dipped in aqueous solutions of No. 3 sodium silicate at concentrations as described in Table 41, washed with water, and dried.

(Hydrophilizing Treatment with Potassium Fluorozirconate: Hydrophilic Layers 7 to 9)

The supports were dipped in aqueous solutions of potassium fluorozirconate at concentrations as listed in Table 41, washed with water, and dried.

(Hydrophilizing Treatment with Tamol: Hydrophilic Layers 10 to 12)

The supports were dipped in aqueous solutions of tamol at concentrations as listed in Table 41, washed with water, and dried.

TABLE 41

| | Hydrophilizing treatment | | | | |
|---|---|---|---|---|---|
| | | | | | Adsorbed |
| | | | Temperature | Time | amount |
| | Compound | Concentration | (° C.) | (second) | (mg/m²) |
| Hydrophilizing | Polyvinylphosphonic | 0.1% aqueous | 60 | 5 | 10 |
| treatment 1 | acid | solution 60 5 10 | | | |
| Hydrophilizing | Polyvinylphosphonic | 0.5% aqueous | 60 | 5 | 15 |
| treatment 2 | acid | solution 60 5 15 | | | |
| Hydrophilizing | Polyvinylphosphonic | 1.0% aqueous | 60 | 5 | 20 |
| treatment 3 | acid | solution 60 5 20 | | | |
| Hydrophilizing | No. 3 sodium silicate | 1.0% aqueous | 20 | 5 | 1.0 |
| treatment 4 | | solution | | | |
| Hydrophilizing | No. 3 sodium silicate | 1.0% aqueous | 20 | 13 | 3.5 |
| treatment 5 | | solution | | | |
| Hydrophilizing | No. 3 sodium silicate | 2.5% aqueous | 70 | 13 | 12.0 |
| treatment 6 | | solution | | | |
| Hydrophilizing | Potassium | 1.0% aqueous | 60 | 5 | 10 |
| treatment 7 | fluorozirconate | solution | | | |
| Hydrophilizing | Potassium | 2.5% aqueous | 60 | 5 | 15 |
| treatment 8 | fluorozirconate | solution | | | |
| Hydrophilizing | Potassium | 4.0% aqueous | 60 | 5 | 20 |
| treatment 9 | fluorozirconate | solution | | | |
| Hydrophilizing | Tamol | 1.0% aqueous | 60 | 5 | 10 |
| treatment 10 | | solution | | | |
| Hydrophilizing | Tamol | 2.5% aqueous | 60 | 5 | 15 |
| treatment 11 | | solution | | | |
| Hydrophilizing | Tamol | 4.0% aqueous | 60 | 5 | 20 |
| treatment | | solution | | | |
| 12 | | | | | |

<Formation of the Ink Receiving Layer>

Coating liquids for ink receiving layer of the compositions as listed in the following Table 42 were applied using a wire bar, and dried at 80° C. for 15 seconds to form a coating film. The coating weight of the coating film after drying was achieved by adjusting the moisture of the wire bar.

TABLE 42

| | | | | Coating | |
|---|---|---|---|---|---|
| | Fluorine | | | weight of | Coating |
| | compound | Hydrophilic | | fluorine | weight of |
| | (parts by | resin (parts by | Water (parts | compound | hydrophilic |
| | weight) | weight) | by weight) | (mg/m²) | resin (mg/m²) |
| Coating liquid | 0.14 | — | 100 | 10.0 | 0 |
| composition | | | | | |
| \textcircled{1} | | | | | |
| Coating liquid | 0.14 | 0.14 | 100 | 10.0 | 10.0 |
| composition | | | | | |
| \textcircled{2} | | | | | |
| Coating liquid | 0.14 | 0.700 | 100 | 10.0 | 50.0 |
| composition | | | | | |
| \textcircled{3} | | | | | |
| Coating liquid | 0.03 | 0.14 | 100 | 2.0 | 10.0 |
| composition | | | | | |
| \textcircled{4} | | | | | |
| Coating liquid | 0.28 | 0.14 | 100 | 20.0 | 10.0 |
| composition | | | | | |
| \textcircled{5} | | | | | |
| Coating liquid | 0.700 | 0.14 | 100 | 50.0 | 10.0 |
| composition | | | | | |
| \textcircled{6} | | | | | |
| Coating liquid | — | 0.14 | 100 | 0 | 10.0 |
| composition | | | | | |
| \textcircled{7} | | | | | |
| Coating liquid | 0.003 | 1.40 | 100 | 0.2 | 100 |
| composition | | | | | |
| \textcircled{8} | | | | | |
| Coating liquid | 0.015 | 0.70 | 100 | 1.0 | 50 |
| composition | | | | | |
| \textcircled{9} | | | | | |
| Coating liquid | 0.015 | 1.40 | 100 | 1.0 | 100 |
| composition | | | | | |
| \textcircled{10} | | | | | |
| Coating liquid | 0.015 | 2.10 | 100 | 1.0 | 150 |
| composition | | | | | |
| \textcircled{11} | | | | | |
| Coating liquid | 0.015 | 2.80 | 100 | 1.0 | 200 |
| composition | | | | | |
| \textcircled{12} | | | | | |

Fluorine compounds and hydrophilic resins used for the coating liquid compositions are summarized in the following Table 43.

TABLE 43

| | F-based compound | | Hydrophilized resin | |
|---|---|---|---|---|
| | Structural | Coating weight | Structural | Coating weight |
| | formula | (mg/m²) | formula | (mg/m²) |
| Ink receiving | F-2 | 10 | — | — |
| layer 1 | | | | |
| Ink receiving | F-4 | 10 | — | — |
| layer 2 | | | | |
| Ink receiving | F-5 | 10 | — | — |
| layer 3 | | | | |
| Ink receiving | F-9 | 10 | — | — |
| layer 4 | | | | |
| Ink receiving | F-10 | 10 | — | — |
| layer 5 | | | | |
| Ink receiving | F-11 | 10 | — | — |
| layer 6 | | | | |
| Ink receiving | F-12 | 10 | — | — |
| layer 7 | | | | |
| Ink receiving | F13 | 10 | — | — |
| layer 8 | | | | |
| Ink receiving | F-2 | 10 | (A) | 10 |
| layer 9 | | | | |
| Ink receiving | F-4 | 10 | (A) | 10 |
| layer 10 | | | | |
| Ink receiving | F-5 | 10 | (A) | 10 |
| layer 11 | | | | |
| Ink receiving | F-9 | 10 | (A) | 10 |
| layer 12 | | | | |
| Ink receiving | F-10 | 10 | (A) | 10 |
| layer 13 | | | | |
| Ink receiving | F-11 | 10 | (A) | 10 |
| layer 14 | | | | |
| Ink receiving | F12 | 10 | (A) | 10 |
| layer 15 | | | | |
| Ink receiving | F-13 | 10 | (A) | 10 |
| layer 16 | | | | |
| Ink receiving | F-12 | 10 | (B) | 10 |
| layer 17 | | | | |
| Ink receiving | F-12 | 10 | (C) | 10 |
| layer 18 | | | | |
| Ink receiving | F-12 | 2 | (A) | 10 |
| layer 19 | | | | |
| Ink receiving | F-12 | 20 | (A) | 10 |
| layer 20 | | | | |
| Ink receiving | F-12 | 50 | (A) | 10 |
| layer 21 | | | | |
| Ink receiving | F-12 | 10 | (A) | 50 |
| layer 22 | | | | |
| Ink receiving | F-12 | 50 | (A) | 50 |
| layer 23 | | | | |
| Ink receiving | — | — | (A) | 10 |
| layer 24 | | | | |
| Ink receiving | — | — | (B) | 10 |
| layer 25 | | | | |
| Ink receiving | — | — | (C) | 10 |
| layer 26 | | | | |
| Ink receiving | Si-1 | 10 | — | — |
| layer 27 | | | | |
| Ink receiving | Si-1 | 10 | (A) | 10 |
| layer 28 | | | | |
| Ink receiving | F-12 | 0.2 | (A) | 100 |
| layer 29 | | | | |
| Ink receiving | F-12 | 1.0 | (A) | 50 |
| layer 30 | | | | |
| Ink receiving | F-12 | 1.0 | (A) | 100 |
| layer 31 | | | | |
| Ink receiving | F-12 | 1.0 | (A) | 150 |
| layer 32 | | | | |
| Ink receiving | F-12 | 1.0 | (A) | 200 |
| layer 33 | | | | |
| Ink receiving | Si-1 | 0.2 | (A) | 100 |
| layer 34 | | | | |
| Ink receiving | Si-1 | 1.0 | (A) | 50 |
| layer 35 | | | | |
| Ink receiving | Si-1 | 1.0 | (A) | 100 |
| layer 36 | | | | |
| Ink receiving | Si-1 | 1.0 | (A) | 150 |
| layer 37 | | | | |
| Ink receiving | Si-1 | 1.0 | (A) | 200 |
| layer 38 | | | | |

The compounds as listed in the above Table 43 are specified as follows:

Si-1(water-soluble silicon-based surfactant); Sansilicon M-84 (water-soluble silicon-based surfactant, dimethyl siloxane ethylene oxide copolymer, manufactured by Sanyo Chemical Industries, Ltd.)

Hydrophilic resins:

(A) Poly(2-acrylamide-2-methyl-1-propane sulfonic acid)

(B) Carboxymethyl cellulose potassium salt

(C) Compound represented by the following structural formula

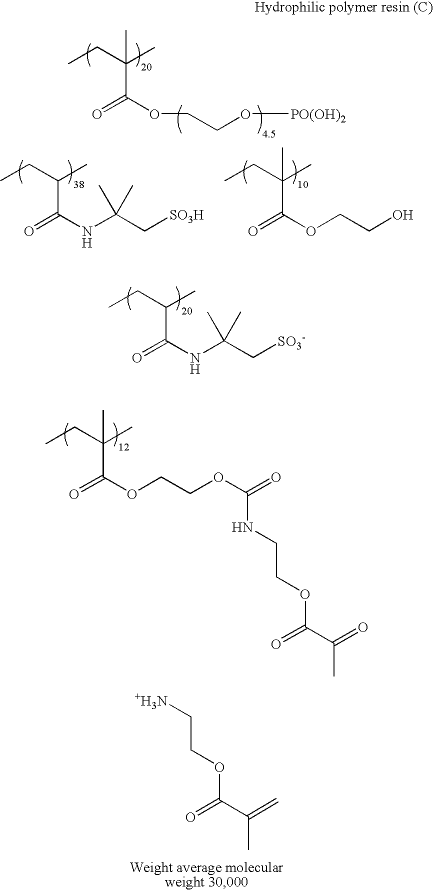

A recording medium was prepared by combining the above-described support, surface treatment, hydrophilizing treatment, and ink receiving layer, and then a planographic printing plate was prepared by depositing and curing ink on the surface of the recording medium.

<Fluorine-Based Surfactant-Containing Ink>

Radical-polymerizable UV ink manufactured by Mimaki Engineering Co. Ltd. (referred to as ink 1), and ink 2 which contains the radical-polymerizable UV ink manufactured by Mimaki Engineering Co. Ltd. and 0.5% Megafac F780(manufactured by Dainippon Ink And Chemicals, Incorporated) were used.

<Ink in Which Polymer is Dissolved by Organic Solvent>

10 g of methyl methacrylate-methacrylic acid copolymer (copolymerization ratio: methyl methacrylate 60 mol %/methacrylic acid 40 mol %, weight average molecular weight: 6,000) was dissolved in a mixture of 90 g of diethylene glycol diethylether. Thus ink 4 was obtained.

<Ink in Which UV Ink is Diluted by Organic Solvent>

20 g of radical polymerizable UV ink (manufactured by Mimaki Engineering Co. Ltd.) was dissolved in 80 g of diethylene glycol diethylether. Thus ink 4 was obtained.

<Deposition of Ink by Ink Jet Recording System>

The ultraviolet-polymerizable ink 1 or 2 was loaded on UJF-605C (manufactured by Mimaki Engineering Co. Ltd.) equipped with a piezo-type head and an ultraviolet radiation device, and deposited on the recording medium for producing the direct-writing planographic printing plates 1 to 107, and then cured by ultraviolet radiation.

<Evaluation of Performance of Planographic Printing Plates>

(1. Printing Durability Evaluation)

The obtained planographic printing plates were subjected to printing with a Lithrone printing machine (manufactured by Komori Corp.) using black ink (trade name: DIC-GEOS(N), manufactured by Dainippon Ink and Chemicals, Inc.) and dampening water (trade name IF102, manufactured by Fuji Photo Film Co., Ltd.). The printing durability was evaluated based on the number of printed sheets at the point where it could be observed visually that the density of the solid image had started to become lighter.

(2. Stain Resistance Evaluation)

Printing was carried out with a Mitsubishi Dia-type F2 printing machine (manufactured by Mitsubitshi Heavy Industries, Ltd.) using a 3% aqueous solution of dampening water (trade name: Ecolity-2, manufactured by Fuji Photo Film Co., Ltd.) and red ink (trade name: DIC-GEOS (s)). After contacting the moistened roller with the 10 rotating plate, printing was initiated upon the application of ink. The number of sheets before a fine printed sheet was obtained was counted.

In the first place, the supports which had been subjected to the surface treatment 9 were hydrophilized by the hydrophilizing treatment 5, and ink receiving layers as listed in Table 44 were formed on the surface of the supports. The thus obtained planographic printing plates of Examples I-1 to I-24 and Comparative Examples I-1 to I-5 were evaluated by the above-described methods. The ink receiving layers in the region where no ink had been deposited were removed by dampening water, except for that of Comparative Example I-4, thereby the hydrophilic surfaces were exposed.

TABLE 44

| | | Contact angle | | | | |
|---|---|---|---|---|---|---|
| | | with ink | Contact angle with | Dot | Stain resistance | |
| | Ink receiving | (flying ink | water (flying water | diameter | (number of | Printing durability |
| Example | layer | droplets) | droplets) | (μm) | developed sheets) | (number of sheets) |
| Example I-1 | Ink receiving | 40 | 7 | 40 | 15 | 100000 |
| | layer 1 | | | | | |
| Example I-2 | Ink receiving | 45 | 8 | 38 | 19 | 100000 |
| | layer 2 | | | | | |
| Example I-3 | Ink receiving | 40 | 9 | 42 | 20 | 100000 |
| | layer 3 | | | | | |
| Example I-4 | Ink receiving | 40 | 8 | 40 | 20 | 100000 |
| | layer 4 | | | | | |
| Example I-5 | Ink receiving | 35 | 5 | 45 | 10 | 100000 |
| | layer 5 | | | | | |
| Example I-6 | Ink receiving | 60 | 5 | 33 | 8 | 100000 |
| | layer 7 | | | | | |
| Example I-7 | Ink receiving | 60 | 9 | 35 | 20 | 100000 |
| | layer 8 | | | | | |
| Example I-8 | Ink receiving | 60 | 5 | 35 | 8 | 100000 |
| | layer 9 | | | | | |
| Example I-9 | Ink receiving | 65 | 5 | 33 | 8 | 100000 |
| | layer 10 | | | | | |
| Example I-10 | Ink receiving | 60 | 5 | 35 | 8 | 100000 |
| | layer 11 | | | | | |
| Example I-11 | Ink receiving | 65 | 4 | 33 | 6 | 100000 |
| | layer 12 | | | | | |
| Example I-12 | Ink receiving | 50 | 3 | 38 | 5 | 100000 |
| | layer 13 | | | | | |
| Example I-13 | Ink receiving | 70 | 8 | 30 | 20 | 100000 |
| | layer 14 | | | | | |
| Example I-14 | Ink receiving | 80 | 3 | 28 | 6 | 100000 |
| | layer 15 | | | | | |
| Example I-15 | Ink receiving | 85 | 5 | 28 | 10 | 100000 |
| | layer 16 | | | | | |
| Example I-16 | Ink receiving | 80 | 4 | 28 | 8 | 100000 |
| | layer 17 | | | | | |
| Example I-17 | Ink receiving | 80 | 3 | 28 | 6 | 100000 |
| | layer 18 | | | | | |
| Example I-18 | Ink receiving | 60 | 2 | 35 | 4 | 100000 |
| | layer 19 | | | | | |
| Example I-19 | Ink receiving | 90 | 5 | 27 | 5 | 100000 |
| | layer 20 | | | | | |
| Example I-20 | Ink receiving | 100 | 9 | 27 | 20 | 90000 |
| | layer 21 | | | | | |
| Example I-21 | Ink receiving | 90 | 5 | 28 | 13 | 100000 |
| | layer 22 | | | | | |
| Example I-22 | Ink receiving | 100 | 8 | 27 | 16 | 90000 |
| | layer 23 | | | | | |
| Example I-23 | Ink receiving | 60 | 5 | 33 | 8 | 100000 |
| | layer 27 | | | | | |
| Example I-24 | Ink receiving | 80 | 3 | 28 | 6 | 100000 |
| | layer 28 | | | | | |
| Example I-25 | Ink receiving | 60 | 6 | 35 | 10 | 100000 |
| | layer 29 | | | | | |
| Example I-26 | Ink receiving | 70 | 8 | 30 | 8 | 100000 |
| | layer 30 | | | | | |
| Example I-27 | Ink receiving | 70 | 8 | 30 | 10 | 100000 |
| | layer 31 | | | | | |
| Example I-28 | Ink receiving | 70 | 8 | 30 | 11 | 100000 |
| | layer 32 | | | | | |
| Example I-29 | Ink receiving | 70 | 8 | 30 | 12 | 100000 |
| | layer 33 | | | | | |
| Example I-30 | Ink receiving | 55 | 6 | 40 | 10 | 100000 |
| | layer 34 | | | | | |
| Example I-31 | Ink receiving | 65 | 8 | 30 | 8 | 100000 |
| | layer 35 | | | | | |
| Example I-32 | Ink receiving | 65 | 8 | 30 | 10 | 100000 |
| | layer 36 | | | | | |
| Example I-33 | Ink receiving | 65 | 8 | 30 | 11 | 100000 |
| | layer 37 | | | | | |
| Example I-34 | Ink receiving | 65 | 8 | 30 | 12 | 100000 |
| | layer 38 | | | | | |
| Comparative | Ink receiving | 5 | 2 | 130 | 6 | 100000 |
| Example I-1 | layer 24 | | | | | |
| Comparative | Ink receiving | 5 | 2 | 130 | 6 | 100000 |
| Example I-2 | layer 25 | | | | | |
| Comparative | Ink receiving | 5 | 2 | 130 | 6 | 100000 |
| Example I-3 | layer 26 | | | | | |
| Comparative | Ink receiving | 50 | 15 | 35 | 80 | 100000 |
| Example I-4 | layer 6 | | | | | |
| Comparative | None | 5 | 2 | 130 | 6 | 100000 |
| Example I-5 | | | | | | |

The results summarized in Table 44 indicate that when the contact angle with ink was larger than 30° and that with water was smaller 10°, the planographic printing plate presented a small dot diameter, required only 20 or less sheets until a fine printed sheet was obtained, and showed satisfactory printing durability. On the other hand, when the contact angle with ink is smaller than 30°, the dot diameter exceeded 100 μm, and when the contact angle with water exceeded 15°, the number of developed sheets increased.

In the next place, The supports which had been subjected to the surface treatment 1 had provided thereon hydrophilic layers listed in the following Table 45-1 and Table 45-2, and the ink receiving layer 15 was formed on the surface of the hydrophilic layers. The thus obtained recording media were used to prepare the planographic printing plates of Examples J-1 to J-13 and K-1 to K-13, and evaluations were carried out in the same manner as described above.

TABLE 45-1
Ink receiving layer 15

| | | | | | Stain resistance | |
|---|---|---|---|---|---|---|
| | | | Contact angle with | Dot | (number of | |
| | Hydrophilizing | Contact angle with ink | water (flying water | diameter | developed | Printing durability |
| Example | treatment | (flying ink droplets) | droplets) | (μm) | sheets) | (number of sheets) |
| Example | Hydrophilizing | 80 | 3 | 28 | 15 | 120000 |
| J-1 | treatment 1 | | | | | |
| Example | Hydrophilizing | 80 | 3 | 28 | 13 | 110000 |
| J-2 | treatment 2 | | | | | |
| Example | Hydrophilizing | 80 | 3 | 28 | 10 | 100000 |
| J-3 | treatment 3 | | | | | |
| Example | Hydrophilizing | 80 | 3 | 28 | 5 | 120000 |
| J-4 | treatment 4 | | | | | |
| Example | Hydrophilizing | 80 | 3 | 28 | 4 | 110000 |
| J-5 | treatment 5 | | | | | |
| Example | Hydrophilizing | 80 | 3 | 28 | 4 | 100000 |
| J-6 | treatment 6 | | | | | |
| Example | Hydrophilizing | 80 | 3 | 28 | 10 | 100000 |
| J-7 | treatment 7 | | | | | |
| Example | Hydrophilizing | 80 | 3 | 28 | 8 | 100000 |
| H-8 | treatment 8 | | | | | |
| Example | Hydrophilizing | 80 | 3 | 28 | 7 | 90000 |
| J-9 | treatment 9 | | | | | |
| Example | Hydrophilizing | 80 | 3 | 28 | 15 | 100000 |
| J-10 | treatment 10 | | | | | |
| Example | Hydrophilizing | 80 | 3 | 28 | 13 | 100000 |
| J-11 | treatment 11 | | | | | |
| Example | Hydrophilizing | 80 | 3 | 28 | 10 | 90000 |
| J-12 | treatment 12 | | | | | |
| Example | — | 80 | 5 | 28 | 20 | 120000 |
| J-13 | | | | | | |

TABLE 45-2
Ink receiving layer 31

| | | | | | Stain resistance | |
|---|---|---|---|---|---|---|
| | | | Contact angle with | Dot | (number of | |
| | Hydrophilizing | Contact angle with ink | water (flying water | diameter | developed | Printing durability |
| Example | treatment | (flying ink droplets) | droplets) | (μm) | sheets) | (number of sheets) |
| Example K-1 | Hydrophilizing | 75 | 3 | 30 | 17 | 110000 |
| | treatment 1 | | | | | |
| Example K-2 | Hydrophilizing | 75 | 3 | 30 | 15 | 100000 |
| | treatment 2 | | | | | |
| Example K-3 | Hydrophilizing | 75 | 3 | 30 | 12 | 90000 |
| | treatment 3 | | | | | |
| Example K-4 | Hydrophilizing | 75 | 3 | 30 | 6 | 110000 |
| | treatment 4 | | | | | |
| Example K-5 | Hydrophilizing | 75 | 3 | 30 | 5 | 100000 |
| | treatment 5 | | | | | |
| Example K-6 | Hydrophilizing | 75 | 3 | 30 | 5 | 90000 |
| | treatment 6 | | | | | |
| Example K-7 | Hydrophilizing | 75 | 3 | 30 | 12 | 90000 |
| | treatment 7 | | | | | |
| Example K-8 | Hydrophilizing | 75 | 3 | 30 | 10 | 90000 |
| | treatment 8 | | | | | |
| Example K-9 | Hydrophilizing | 75 | 3 | 30 | 8 | 80000 |
| | treatment 9 | | | | | |
| Example K-10 | Hydrophilizing | 75 | 3 | 30 | 17 | 90000 |
| | treatment 10 | | | | | |
| Example K-11 | Hydrophilizing | 75 | 3 | 30 | 15 | 90000 |
| | treatment 11 | | | | | |
| Example K-12 | Hydrophilizing | 75 | 3 | 30 | 12 | 80000 |
| | treatment 12 | | | | | |
| Example K-13 | — | 75 | 3 | | 25 | 110000 |

The results summarized in Table 45-1 and Table 45-2 indicate that the hydrophilizing treatment on the anodic oxidation coating decreased the contact angle with water, and decreased the number of developed sheets.

In the next place, the aluminum supports which had been subjected to the surface treatments listed in Table 46 were subjected to the hydrophilizing treatment 3, and the ink receiving layer 15 was formed on the surface of the supports to obtain recording media. The thus obtained recording media were used to prepare the planographic printing plates of Examples G-38 to G-54, and evaluations were carried out in the same manner as described above.

TABLE 46-1
ink receiving layer 15

| | | | Contact angle | | Stain resistance | |
|---|---|---|---|---|---|---|
| | Surface | Contact angle with ink | with water (flying | Dot diameter | (number of | Printing durability |
| Example | treatment | (flying ink droplets) | water droplets) | (μm) | developed sheets) | (number of sheets) |
| Example | Surface | 80 | 3 | 28 | 5 | 110000 |
| L-1 | treatment 1 | | | | | |
| Example | Surface | 80 | 3 | 28 | 5 | 110000 |
| L-2 | treatment 2 | | | | | |
| Example | Surface | 80 | 3 | 28 | 5 | 120000 |
| L-3 | treatment 3 | | | | | |
| Example | Surface | 80 | 3 | 28 | 5 | 100000 |
| L-4 | treatment 4 | | | | | |
| Example | Surface | 80 | 3 | 28 | 5 | 110000 |
| L-5 | treatment 5 | | | | | |
| Example | Surface | 80 | 3 | 28 | 5 | 100000 |
| L-6 | treatment 6 | | | | | |
| Example | Surface | 80 | 3 | 28 | 5 | 90000 |
| L-7 | treatment 7 | | | | | |
| Example | Surface | 80 | 3 | 28 | 5 | 100000 |
| L-8 | treatment 8 | | | | | |
| Example | Surface | 80 | 3 | 28 | 5 | 140000 |
| L-9 | treatment 9 | | | | | |
| Example | Surface | 80 | 3 | 28 | 10 | 110000 |
| L-10 | treatment 10 | | | | | |
| Example | Surface | 80 | 3 | 28 | 10 | 110000 |
| L-11 | treatment 11 | | | | | |
| Example | Surface | 80 | 3 | 28 | 20 | 90000 |
| L-12 | treatment 12 | | | | | |
| Example | Surface | 80 | 3 | 28 | 10 | 100000 |
| L-13 | treatment 13 | | | | | |
| Example | Surface | 80 | 3 | 28 | 10 | 100000 |
| L-14 | treatment 14 | | | | | |
| Example | Surface | 80 | 3 | 28 | 20 | 100000 |
| L-15 | treatment 15 | | | | | |
| Example | Surface | 80 | 3 | 28 | 5 | 5000 |
| L-16 | treatment 16 | | | | | |
| Example | Surface | 80 | 3 | 28 | 5 | 50000 |
| L-17 | treatment 17 | | | | | |

TABLE 46-2
ink receiving layer 31

| | | | Contact angle | | Stain resistance | |
|---|---|---|---|---|---|---|
| | Surface | Contact angle with ink | with water (flying | Dot diameter | (number of | Printing durability |
| Example | treatment | (flying ink droplets) | water droplets) | (μm) | developed sheets) | (number of sheets) |
| Example | Surface | 75 | 3 | 30 | 6 | 100000 |
| M-1 | treatment 1 | | | | | |
| Example | Surface | 75 | 3 | 30 | 6 | 100000 |
| M-2 | treatment 2 | | | | | |
| Example | Surface | 75 | 3 | 30 | 6 | 110000 |
| M-3 | treatment 3 | | | | | |
| Example | Surface | 75 | 3 | 30 | 6 | 90000 |
| M-4 | treatment 4 | | | | | |
| Example | Surface | 75 | 3 | 30 | 6 | 100000 |
| M-5 | treatment 5 | | | | | |
| Example | Surface | 75 | 3 | 30 | 6 | 90000 |
| M-6 | treatment 6 | | | | | |
| Example | Surface | 75 | 3 | 30 | 6 | 80000 |
| M-7 | treatment 7 | | | | | |
| Example | Surface | 75 | 3 | 30 | 6 | 90000 |
| M-8 | treatment 8 | | | | | |
| Example | Surface | 75 | 3 | 30 | 6 | 130000 |
| M-9 | treatment 9 | | | | | |
| Example | Surface | 75 | 3 | 30 | 12 | 100000 |
| M-10 | treatment 10 | | | | | |
| Example | Surface | 75 | 3 | 30 | 12 | 100000 |
| M-11 | treatment 11 | | | | | |
| Example | Surface | 75 | 3 | 30 | 25 | 80000 |
| M-12 | treatment 12 | | | | | |
| Example | Surface | 75 | 3 | 30 | 12 | 90000 |
| M-13 | treatment 13 | | | | | |
| Example | Surface | 75 | 3 | 30 | 12 | 90000 |
| M-14 | treatment 14 | | | | | |
| Example | Surface | 75 | 3 | 30 | 25 | 90000 |
| M-15 | treatment 15 | | | | | |
| Example | Surface | 75 | 3 | 30 | 6 | 3000 |
| M-16 | treatment 16 | | | | | |
| Example | Surface | 75 | 3 | 30 | 6 | 40000 |
| M-17 | treatment 17 | | | | | |

For the planographic printing plates except for those having a medium wave structure with an average aperture 0.5 to 5 μm or a small wave structure with an average aperture size of 0.01 to 0.2 μm (surface treatment 10 to 17), either the printing durability or the stain resistance was at a level of practically no problem. However, they were rather inferior to optimal ones.

The planographic printing plates having a grain form structure (surface treatment 1 to 9), in which a large wave structure with an average wavelength of 5 to 100 μm, a medium wave structure with an average aperture size of 0.5 to 5 μm, and a small wave structure with an average aperture size of 0.01 to 0.2 μm are superimposed each other, showed a good balance of printing durability and stain resistance.

In the next place, a support which had been subjected to the surface treatment 9 and the hydrophilizing treatment 5 had provided thereon the ink receiving layer as listed in Table 47, and the ink 2 was deposited on the ink receiving layer to obtain the planographic printing plate of Example O-1. Evaluations were carried out in the same manner as described above. As control examples, the results for Example I-14 and Comparative Example I-1, which differed from Example O-1 only in the deposited ink, are listed together.

TABLE 47

| | | | | Contact | | | |
|---|---|---|---|---|---|---|---|
| | | | Contact | angle | | Stain | |
| | | | angle | with | | resistance | |
| | | | with ink | water | | (number | Printing |
| | | Ink | (flying | (flying | Dot | of | durability |
| | | receiving | ink | water | diameter | developed | (number |
| Example | Ink | layer | droplets) | droplets) | (μm) | sheets) | of sheets) |
| Example | Ink 2 | Ink | 70 | 3 | 30 | 6 | 100000 |
| O-1 | | receiving | | | | | |
| | | layer 15 | | | | | |
| Example | Ink 1 | Ink | 80 | 3 | 28 | 6 | 100000 |
| I-14 | | receiving | | | | | |
| | | layer 15 | | | | | |
| Comparative | Ink 1 | Ink | 5 | 2 | 130 | 6 | 100000 |
| Example | | receiving | | | | | |
| I-1 | | layer 24 | | | | | |

The deposited organic solvent inks such as ink 3 or ink 4 provide high printing durability as listed in Table 48.

TABLE 48

| | | | Contact angle | Contact angle | | Stain resistance | |
|---|---|---|---|---|---|---|---|
| | | | with ink | with water | Dot | (number of | |
| | | ink receiving | (flying ink | (flying water | diameter | developed | Printing durability |
| Example | ink | layer | droplets) | droplets) | (μm) | sheets) | (number of sheets) |
| Example | ink 3 | ink receiving | 60 | 6 | 35 | 10 | 160000 |
| N-1 | | layer 29 | | | | | |
| Example | ink 3 | ink receiving | 70 | 8 | 30 | 8 | 160000 |
| N-2 | | layer 30 | | | | | |
| Example | ink 3 | ink receiving | 70 | 8 | 30 | 10 | 160000 |
| N-3 | | layer 31 | | | | | |
| Example | ink 3 | ink receiving | 70 | 8 | 30 | 11 | 160000 |
| N-4 | | layer 32 | | | | | |
| Example | ink 3 | ink receiving | 70 | 8 | 30 | 12 | 160000 |
| N-5 | | layer 33 | | | | | |
| Example | ink 4 | ink receiving | 55 | 6 | 40 | 10 | 150000 |
| N-6 | | layer 29 | | | | | |
| Example | ink 4 | ink receiving | 65 | 8 | 30 | 8 | 150000 |
| N-7 | | layer 30 | | | | | |
| Example | ink 4 | ink receiving | 65 | 8 | 30 | 10 | 150000 |
| N-8 | | layer 31 | | | | | |
| Example | ink 4 | ink receiving | 65 | 8 | 30 | 11 | 150000 |
| N-9 | | layer 32 | | | | | |
| Example | ink 4 | ink receiving | 65 | 8 | 30 | 12 | 150000 |
| N-10 | | layer 33 | | | | | |
| Example | ink 1 | ink receiving | 60 | 6 | 35 | 10 | 100000 |
| I-25 | | layer 29 | | | | | |
| Example | ink 1 | ink receiving | 70 | 8 | 30 | 8 | 100000 |
| I-26 | | layer 30 | | | | | |
| Example | ink 1 | ink receiving | 70 | 8 | 30 | 10 | 100000 |
| I-27 | | layer 31 | | | | | |
| Example | ink 1 | ink receiving | 70 | 8 | 30 | 11 | 100000 |
| I-28 | | layer 32 | | | | | |
| Example | ink 1 | ink receiving | 70 | 8 | 30 | 12 | 100000 |
| I-29 | | layer 33 | | | | | |

The addition of F-780 to the ink 1 increased the contact angle with ink from 5° to 70°. The dot diameter of the ink 1 on the ink receiving layer 24 , which is outside the range of the invention, was 130 μm, and the diameter was decreased to 30 μm by replacing the ink 1 with the ink 2. This result indicates that image forming with high resolution and no ink bleeding can be achieved by adding an water-repellent compound to ink.

### Example P

The plate as described in Example I-1, N-3 and N-8 was subjected to image forming and exposure in the same manner as Example I-1, N-3 and N-8, and then a gum solution prepared by two-fold diluting GU-7 with water was applied to the plate using a gum coater (trade name: G-800H, manufactured by Fuji Photo Film Co., Ltd.). The printing durability and stain resistance of the plate were equivalent to those of Example 1, indicating that the ink receiving layer in the non-image area was removed by the gum treatment.

According to the invention, a recording medium for planographic printing plate which prevents bleeding of deposited ink, leaves no significant stains during printing, and provides good printing durability is provided.

Furthermore, according to the invention, a planographic printing plate which uses the recording medium of the invention, forms image areas with excellent resolution and printing durability, and produces printed matters with reduced stains in non-image area, and a simple method for producing the planographic printing plate are also provided.

The invention also includes the following embodiments.

<1> A recording medium for producing a direct-writing planographic printing plate comprising: a support; a hydrophilic layer; and an ink receiving layer laminated on the support in this order, wherein the ink receiving layer contains one or more compounds selected from the group consisting of organic fluorine compounds having a fluoroalkyl group and compounds having a dimethyl siloxane skeleton, and receives ink deposited by an ink jet recording system.

<2> The recording medium for producing a direct-writing planographic printing plate of item <1>, wherein the organic fluorine compound having a fluoroalkyl group contains five or more fluorine atoms per molecule.

<3> The recording medium for producing a direct-writing planographic printing plate of any one of items <1> to <2>, wherein the ink receiving layer in the region where no ink has been deposited by an ink jet recording system is removed using dampening water during printing carried out after deposition and curing of ink.

<4> The recording medium for producing a direct-writing planographic printing plate of any one of items <1> to <3>, wherein the ink receiving layer in the region where no ink has been deposited by an ink jet recording system is removed using gum in the process of gum treatment carried out after deposition and curing of ink.

<5> The recording medium for producing a direct-writing planographic printing plate of any one of items <1> to <4>, wherein the support has a grain structure where a medium wave structure having an average aperture size of 0.5 to 5 μm and a small wave structure having an average aperture size of 0.01 to 0.2 μm are superimposed on each other.

<6> The recording medium for producing a direct-writing planographic printing plate of item <5>, wherein the support has a grain form on its surface where a large wave structure having an average aperture size of 5 to 100 μm.

<7> The recording medium for producing a direct-writing planographic printing plate of item <5> or <6>, wherein the average ratio of the depth to the aperture size of the small wave structure of the support is 0.2 or more.

<8> The recording medium for producing a direct-writing planographic printing plate of any one of items <1> to <7>, wherein the support comprises an aluminum support having an anodic oxidation layer thereon and the hydrophilic layer comprises a silicate layer of a coating weight of 1.2 to 25 mg/m2 provided thereon, and an ink receiving layer contains 0.2 to 50.0 mg/m2 of the organic fluorine compound having a fluoroalkyl group containing five or more fluorine atoms per molecule.

<9> The recording medium for producing a direct-writing planographic printing plate of item <8>, wherein the ink receiving layer additionally contains 1.0 to 200.0 mg/m2 of a hydrophilic resin.

<10> The recording medium for producing a direct-writing planographic printing plate of any one of items <1> to <7>, wherein the hydrophilic layer is a hydrophilic layer containing a sol-gel structure and contains 0.2 to 50.0 mg/m2 of the organic fluorine compound having a fluoroalkyl group containing five or more fluorine atoms per molecule.

<11> The recording medium for producing a direct-writing planographic printing plate of item <10>, wherein the ink receiving layer additionally contains 1.0 to 50.0 mg/m2 of a hydrophilic resin.

<12> The recording medium for producing a direct-writing planographic printing plate of any one of items <1> to <11>, wherein the organic fluorine compound has a —COO—RF skeleton, wherein RF represents a fluoroalkyl group.

<13> The recording medium for producing a direct-writing planographic printing plate of any one of items <1> to <11>, wherein the organic fluorine compound has two or more —COO—RF skeletons per molecule, wherein RF represents a fluoroalkyl group.

<14> The recording medium for producing a direct-writing planographic printing plate of any one of items <1> to <11>, wherein the organic fluorine compound is water soluble.

<15> The recording medium for producing a direct-writing planographic printing plate of item <14>, wherein the organic fluorine compound has a sulfonic acid or a salt thereof.

<16> The recording medium for producing a direct-writing planographic printing plate of any one of items <1> to <15>, wherein the ink receiving layer is provided by coating.

<17> A planographic printing plate obtained by depositing an ink and curing the ink to form an image area on the surface of a recording medium, wherein a support, a hydrophilic layer, and an ink receiving layer are laminated on the support in this order, the ink receiving layer contains one or more compounds selected from the group consisting of organic fluorine compounds having a fluoroalkyl group and compounds having a dimethyl siloxane skeleton, and the ink receiving layer receives the ink deposited by an ink jet recording system.

<18> The planographic printing plate of item <17>, wherein the contact angle between water and the ink receiving layer formed on the hydrophilic layer is smaller than 10°, and the contact angle between the ink receiving layer and the ink deposited by an ink jet system is larger than 30°.

<19> The planographic printing plate of item <17>, wherein the contact angle between the hydrophilic layer formed on the support and dampening water used during printing is smaller than 10°.

<20> The method for producing a planographic printing plate, wherein an ink is deposited on the ink receiving layer surface of the recording medium according to any one of items <1> to <19>, and the ink is cured by ultraviolet radiation, heat or air blow and then the ink receiving layer in the region where no ink has been deposited is removed.

<21> The method for producing a planographic printing plate of item <20>, wherein the removal of the ink receiving layer is carried out using dampening water during printing.

<22> The method for producing a planographic printing plate of item <20>, wherein the removal of the ink receiving layer is carried out using gum during a process of gum treatment.

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

What is claimed is:

1. A recording medium for producing a direct-writing planographic printing plate comprising: a support; a hydrophilic layer; and an ink receiving layer laminated on the support in this order, wherein the ink receiving layer contains one or more compounds selected from the group consisting of organic fluorine compounds having a fluoroalkyl group and compounds having a dimethyl siloxane skeleton, and receives ink deposited by an ink jet recording system.

2. The recording medium for producing a direct-writing planographic printing plate of claim 1, wherein the organic fluorine compound having a fluoroalkyl group contains five or more fluorine atoms per molecule.

3. The recording medium for producing a direct-writing planographic printing plate of claim 1, wherein the ink receiving layer in the region where no ink has been deposited by an ink jet recording system is removed using dampening water during printing carried out after deposition and curing of ink.

4. The recording medium for producing a direct-writing planographic printing plate of claim 1, wherein the ink receiving layer in the region where no ink has been deposited by an ink jet recording system is removed using gum in the process of gum treatment carried out after deposition and curing of ink.

5. The recording medium for producing a direct-writing planographic printing plate of claim 1, wherein the support has a grain structure where a medium wave structure having an average aperture size of 0.5 to 5 μm and a small wave structure having an average aperture size of 0.01 to 0.2 μm are superimposed on each other.

6. The recording medium for producing a direct-writing planographic printing plate of claim 5, wherein the support has a grain form on its surface where a large wave structure having an average aperture size of 5 to 100 μm.

7. The recording medium for producing a direct-writing planographic printing plate of claim 5, wherein the average ratio of the depth to the aperture size of the small wave structure of the support is 0.2 or more.

8. The recording medium for producing a direct-writing planographic printing plate of claim 1, wherein the support comprises an aluminum support having an anodic oxidation layer thereon and the hydrophilic layer comprises a silicate layer of a coating weight of 1.2 to 25 mg/m² provided thereon, and an ink receiving layer contains 0.2 to 50.0 mg/m² of the organic fluorine compound having a fluoroalkyl group containing five or more fluorine atoms per molecule.

9. The recording medium for producing a direct-writing planographic printing plate of claim 8, wherein the ink receiving layer additionally contains 1.0 to 200.0 mg/m² of a hydrophilic resin.

10. The recording medium for producing a direct-writing planographic printing plate of claim 1, wherein the hydrophilic layer is a hydrophilic layer containing a sol-gel structure and contains 0.2 to 50.0 mg/m² of the organic fluorine compound having a fluoroalkyl group containing five or more fluorine atoms per molecule.

11. The recording medium for producing a direct-writing planographic printing plate of claim 10, wherein the ink receiving layer additionally contains 1.0 to 50.0 mg/m² of a hydrophilic resin.

12. The recording medium for producing a direct-writing planographic printing plate of claim 1, wherein the organic fluorine compound has a —COO—R_{F} skeleton, wherein RF represents a fluoroalkyl group.

13. The recording medium for producing a direct-writing planographic printing plate of claim 1, wherein the organic fluorine compound has two or more —COO—R_{F} skeletons per molecule, wherein RF represents a fluoroalkyl group.

14. The recording medium for producing a direct-writing planographic printing plate of any of claim 1, wherein the organic fluorine compound is water soluble.

15. The recording medium for producing a direct-writing planographic printing plate of claim 1, wherein the organic fluorine compound has a sulfonic acid or a salt thereof.

16. The recording medium for producing a direct-writing planographic printing plate of claim 1, wherein the ink receiving layer is provided by coating.

17. A planographic printing plate obtained by depositing an ink and curing the ink to form an image area on the surface of a recording medium, wherein a support, a hydrophilic layer, and an ink receiving layer are laminated on the support in this order, the ink receiving layer contains one or more compounds selected from the group consisting of organic fluorine compounds having a fluoroalkyl group and compounds having a dimethyl siloxane skeleton, and the ink receiving layer receives the ink deposited by an ink jet recording system.

18. The planographic printing plate of claim 17, wherein the contact angle between water and the ink receiving layer formed on the hydrophilic layer is smaller than 10°, and the contact angle between the ink receiving layer and the ink deposited by an ink jet system is larger than 30°.

19. The planographic printing plate of claim 17, wherein the contact angle between the hydrophilic layer formed on the support and dampening water used during printing is smaller than 10°.

20. The method for producing a planographic printing plate, wherein an ink is deposited on the ink receiving layer surface of the recording medium according to claim 1, and the ink is cured by ultraviolet radiation, heat or air blow, and then the ink receiving layer in the region where no ink has been deposited is removed.

21. The method for producing a planographic printing plate of claim 20, wherein the removal of the ink receiving layer is carried out using dampening water during printing.

22. The method for producing a planographic printing plate of claim 20, wherein the removal of the ink receiving layer is carried out using gum during a process of gum treatment.
